(19) United States
(12) Patent Application Publication
(10) Pub. No.: US 2023/0386347 A1
(43) Pub. Date: Nov. 30, 2023

(54) FLIGHT MANAGEMENT SYSTEM

(71) Applicant: Altitude Angel Limited, Reading (GB)

(72) Inventors: Richard Steven PARKER, Reading (GB); Cara WINTERS, Reading (GB)

(21) Appl. No.: 18/027,350

(22) PCT Filed: Jun. 4, 2021
(86) PCT No.: PCT/GB2021/051386

§ 371 Date: Mar. 20, 2023

(30) Foreign Application Priority Data
Sep. 22, 2020 (GB) 2014988.6

(51) Int. Cl. G08G 5/00; G08G 5/04

(52) U.S. Cl. CPC G08G 5/0039; G08G 5/0013; G08G 5/0026; G08G 5/045; G08G 5/0069

(57) ABSTRACT

Method(s), apparatus and system (s) are provided for flight management of aircraft within an airspace comprising one or more airspace regions. The method(s), apparatus and system (s) are configured to: receive at least flight data associated with a plurality of aircraft in-flight within an airspace region from a communication network, wherein the airspace region comprises a plurality of airspace zones; model each airspace zone of the plurality of airspace zones, wherein each airspace zone represented by a corresponding airspace model comprising an airspace zone state representing at least air traffic in-flight within said each airspace zone based on received flight data associated with aircraft in-flight within said each airspace zone; detect any flight conflicts in relation to at least one or more aircraft in-flight within each airspace zone based on the airspace zone state of said each airspace zone; resolve any detected flight conflicts by the conflict detection component in relation to said at least one or more of the plurality of aircraft; and send over the communication network flight control information in relation to any detected and/or resolved conflicts by the conflict resolver component associated with said at least one or more of the plurality of aircraft.

The present application relates to apparatus, method(s) and system(s) for flight management.

### BACKGROUND

In manned aviation, the largest commercial aircraft (e.g. “Jumbo jets”) have a traffic collision avoidance system (TCAS) on board. Effectively, when two Jumbo jets approach each other on a collision course (e.g. some number of n miles away), the TCAS computers exchange flight data and agree between them which aircraft will go in which direction to avoid the collision. The TCAS computers each output a direction to the corresponding human pilot, who is legally obliged to take the action instructed. The TCAS computer itself does not automatically take the action.

TCAS relies on long-range radio broadcasts between aircraft equipped with TCAS systems such that aircraft on collision courses can detect the broadcast of the approaching plane, and then communicate with it to agree a resolution. However, only those aircraft with TCAS can benefit from such collision avoidance systems.

Unmanned aircraft or unmanned aerial vehicles (UAVs) typically feature an ‘autopilot’ system. The autopilot is really a ‘dumb’ device which usually relies on GPS to compare a pre-programmed route consisting of ‘waypoints’ with the current coordinates, and then change the flight of the UAV to achieve hitting each waypoint. The autopilot system is often referred to as a flight controller. There is no common standard for flight data exchange between flight controllers of two or more UAVs nor is there a common standard for enabling UAVs and manned aviation to safely coexist within the same air traffic control system.

Existing technologies for collision avoidance or conflict detection and resolution are typically akin to TCAS. However, such technologies are costly and require the same or compatible hardware to be deployed on aircraft. Ideally, to improve air safety, all manned and unmanned aircraft (or aerial vehicles/UAVs) need to be equipped with the same or compatible hardware so they can communicate and benefit from such collision avoidance systems. This is not only costly, but it is extremely unlikely to be implemented due to the disparate types of technologies involved.

The nearest conventional systems attempting to overcome this limitation tend to focus on automatic dependent surveillance-broadcast (ADS-B) local broadcasts, which are unencrypted one-way broadcasts of an aircraft's position over a 5-30 mile radius, to be predominantly picked up by ground-station receivers. Some unmanned aircraft (e.g. drones) may be equipped with ‘ADSB-IN’ which allows them to receive those signals, but there are challenges, ADS-B was not intended for conflict detection and resolution purposes between aircraft like TCAS is, and is also not encrypted or secure. For example, ADS-B signals can be “spoofed” using low cost hardware and software by malicious actors. This makes ADS-B unsuitable for implementing a TCAS style system for all manned and unmanned aircraft.

There is a desire for a robust, scalable, secure and cost effective approach for improving air traffic safety between manned and/or unmanned aircraft and the like.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

The present disclosure provides method(s), apparatus and system(s) for a flight management system that receives at least flight data and/or airspace data from multiple disparate flight data and/or airspace data sources associated with manned and/or unmanned aircraft in flight within an airspace, the airspace data associated with, without limitation, for example describing conditions of the airspace, for modelling the airspace and air traffic therein in a real-time fashion. The modelled airspace and air traffic therein is used for detecting conflicts between aircraft, resolving said conflicts, and issuing flight control information or navigation guidance to those aircraft and/or operators/pilot of said aircraft communicatively coupled to the flight management system and/or services thereof for taking action to avoid one or more of the associated detected conflicts. The flight control information may include, without limitation, for example data representative of navigation guidance instructions for use in avoiding conflicts and the like. The flight management system may be a cloud-based system that interfaces with, without limitation, for example, aircraft, other aviation systems, flight sources, air-traffic control, and/or backbone systems/infrastructure for receiving said flight data and/or airspace data associated with the airspace for modelling the airspace and the like, analysing conflicts/resolutions, and issuing flight control information and the like.

In a first aspect, the present disclosure provides a flight management system for controlling air traffic within an airspace, the flight management system comprising a flight data component, airspace modelling component, a conflict detection component and conflict resolver component, the flight data component connected to the airspace modelling component, conflict detection component and conflict resolver component, wherein: the flight data component is configured to receive at least flight data associated with a plurality of aircraft in-flight within an airspace region of the airspace from a communication network, wherein the airspace region comprises a plurality of airspace zones; the airspace modelling component is configured to model each airspace zone of the plurality of airspace zones, wherein each airspace zone is represented by a corresponding airspace model comprising an airspace zone state representing the state of at least air traffic in-flight within said each airspace zone based on received flight data corresponding to aircraft in-flight within said each airspace zone; the conflict detection component is configured to detect any flight conflicts in relation to at least one or more aircraft in-flight within each airspace zone based on the airspace zone state of said each airspace zone; the conflict resolver component is configured to resolve any detected flight conflicts by the conflict detection component in relation to said at least one or more of the plurality of aircraft; and the flight data component is further configured to send over the communication network flight control information in relation to any detected and/or resolved conflicts by the conflict resolver component associated with said at least one or more of the plurality of aircraft.

As an option, the flight data of each aircraft is received from one or more flight data sources over the communication network. As another option, the received flight data of an aircraft comprises at least one or more of: data representative of at least the location of the aircraft transmitted or broadcast by said aircraft; and data representative of at least the location of the aircraft transmitted or broadcast by one or more flight data sources; and data representative of at least the location of the aircraft transmitted or broadcast by one or more disparate flight data sources.

As a further option, the one or more flight data sources comprises at least one from the group of: flight telemetry receiver of said each aircraft; another aircraft of the plurality of aircraft; a radar source detecting position of said each aircraft; All Purpose Structured Eurocontrol Surveillance Information Exchange (ASTERIX) air traffic services information; airspace surveillance data associated with one or more of said plurality of aircraft; automatic dependent surveillance broadcast (ADS-B) data associated with one or more of said aircraft; flight planning services configured for providing flight plans of one or more of the aircraft of the plurality of aircraft; and any other standard for exchange of air traffic services information.

As an option, the flight data component is further configured to: identify flight data corresponding to a particular aircraft within a particular airspace zone; and route messages associated with the identified flight data to the corresponding airspace model associated with the particular airspace zone for modelling the airspace zone state in relation to air traffic within the particular airspace zone. As another option, the airspace modelling component for modelling each airspace model is further configured to receive airspace condition data for said each airspace zone for use in modelling the airspace zone state associated with the airspace zone.

As an option, airspace condition data comprises data representative of one or more from the group of: airspace geometry/flight restriction data; airspace obstructions and/or terrestrial structures; airspace disturbances adversely affecting aircraft based on at least one or more from the group of: efflux from a structure, volcano ash, pyrotechnics, weapons firing, light and/or other disturbances adversely affecting aircraft and/or pilots of aircraft and the like; airspace weather data; notice to airmen message (NOTAM) data; and any other data representative of the airspace condition and/or environment.

As an option, each airspace model represents an airspace zone state comprising a plurality of entities determined to be within the particular airspace zone based on at least the flight data and airspace condition data associated with the particular airspace zone, wherein the plurality of entities includes mobile entities and static entities, each mobile entity being assigned to either: a) one aircraft of the plurality of aircraft in-flight within the particular airspace zone based on the corresponding flight data associated with said one aircraft; or b) airspace condition data representing a mobile portion of airspace based on the corresponding airspace condition data identified to be associated with the mobile portion of airspace; and each static entity corresponding to a particular airspace condition data associated with a static portion of airspace within the particular airspace zone.

As another option, the airspace modelling component is configured to: analyse each of the entities associated with aircraft within the airspace zone state for detecting any conflicts using the conflict detection component with any other entity within the airspace zone state; resolve any detected conflicts using the conflict resolver component between entities within the airspace zone state; and send flight control information notifications including data representative of the resolution of any detected conflicts to corresponding aircraft.

As an option, the airspace modelling component is configured to queue received flight data/airspace data messages associated with aircraft in flight in the airspace zone, and process the airspace zone state in a plurality of processing intervals, where each processing interval is configured to: update the modelled airspace zone state, prior to analysing the modelled airspace zone state, based on received flight data/airspace data message queue buffered in the previous processing interval; and whilst buffering further received flight data/airspace data messages in the queue in the current processing interval: analyse each of the entities associated with aircraft within the airspace zone state for detecting any conflicts using the conflict detection component with any other entity within the airspace zone state; resolve any detected conflicts using the conflict resolver component between entities within the airspace zone state; and send flight control information notifications including data representative of the resolution of any detected conflicts to corresponding aircraft.

As a further option, the airspace modelling component is configured to model each airspace zone by switching between a data ingestion phase and an airspace zone state analysis phase, wherein: in the data ingestion phase, the airspace modelling component is configured to: receive flight data associated with aircraft and/or airspace condition data associated with the particular airspace zone; identify each entity corresponding to an aircraft or airspace associated with corresponding received flight data and/or airspace condition data; and send a message to each identified entity, each message including data representative of the corresponding flight data and/or airspace condition data for updating the state of said each identified entity; in the airspace zone state analysis phase, performed within a predetermined analysis interval, the airspace modelling component is configured to: update the airspace zone state based on any queued messages associated with corresponding entities of the airspace zone state; each of the entities associated with aircraft within the airspace zone state are analysed for detecting any conflicts using the conflict detection component with any other entity within the airspace zone state; resolve any detected conflicts using the conflict resolver component between entities within the airspace zone state; and send flight control information notifications including data representative of the resolution of any detected conflicts to corresponding aircraft.

As an option, during the airspace zone state analysis phase, any received flight data of aircraft and/or airspace condition data associated with the particular airspace zone are buffered for processing during the next data ingestion phase.

As another option, the flight data component is configured to process the received flight data associated with a plurality of aircraft in-flight within the airspace region covered by said flight data component by: receiving flight data associated with each of one or more aircraft of the plurality of aircraft from multiple flight data streams of one or more flight data sources; identifying portions of the received flight data associated with each of one or more aircraft of the plurality of aircraft; combining the identified portions of received flight data for said each aircraft into a flight data message including data representative of a single canonical representation of flight data associated with an entity corresponding to said each aircraft; and sending each flight data message to the corresponding airspace model for modelling the corresponding airspace zone state.

As a further option, the single canonical representation of flight data associated with an entity corresponding to said each aircraft is based on portions of flight data identified to be associated with the same entity and combined from multiple flight data sources, the single canonical representation including data representative of the state of the entity in relation to at least one of the position, location, velocity, airspeed, altitude and any other relevant data of the aircraft corresponding to the state of the associated entity. As another option, each entity is allocated a unique entity identifier and each flight data message is routed to the entity based on the unique entity identifier.

As an option, each of at least one or more portions of received flight data associated with an aircraft includes an external identifier associated with said aircraft allocated by said flight data source, and identifying said portions of received flight data associated with the aircraft includes allocating a unique identifier for said aircraft and mapping each external identifier identified to be associated with said aircraft to said unique identifier of said aircraft, wherein the flight data message includes data representative of the unique identifier of said aircraft for routing to said corresponding airspace model.

As another option, the conflict detection component for detecting flight conflicts in relation to at least one or more aircraft in flight within a particular airspace zone is further configured to detect a set of conflicts for each aircraft modelled in airspace zone state based on an analysis of any potential conflicts between said each aircraft and at least one or more of: the positions of other unmanned aircraft modelled in the airspace zone state; the positions of other manned aircraft modelled in the airspace zone state; the positions of any unknown aircraft or entities modelled in the airspace zone state; the geometric extents of volumes of restricted/controlled airspace within the airspace zone; weather forecast data about weather systems within the airspace zone; and any flight plans of other unmanned aircraft or manned aircraft modelled in the airspace zone state.

Optionally, the conflict resolver component for resolving any detected flight conflicts in each particular airspace zone is further configured to: generate a set candidate resolutions for each aircraft associated with a set of detected conflicts from said conflict detector in relation to said particular airspace zone; select a single resolution from the set of candidate resolutions to avoid each of conflicts in the set of conflicts based on properties of said each aircraft and/or airspace zone; and send flight control information to said each aircraft, the flight control information comprising data representative of the selected resolution.

As an option, the conflict resolver component is configured to generate a set of candidate resolutions based on a set of conflicts in relation to at least one or more aircraft in flight within a particular airspace zone and is further configured to analyse, for each aircraft modelled in airspace zone state, one or more resolutions based on aircraft properties and/or airspace zone from at least one or more of: aircraft priority; aircraft priority based on its payload; the latency of the connection with aircraft; any rules of the air in the vicinity of the aircraft detected within the airspace zone; aircraft type including at least one of fixed-wing type, rotary-wing type; aircraft course, speed, heading; aircraft intended flight plan/destination; obstacles in vicinity of the aircraft; and effect of implementing a resolution of the set of candidate resolutions on the aircraft and other nearby aircraft.

Optionally, a resolution of a set of candidate resolutions in relation to an aircraft comprises data representative of actions and/or instructions for use in directing the aircraft to avoid one or more conflicts of the set of conflicts associated with the aircraft.

As a further option, the flight management system according to the first aspect, features thereof and/or combinations thereto, modifications thereto, the flight management system further comprising a flight orchestration layer covering an airspace comprising a plurality of airspace regions, the flight orchestration layer comprising a plurality of flight orchestration components, each flight orchestration component associated with one of the plurality of airspace regions, each flight orchestration component comprising a flight data component configured to: receive at least flight data associated with a plurality of aircraft in-flight within the airspace region covered by said flight orchestration component; and communicate flight control information to one or more of the plurality of aircraft; and a plurality of airspace management components connected to each flight orchestration component, each airspace management component associated with a particular airspace zone of the airspace region of said flight orchestration component, said each airspace management component comprising an airspace modelling component, conflict detection component, and a conflict resolver component that are configured to: model the corresponding airspace zone state of at least air traffic in-flight within the particular airspace zone based on received flight data associated with aircraft in-flight within the particular airspace zone; and detect any flight conflicts in relation to at least one or more aircraft of the aircraft in-flight within the particular airspace zone; resolve any detected flight conflicts in relation to said at least one or more aircraft; and send flight control information, via the corresponding flight data component of said flight orchestration component, in relation to any detected and/or resolved conflicts associated with said at least one or more aircraft.

As an option, the flight management system is further configured to dynamically resize, assign and/or reassign one or more airspace zones of the plurality of airspace zones for modelling the airspace zone state of at least another airspace zone within said airspace region based on processing load of modelling said at least other airspace zone and/or number of flights within said at least other airspace zone. Optionally, the dynamic resizing, assignment and/or reassignment further includes at least one from the group of: dividing a particular airspace zone into multiple airspace zones when the processing load associated with modelling the number of flights within an airspace zone exceeds a first predetermined load threshold, and assigning processing load for modelling each of the multiple airspace zones; and merging multiple airspace zones into a single merged airspace zone when the combined processing load associated with modelling the number of flights within the multiple airspace zones falls below a second predetermined load threshold; wherein the first predetermined load threshold is greater than or equal to the second predetermined load threshold.

In a second aspect, the present disclosure provides an computer-implemented method of flight management for a flight management system covering an airspace region of an airspace, the airspace region comprising a plurality of airspace zones, the method further comprising: receiving at least flight data associated with a plurality of aircraft in-flight within the airspace region from a communication network; modelling each airspace zone of the plurality of airspace zones, wherein each airspace zone is represented by a corresponding airspace model comprising an airspace zone state representing at least air traffic in-flight within said each airspace zone based on received flight data associated with aircraft in-flight within said each airspace; and detecting any flight conflicts in relation to at least one or more aircraft in-flight within the each airspace zone based on the airspace zone state of said each airspace zone; resolving any detected flight conflicts in relation to said at least one or more of the plurality of aircraft; and sending over the communication network flight control information in relation to any detected and/or resolved conflicts associated with said at least one or more aircraft.

As an option, the computer-implemented method according to the second aspect, the method including one or more of steps and/or one or more of the features according to any of the features of the first aspect, combinations thereof, modifications thereto, and/or as herein described.

In a third aspect, the present disclosure provides a flight orchestration apparatus comprising a processor, a memory and a communication interface, the processor, memory and communication interface connected together, wherein the flight orchestration component is adapted to: receive at least flight data associated with a plurality of aircraft in-flight within the airspace region covered by said flight orchestration apparatus; distribute the received flight data to a plurality of airspace management components connected to said flight orchestration apparatus, each airspace management component associated with a particular airspace zone of the airspace region of said flight orchestration apparatus and configured to model each particular airspace zone represented by an airspace zone state, detect conflicts using the airspace zone state in relation to one or more aircraft in flight within the particular airspace zone and resolve any detected conflicts in relation to said one or more aircraft within said particular airspace zone; and receive one or more flight control information messages from one or more airspace management components, each flight control information message associated with at least one aircraft of the plurality of aircraft; and communicate said received flight control information to the at least one aircraft.

As an option, the flight orchestration apparatus according to the third aspect, the apparatus configured or adapted to include the features according to any of one or more of the features of the first and/or second aspects, combinations thereof, modifications thereto, and/or as herein described.

In a fourth aspect, the present disclosure provides a computer-implemented method of operating a flight orchestration apparatus, the method comprising: receiving at least flight data associated with a plurality of aircraft in-flight within the airspace region covered by said flight orchestration apparatus; distributing the received flight data to a plurality of airspace management components connected to said flight orchestration apparatus, each airspace management component associated with a particular airspace zone of the airspace region of said flight orchestration apparatus and configured to model each particular airspace zone represented by an airspace zone state, detect conflicts using the airspace zone state in relation to one or more aircraft in flight within the particular airspace zone and resolve any detected conflicts in relation to said one or more aircraft within said particular airspace zone; and receiving one or more flight control information messages from one or more airspace management components, each flight control information message associated with at least one aircraft of the plurality of aircraft; and communicating said received flight control information to the at least one aircraft.

As an option, the computer-implemented method according to the fourth aspect, the method including steps and/or features according to any of one or more of the features of the first, second and/or third aspects, combinations thereof, modifications thereto, and/or as herein described.

In a fifth aspect, the present disclosure provides an airspace management apparatus comprising a processor, a memory and a communication interface, the processor, memory and communication interface connected together, wherein the airspace management component is associated with a particular airspace zone of an airspace region of an flight orchestration apparatus according to the first and/or third aspects, features thereof, combinations thereof, modifications thereto, the airspace management apparatus is further adapted to: receive at least flight data associated with a plurality of aircraft in-flight within the particular airspace zone covered by said airspace management apparatus; model the corresponding airspace zone state of at least air traffic in-flight within the particular airspace zone based on received flight data associated with aircraft in-flight within the particular airspace zone; and detect any flight conflicts in relation to at least one or more aircraft in-flight within the particular airspace zone; resolve any detected flight conflicts in relation to said at least one or more aircraft; and send flight control information, via the flight orchestration apparatus, in relation to any detected and/or resolved conflicts associated with said at least one or more aircraft.

As an option, the airspace management apparatus according to the fifth aspect, the apparatus configured or adapted to include one or more of the features according to any of the features of the first, second, third, and/or fourth aspects, combinations thereof, modifications thereto, and/or as herein described.

In a sixth aspect, the present disclosure provides a computer-implemented method of operating an airspace management apparatus comprising: receiving at least flight data associated with a plurality of aircraft in-flight within the particular airspace zone covered by said airspace management apparatus; modelling the corresponding airspace zone state of at least air traffic in-flight within the particular airspace zone based on received flight data associated with aircraft in-flight within the particular airspace zone; and detecting any flight conflicts in relation to at least one or more aircraft in-flight within the particular airspace zone; resolving any detected flight conflicts in relation to said at least one or more aircraft; and sending flight control information, via the flight orchestration apparatus, in relation to any detected and/or resolved conflicts associated with said at least one or more aircraft.

As an option, the computer-implemented method according to the sixth aspect, the method including steps and/or features according to any of one or more of the features of the first, second, third, fourth, and/or fifth aspects, combinations thereof, modifications thereto, and/or as herein described.

In a seventh aspect, the present disclosure provides an apparatus comprising a processor unit, a memory unit and a communication interface, the processor unit connected to the memory unit and the communication unit, wherein the apparatus is configured to implement the computer-implemented method according to any of the second, fourth and/or sixth aspects, combinations thereof, modifications thereto and/or as herein described.

In an eighth aspect, the present disclosure provides a computer-readable medium comprising code or computer instructions stored thereon, which when executed by a processor unit, causes the processor unit to perform the computer-implemented method according to any of the second, fourth and/or sixth aspects, combinations thereof, modifications thereto and/or as herein described.

In a ninth aspect, the present disclosure provides a system comprising: at least one flight orchestration component according to the third aspect, combinations thereto, modifications thereto and/or as herein described; a plurality of airspace management apparatus, each airspace management apparatus according to the fifth aspect, combinations thereof, modifications thereto and/or as herein described; wherein the at least one flight orchestration component is associated with the plurality of airspace management apparatus.

In a tenth aspect, the present disclosure provides a flight management system as herein described with reference to the accompanying drawings.

In an eleventh aspect, the present disclosure provides a method as herein described with reference to the accompanying drawings.

In a twelfth aspect, the present disclosure provides an apparatus as herein described with reference to the accompanying drawings.

In a thirteenth aspect, the present disclosure provides a computer program product as herein described with reference to the accompanying drawings.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1a is a schematic diagram illustrating an example flight management system according to some embodiments of the invention;

FIG. 1b is a schematic diagram illustrating another example flight management system according to some embodiments of the invention;

FIG. 1c is a flow diagram illustrating an example method of flight management operation of the example flight management system of FIGS. 1a or 1b according to some embodiments of the invention;

FIG. 1d is a flow diagram illustrating an example method of flight orchestration operation of the example flight management system of FIGS. 1a or 1b according to some embodiments of the invention;

FIG. 1e is a flow diagram illustrating an example method of airspace management operation of the example flight management system of FIGS. 1a or 1b according to some embodiments of the invention;

FIG. 2a is a schematic diagram illustrating another example flight management system according to a second embodiment of the invention based on the flight management system of FIGS. 1a or 1b according to some embodiments of the invention;

FIG. 2b is a schematic diagram illustrating the architectural components of the flight management system of FIG. 2a according to some embodiments of the invention;

FIG. 2c is a schematic diagram illustrating the data ingestion and processing of the airspace management component of the flight management system of FIGS. 2a and 2b according to some embodiments of the invention;

FIG. 3a is a flow diagram illustrating an example method of flight data ingestion for modelling airspace covered by flight management systems of FIGS. 1a-2c according to some embodiments of the invention;

FIG. 3b is a schematic diagram illustrating another example of flight data ingestion for modelling airspace zone states covered by flight management systems of FIGS. 1a-1b and/or 2a-2c according to some embodiments of the invention;

FIG. 3c is a flow diagram illustrating another example method of correlating flight data for each aircraft from multiple flight data sources for modelling airspace zone states covered by flight management systems of 1a-1b and/or 2a-2c according to some embodiments of the invention;

FIG. 3d is a flow diagram illustrating another example method of data ingestion in a first phase of processing flight data for updating a model of an airspace zone state in a covered by flight management systems of FIGS. 1a-1b and/or 2a-2c according to some embodiments of the invention;

FIG. 3e is a flow diagram illustrating another example method of conflict detection in a second phase of processing flight data for updating a model of an airspace zone state in a covered by flight management systems of FIGS. 1a-1b and/or 2a-2c according to some embodiments of the invention;

FIG. 3f is a flow diagram illustrating another example method of conflict resolution in the second phase of processing flight data for updating a model of an airspace zone state in a covered by flight management systems of FIGS. 1a-1b and/or 2a-2c according to some embodiments of the invention;

FIG. 4a is an schematic diagram illustrating an example of conflict detection and resolution in relation to two aircraft within an airspace zone covered by flight management systems of FIGS. 1a, 1b and/or 2a-3f according to some embodiments of the invention;

FIG. 4b is an schematic diagram illustrating another example of conflict detection and resolution in relation to an aircraft and non-aircraft objects/entities within an airspace zone covered by flight management systems of FIGS. 1a, 1b and/or 2a-3f according to some embodiments of the invention;

FIG. 5a is a schematic diagram illustrating a computer device or apparatus for use with one or more apparatus and/or components of flight management systems of FIGS. 1a, 1b and/or 2a-3f according to some embodiments of the invention;

FIG. 5b is a schematic diagram illustrating an example flight management system according to some embodiments of the invention.

Common reference numerals are used throughout the figures to indicate similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

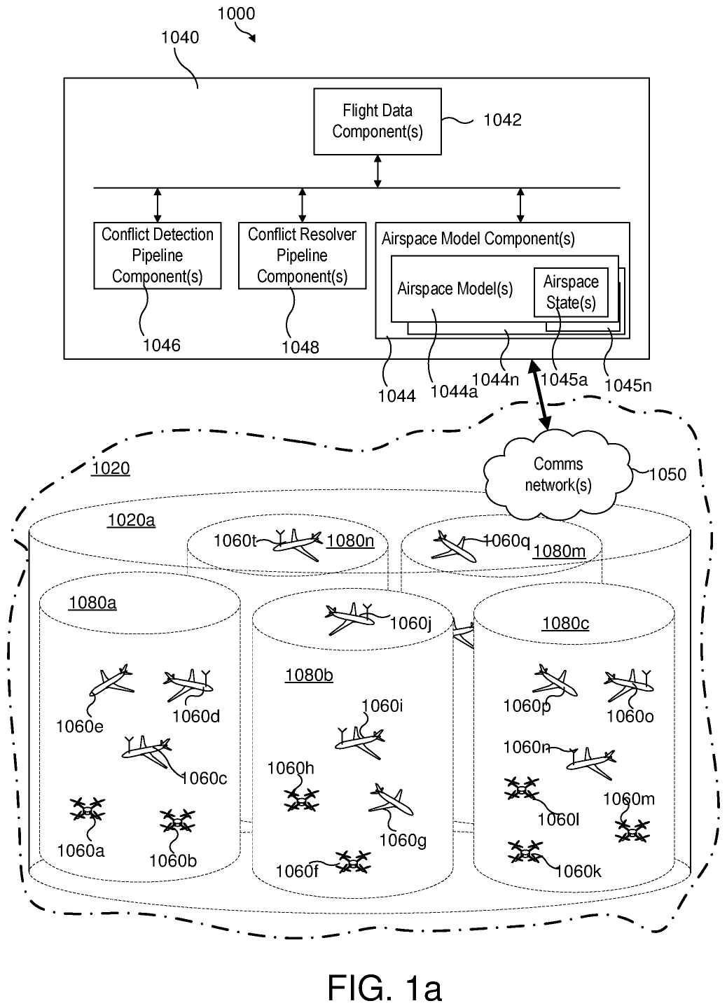

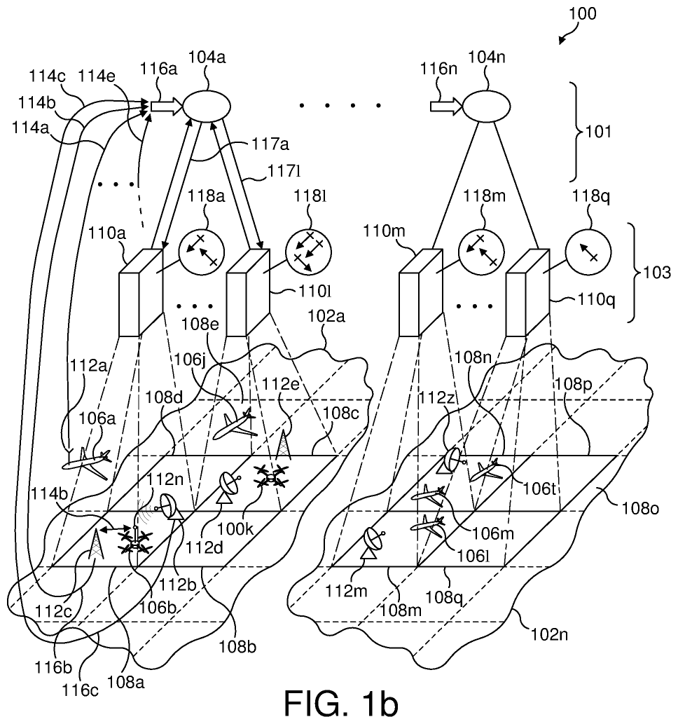

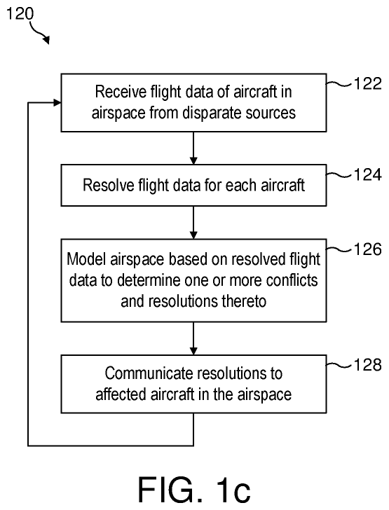

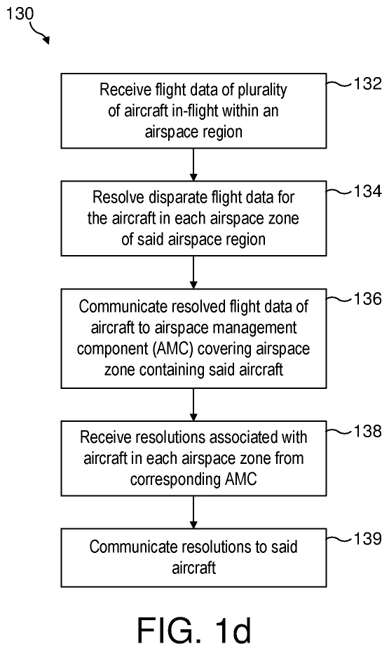

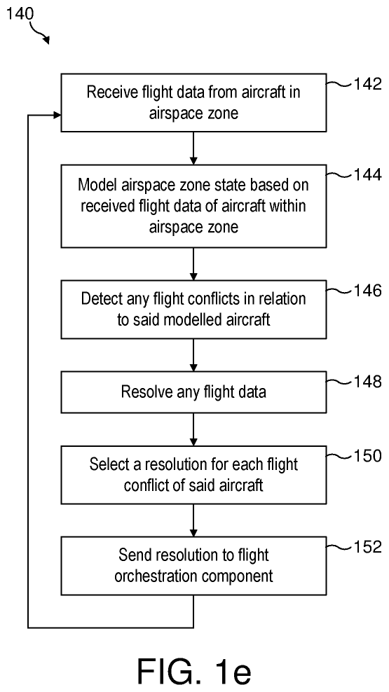

FIG. 1a is a schematic diagram illustrating an example scalable and secure flight management system 1000 for controlling air traffic within an airspace region 1020a of an airspace 1020 via a flight management platform 1040 and communication network(s) 1050, the air traffic including a plurality of unmanned and/or manned aircraft 1060a-1060t in-flight within one or more airspace zones 1080a-1080m of airspace region 1020a of the airspace 1020. The airspace 1020 may include one or more airspace region(s) 1020a, where each airspace region 1020a includes a plurality of airspace zones 1080a-1080n. The airspace 1020, airspace regions 1020a, and/or airspace zones 1080a-1080n may be controlled and/or uncontrolled airspace. The flight management platform 1040 includes one or more flight data component(s) 1042, one or more airspace modelling component(s) 1044, one or more conflict detection component(s) 1046 and one or more conflict resolver component(s) 1048. The flight data component(s) 1042 connected to corresponding airspace modelling component(s) 1044, conflict detection component(s) 1046 and conflict resolver component(s) 1048. For example, as illustrated in FIG. 1a, a flight data component 1042 is configured to receive at least flight data associated with the plurality of aircraft 1060a-1060t in-flight within each of the airspace zones 1080a-1080n from one or more communication network(s) 1050. The airspace modelling component 1044 is configured to model air traffic within each of the airspace zones 1080a-1080n using a corresponding plurality of airspace model(s) 1044a-1044n, wherein each airspace zone 1040a represented by data representative of a corresponding airspace zone state 1045a of a plurality of airzone states 1045a-1045n. Each airzone state 1045a representing at least air traffic 1060a-1060e in-flight within said each airspace zone 1080a based on received flight data associated with said aircraft 1060a-1060e in-flight within said each airspace zone 1080a. For each airspace zone 1080a of the plurality of airspace zones 1080a-1080n, the conflict detection component 1046 is configured to detect any flight conflicts in relation to at least one or more aircraft 106a-106e in-flight within said each airspace zone 1080a based on the airspace zone state 1045a of said each airspace zone 1080a. The conflict resolver component 1048 is configured to resolve any detected flight conflicts by the conflict detection component 1046 in relation to said at least one or more of the plurality of aircraft 1060a-1060t. The flight data component 1042 is further configured to send over the communication network(s) 1020 flight control information in relation to any detected and/or resolved conflicts by the conflict resolver component 1048 associated with said at least one or more of the plurality of aircraft 1060a-1060t.

For simplicity, each airspace region 1020a and corresponding airspace zones 1080a-1080n are illustrated as, without limitation, for example three-dimensional (3D) volumetric cylinders that each describe a particular volume or volumetric portion of the airspace, each of which has an extent in, without limitation, for example in x, y and z-space and/or any other type of 3 dimensional coordinate system (e.g. polar coordinate system) the like. For example, airspace region 1020a may be defined by or based on data representing a 3D volume of a portion of airspace that has an x-y extent that covers an area of ground or land and a z-extent describing a volume up to a particular height or altitude or a z-extent range defining a volume of the airspace between a first altitude and a second altitude (e.g. between ground level up to a maximum altitude or specified altitude, or from a first altitude to a second altitude specified by a operator and the like). The airspace region 1020a shape and size and/or volume may be specified by an operator of the flight management system 1000 or by the flight management platform 1040 itself when allocating one or more airspace regions 1020a and/or airspace zones 1080a-1080n to cover certain portions of airspace 1020 and the like. Similarly, each of the airspace zones 108a-108n may also be defined or based data representative of 3D volumes or volumetric shapes and the like in a similar manner in which each airspace zone 1080a-1080n may describe or represent a 3D volume of a portion of a corresponding airspace region 1020a and the like. Although each airspace region 1020a and corresponding airspace zones 1080a-1080n are described in this example as 3D cylinders, this is for simplicity and by way of example only and the invention is not so limited, it is to be appreciated by the skilled person that each airspace 1020, each of the airspace region 1020a, and each of the corresponding airspace zones 1080a-1080n may be represented by any 3D geometry, 3D shape and/or 3D volumetric shape and the like as the application demands.

An airspace 1020 may cover an area of a geographic area and volume up to a certain range of altitudes and/or or a predefined altitude, which may be changeable, in which the geographic area of said airspace 1020 is of a size such as, without limitation, for example an area the size of one or more states of a country, one or more countries, one or more oceans, multiple countries, one or more continents and/or the whole globe and the like. An airspace region 1020a may cover a smaller portion of the geographic area and volume covered by said airspace 1020 such as, without limitation, for example when the airspace is configured to cover a country (e.g. the United Kingdom), an airspace region may cover a region of said country (e.g. Scotland, Wales, England, and Northern Ireland); when the airspace is configured to cover the globe an airspace region may cover one or more separate countries and/or regions of multiple countries (e.g. United Kingdom, Europe, North Africa, North America, South America, Asia, Australasia, Pacific and the like); and/or any other portion of the airspace 1020 depending on the processing load and/or amount of air traffic 1060a-1060t experienced by said airspace region 1080a such as, without limitation for example, the number of aircraft traversing and/or in-flight within said airspace region 1020a and the like. Each airspace region 1020a may be divided into a plurality of airspace zones 1080a-1080n, where an airspace zone 1080a of the plurality of airspace zones 1080a-1080n is configured to cover a smaller portion of the geographic area and volume of an airspace region 1020a, which may be dependent on the processing load for processing the airspace model 1044a and airspace state 1045a of said airspace zone 1080a and/or based on the amount of air traffic 1060a-1060e experienced by said airspace zone 1080a such as, without limitation, for example the number of aircraft 1060a-1060e or average number of aircraft 1060a-1060e in flight within said airspace zone 1080a and the like. For example, the flight management system 1000 may be configured to cover a global airspace 1020 (e.g. an airspace covering the globe or most of the globe that has air traffic) with multiple airspace regions 1020a that may be one or more large countries/continents or global areas/regions, where each airspace region 1020a may have multiple airspace zones 1080a-1080n that may be dynamically sized from between smaller countries/states down to the size of cities/suburbs and the like based on the amount of air traffic and/or processing load within each of the multiple airspace zones.

Flight data or flight data information associated with an aircraft 1060a may comprise or represent data representative of any type of frequently or rapidly changing data associated with an aircraft 1060a in flight within an airspace 1020, airspace region 1020a and/or airspace zone 1080a such as, without limitation, for example the positional information of the aircraft 1060a; aircraft position updates from the aircraft 1060a and/or one or more flight data source(s) monitoring/detecting said aircraft 1060a; flight telemetry data of the aircraft 1060a; flight telemetry data of the aircraft 1060a received from other aircraft 1060b-1060t; flight data of the aircraft 1060a from flight data sources such as, without limitation for example, monitored surveillance (e.g. radar, ADSB, etc.); incoming aircraft or pilot messages, e.g. command acknowledgements; motion data associated with the aircraft 1060a such as, without limitation, for example position, speed, velocity, attitude, heading and the like; and/or any other flight data associated with the aircraft 1060a for use in determining, forecasting and/or predicting where the aircraft 1060a is within the airspace 1020, airspace region 1020a and/or airspace zone 1080a. Flight data associated with each aircraft 1060a may be received over a communication network 1050 by the flight data component 1042 for processing and/or routing to the associated airspace modelling component 1044 and/or airspace model 1044a that is modelling the airspace state 1045a of the airspace zone 1080a that the aircraft 1060a is determined to be traversing in flight.

Airspace data, airspace condition data and/or non-flight data may comprise or represent data representative of the airspace environment and/or changes thereof of an airspace 1020, airspace region 1020a, airspace zone(s) 1080a-1080n and the like such as, without limitation, for example airspace definitions from airspace/aeronautical information provider(s) (AIPs); airspace definitions and/or updates via notice to airmen messages (NOTAMs); weather information; planned flights or flight plans; restricted airspace; and/or any other airspace information associated with and/or defining the environment, structure and/or geometry of the airspace 1020, airspace region 1020a and/or airspace zone(s) 1080a-1080n for use in defining the airspace state. Airspace data, airspace condition data and/or non-flight data may be generated and/or provided by one or more data services or airspace data sources that the flight management system 1000 may connect to over a communication network 1050. For example, the airspace modelling component 1044 or an airspace management component may connect directly to these data services/sources and request the airspace data/airspace condition data/non-flight data for the airspace region 1020a and/or airspace zone(s) 1080a-1080n it is controlling and/or modelling. This data may be loaded into the corresponding airspace state 1045a of the airspace zone 1080a that is being modelled by the corresponding airspace modelling component 1044. This may be performed on initialisation of the airspace modelling component 1044/airspace management component during start-up. The airspace modelling component 1044 may then monitor these data services/sources for changes to the airspace 1020, airspace region 1020a and/or airspace zone(s) 1080a-1080n and apply these changes in said airspace data to the corresponding modelled internal airspace state associated with said airspace zone.

The flight management system 1000 may be further configured to enhance the scalability of the flight management platform 1040 to cover wider airspace(s) 1020, airspace region(s) 1020a, and/or more airspace zones 1080a-1080n (e.g. airspace coverage over one or more states/counties with in a country, one or more countries, globally etc.). This may be achieved using a scalable flight management architecture including a flight orchestration layer and airspace management layer for managing air traffic 106a-106t within airspace 1020. The flight orchestration layer operates to split the airspace 1020 into a plurality of airspace regions 1020a-1020n, the airspace management layer operates to split each airspace region 1020a into a plurality of airspace zones 1080a-1080m. The flight orchestration layer may include one or more flight data component(s) 1042 that operates to act as a flight and/or airspace data ‘sink’ for any aircraft 1060a-1060t that is able to be detected from, without limitation, for example ground based infrastructure or flight data sources and/or location ‘broadcasts’ of the aircraft 1060a-1060t to the flight orchestration layer. For example, the flight and/or airspace data of the aircraft 1060a-1060t in the airspace 1020 may be transmitted over a communications network 1050 such as, without limitation, for example the Internet or other type of communications network(s) and the like. The flight data for each aircraft 1060a of the plurality of aircraft 1060a-1060t may be received over the communication network 1050 by the flight orchestration layer from multiple disparate flight data sources and/or the aircraft 1060a itself. The flight data is generally very time sensitive data associated with the positions, speed and/or velocity, heading, altitudes and any other positional information of an aircraft in-flight, which means the flight orchestration layer and/or the flight data component(s) are specifically configured to receive this type of data.

The airspace data or airspace condition data (also referred to as non-flight data) associated with an airspace 1020, airspace region(s) 1020a and/or airspace zone(s) 1080a-1080n may also be received over the communication network(s) 1050 by the airspace management layer from multiple disparate airspace data sources and/or services. As described, airspace data or airspace condition data includes more static data associated with the airspace, airspace region(s), and/or airspace zone(s) such as without limitation, for example, airspace definitions, weather info, NOTAM etc., which can be monitored by and loaded by the corresponding airspace model component 1044 (or airspace region managers) and/or airspace model(s) 1044a-1044n in relation to the airspace region 1020a and/or airspace zones 1080a-1080n, respectively, into their respective airspace states 1045a-1045n. For example, this may be performed either via an internal message queue/buffer associated with each airspace model 144a-144n or directly into airspace state 1045a-1045n in between conflict processing intervals. The airspace data and/or airspace condition data is less time sensitive, such that each airspace layer and/or other components of the flight management platform 1040 such as, without limitation, for example airspace model component(s) 1044 may receive the airspace data/airspace condition data of the corresponding airspace regions 1020a/airspace zones 1080a-1080n. Alternatively of additionally, the airspace data for an airspace 1020, airspace region 1020a and/or airspace zone 1080a-1080n may also be received over the communication network(s) 1050 by the flight orchestration layer from multiple disparate airspace data sources and/or services. The airspace 1020, airspace regions 1020a, and/or airspace zones 1080a-1080n may be controlled and/or uncontrolled airspace.

Frequently changing data and/or messages such as the flight data and/or messages containing flight data that includes, without limitation, for example position of aircraft, velocity and/or speed, altitude, attitude, heading, and/or any aircraft communication messages and the like are sent via the corresponding flight data component(s) 1042 in the flight orchestration layer. These data and/or messages may include data representative of a geo-spatial data field within them that enables the corresponding flight data component(s) 1042 to identify which airspace region and/or which airspace zone this data pertains to and/or originates from within and routes each portion of flight data and/or messages including flight data to the corresponding airspace modelling component 1044. For example, these messages associated with each aircraft 1060a may be routed using geo-spatial routing to the correct airspace modelling component 1044 dealing with the airspace model 1044a and corresponding airspace state 1045a of the airspace zone 1080a that the flight data of said each aircraft 1060a that is associated with it. Less frequently changing data and/or messages including airspace data and/or airspace condition data such as, without limitation, data representative of weather data, flight plan data, airspace data (e.g. airfields, restricted airspace, etc.) and/or terrestrial objects/obstacles and/or airspace hazards, NOTAMs, and the like may be requested and/or received for a specific airspace zone of each of the airspace zones 1080a-1080n from one or more data services by the corresponding airspace modelling component(s) 1044, where the corresponding airspace models 1044a-1045n and associated airspace states 1045a-1045n are updated. This is used by the airspace modelling component(s) 1044 for updating the airspace state 1045a of each specific airspace zone 1080a such that as many aircraft 1060a-1060e and objects within each airspace zone 1080a are appropriately modelled. Given this, the flight data associated with the plurality of aircraft 1060a-1060t is separated and prioritised from the airspace/airspace condition data because the flight data information, which changes rapidly in real-time when aircraft are in-flight, will typically update within short time intervals/timeframes at a frequency, without limitation, for example, in the range of milliseconds to seconds whereas airspace data/airspace condition data typically updates within longer time intervals/time frames at frequencies, without limitation, for example in the range of minutes, hours and/or days. Thus, the flight data and airspace data (or airspace condition data) are arrange to be received by different components of the flight management platform 1040, which in this example may be the flight data component(s) 1042 and airspace model component(s) 1044, respectively.

Once the flight data is received, the flight orchestration layer via the corresponding flight data component(s) 1042 resolves and standardises the flight data associated with each aircraft and communicates the resolved flight data to the corresponding airspace zones of the airspace management layer. The airspace management layer is configured to evaluate the received flight and airspace data against all other received flight data associated with aircraft 10601-1060t within each airspace zone 1080a-1080n, including, without limitation, for example: 1) the positions of other unmanned aircraft; 2) the positions of other manned aircraft; 3) the known extents (in 3 dimensions, with time added) of volumes of restricted/controlled airspace (e.g. NOTAMS); 4) forecast data about weather systems; 5) any known flight plans of other unmanned aircraft; 6) any known flight plans of other manned aircraft; and 7) any other flight data/airspace data and the like associated with aircraft 1060a-1060t and/or airspace zones 1080a-1080n in the airspace 1020 covered by the flight orchestration layer. The airspace management layer operates to act on the received flight and airspace data to model the detected air traffic of aircraft 1060a-1060t within each airspace zone 1080a-1080n, model the airspace state and/or airspace infrastructure (e.g. controlled/restricted airspace around airfields and other restricted geographic locations such as, without limitation, for example cities, military bases, power plants, highways, power and the like) and other airspace features (e.g. weather systems), and perform collision avoidance via issuance of resolution messages including data representative of direct/indirect actions/instructions to those aircraft 1060a-1060e in the airspace zone 1060a that the flight management platform 1040/system 1000 is capable of communicating with via communications network 1050.

The flight management system 1000 is configured to be aware what aircraft it is sensing via the received flight data, what aircraft the system is able to communicate with (e.g. ‘talk to’ either directly to, without limitation, for example the flight controller, pilot and/or remote flight control station associated with the aircraft for communicating resolution messages including data representative of direct and/or indirect action in relation to collision avoidance and the like. The flight management system 1000 is also configured to be aware of those aircraft detected within the received flight data that it cannot communicate with. For example, manned aircraft whose location has been ‘detected’ but the flight management system is unable to communicate with. Thus, the flight management system 1000 may assist in adjusting the courses of the aircraft that it can communicate with via resolution messages including data representative of direct or indirect actions for avoiding collisions with all aircraft detected within the airspace.

The airspace management layer of the flight management system 1000 is configured to, before formulating what resolution messages to dispatch to those aircraft it can communicate with in each of the airspace zones 1080a-1080n, evaluate, without limitation, for example the following: 1) aircraft priority (including its payload); 2) The latency of the communication connection with the aircraft; 3) what are the rules of the air in the vicinity of the airspace region being detected; 4) aircraft type such as, without limitation, for example is it fixed-wing or is it a rotary-wing and the like, which is important for resolving a conflict (e.g. a rotary-wing aircraft may be able to ‘hover’ to avoid a conflict, or a fixed-wing aircraft will need to veer off course in, for example, a long-sweeping arc due to the way the vehicle achieves flight); 5) aircraft flight data such as, without limitation, for example vehicle course, speed, heading; 6) aircraft intended flight plan/destination; 7) nearby airspace hazards and/or obstacles; 8) the effect of making a suggested change on the aircraft and other nearby aircraft and the like; and/or 9) any other information associated with each of the aircraft suitable for determining one or more conflicts associated with the aircraft and whether a collision with another aircraft is imminent and the like.

After evaluating all of these variables and scenarios, the airspace management layer of the flight management system 1000 may issue resolution messages including direct/indirect actions and/or instructions to those aircraft with detected conflicts that it can communicate with to assist in avoiding collisions and/or conflicts, and to monitor said aircraft for compliance with said resolution messages sent thereto. The flight orchestration layer via, for example, flight data component 1042 forwards any issued resolution messages to each aircraft.

The flight management system 1000 may be designed to be extensible and scalable and is configured to split the processing of flight data of aircraft 1060a-1060t to within each airspace zone 1080a-1080n into stages in which each airspace zone 1080a may be covered by a conflict detection pipeline component 1046 and conflict resolution pipeline component 1048. For example, each conflict detection pipeline component 1046 associated with an airspace zone 1080a may include a plurality of conflict detectors and each conflict resolution pipeline component 1048 associated with the airspace zone 1080a may include a plurality of conflict resolvers. Each of the conflict detectors may use the modelled airspace state 1045a of the corresponding airspace zone 1080a to detect a different type of conflict associated with each aircraft 1060a-1060e within the corresponding airspace zone 1080a. Each of the conflict resolvers may also determine a different type of resolution based on the modelled airspace state 1045a of the corresponding airspace zone 1080a in relation to one or more detected conflicts relating to one or more of the aircraft 1060a-1060e within the corresponding airspace zone 1080a. The conflicts and/or resolutions may be evaluated to determine the best resolution that may be performed in relation to avoiding one or more determined/detected conflicts of those affected aircraft 1060a-1060e.

Conflict detectors may be specific to a type of conflict between aircraft and may be ‘trained’ to identify particular conflicts. Multiple conflict detectors might ‘fire’ or output a potential conflict associated with the same physical aircraft. For example, conflicts associated with “unmanned aircraft to manned aircraft”, “unmanned aircraft to unmanned aircraft”, “unmanned aircraft to “static” airspace objects”, “manned aircraft to “static” airspace objects” such as, without limitation, for example “drone to drone”, or “drone to manned aircraft”, or “drone to restricted airspace”, or “drone to weather system” and the like. The conflict detectors are modular and can be adapted or added at any time when new capabilities or flight data becomes available.

Conflict resolvers are also configured to be expandable, and are geography and regulation aware. Conflict resolvers can each ingest multiple ‘conflict detections’ from the conflict detectors for each physical aircraft, but have the task of ensuring only one (i.e. the most appropriate) resolution with avoiding action is issued, and that the appropriate action is given based on the various flight and aircraft variables given.

Due to improvements in aircraft technologies and its applications, both manned and unmanned air traffic is continuing to increase. Mass adoption of unmanned air traffic for, without limitation, for example inspections of public/private infrastructure, surveillance and security, passenger transport, and deliveries within uncontrolled and controlled airspace is increasing. Thus, there needs to be a scalable air traffic control capability with the ability to perform command and control of the plethora of manned and unmanned air traffic that current conventional human air traffic controllers may not be able to safely analyse, control and/or issue voice instructions and/or appropriate permissions for all manned and unmanned aircraft wishing to operating in uncontrolled and/or controlled airspace.

The flight management system 1000 of the present invention as described herein provides such a scalable solution and defines a common standard for both aircraft and software manufacturers to choose the most appropriate communication mechanism (e.g. Cellular, satellite, wired) to establish a connection to manned and unmanned air traffic control services provided by the flight management system. As an option, the flight management system may be configured to be centrally managed and updates to it are in real-time, which means that the system is reconfigurable, adaptable should airspace or flight regulations change, or an urgent notification of airspace changes takes place, all aircraft in communication with the flight management system will receive such changes immediately.

The flight management system 1000 and/or as herein described defines and sets a standard that enables aircraft without specialist collision avoidance equipment/services (e.g. TCAS/ADS-B and the like) to safely coexist within the current air traffic control systems and the like. Moreover, the flight management system 1000 and/or as herein described also enables any aircraft, even aircraft with specialist collision avoidance equipment/services, access to deconfliction with other things/objects/entities and/or other aircraft that cannot carry such specialist equipment such as, without limitation, for example transponders, TCAS/ADS-B and the like etc., or that have access to real-time changes in weather, further planned flights, NOTAM activations (e.g. temporary flight restriction(s) (TFRs)) etc. The flight management system 1000 and/or as herein described is configured to perform collision detection and resolution of a modelled airspace state, which is based on received/detected flight data and/or airspace data generated from multiple disparate flight data sources associated with aircraft, objects, entities and/or things transiting or in-flight within the airspace, and providing flight control information/commands/instructions to said aircraft over a communication network. Although the flight management system 1000 may be applicable for all aircraft within an airspace, it is particularly useful for those aircraft such as, without limitation, for example light aircraft; unmanned aircraft, drones or UAVs with an operator and/or flight controller or autopilot system; or any other aircraft that do not typically have access to the required specialist devices (e.g. TCAS/ADS-B) and the like because it enables these aircraft to safely coexist within current and/or the same air traffic control system used by other commercial aircraft and/or military aircraft and the like. All that is required is access by the operator, pilot and/or flight controller/autopilot system of an aircraft to a communication network connected to the flight management system 1000 and/or flight management services thereof for providing at least one of flight data and/or for receiving flight control information and the like from said flight management system 1000 or service. The flight management system 1000 and/or as herein described with reference to FIGS. 1a to 5b provides for a robust, scalable, secure and cost effective approach for improving air traffic safety between manned and/or unmanned aircraft and the like.

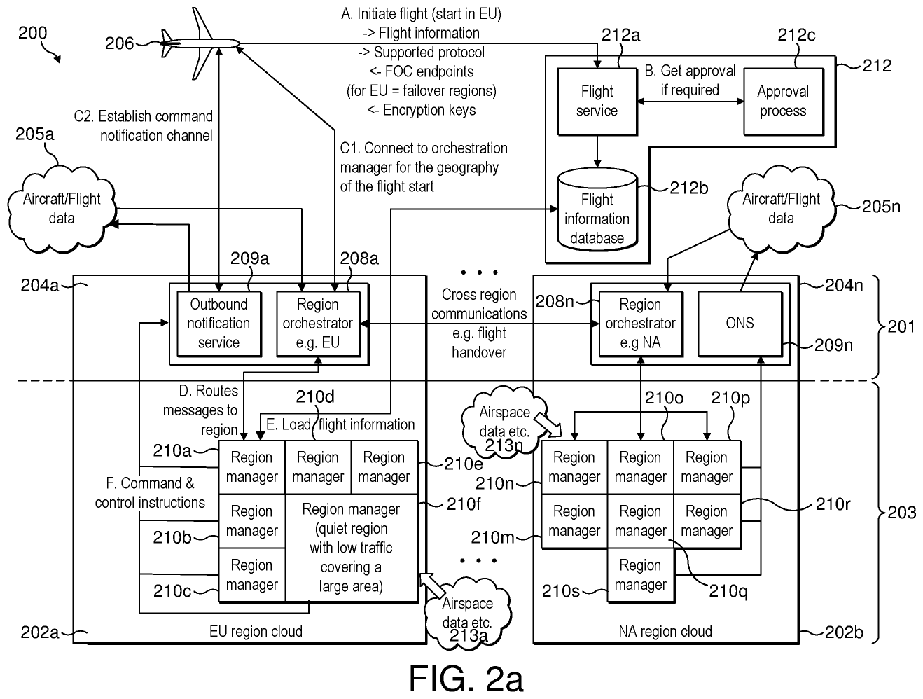

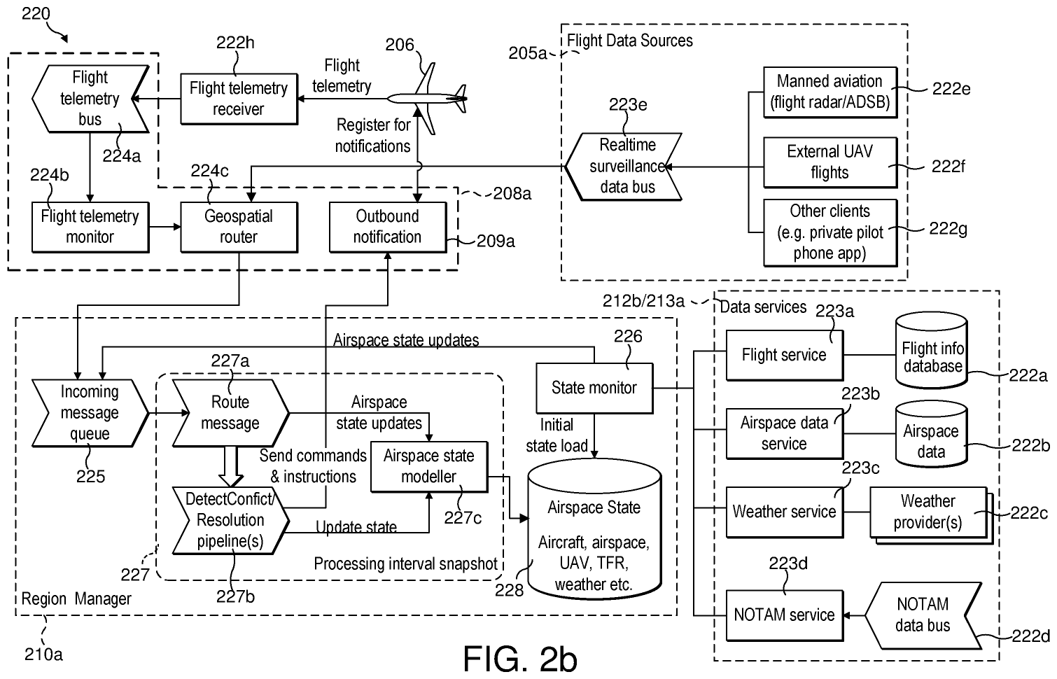

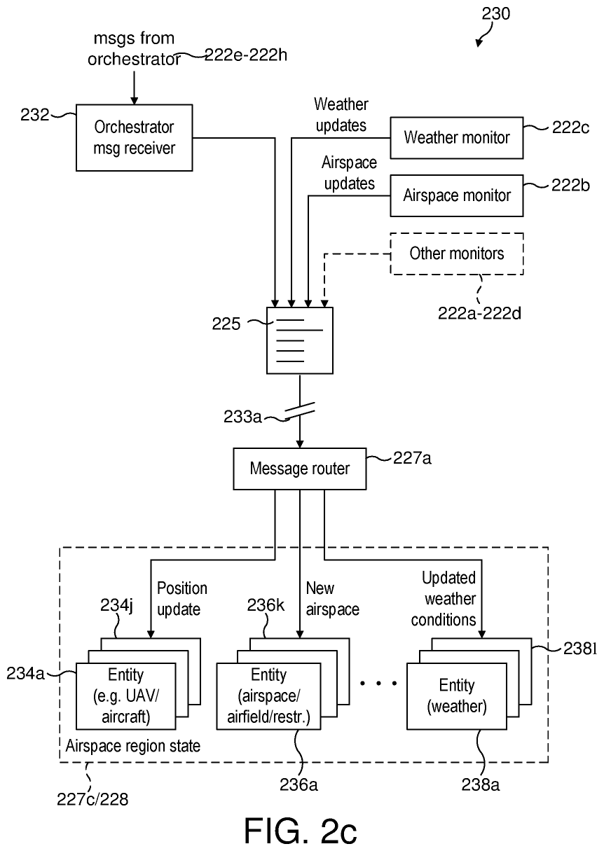

FIG. 1b is a schematic diagram illustrating another overview of an example of a flight management system 100 based on flight management system 1000, while FIGS. 2a and 2b illustrate more detailed system architectures 200, 220 and 230 of the flight management system 100 and/or flight management system 1000. Referring to FIG. 1b, the flight management system 100 is further modified based on flight management system 1000 to include a flight orchestration layer 101 covering an airspace comprising a plurality of airspace regions 102a-102n and an airspace management layer 103 in communication with the flight orchestration layer 101. The flight orchestration layer 101 is configured to receive flight data information (also referred to herein as flight data) over one or more communication networks from a plurality of flight data information sources in relation to air traffic in-flight in the airspace regions 102a-102n, where the airspace management layer 103 is configured to receive and process the flight data information associated with air traffic within the airspace and receive and process airspace data/airspace condition data of the airspace and model, in real-time, the airspace state of air traffic in each of the airspace regions whilst at the same time using each modelled airspace state for detecting and resolving any conflicts in relation to the air traffic within the airspace, which is communicated to the flight orchestration layer 101. The flight orchestration layer 101 communicates flight control information over the one or more communication networks to any air traffic in conflict based on the conflict resolutions determined/selected by the airspace management layer 103. The air traffic that receives a conflict resolution in relation to one or more potential conflicts may then take action based on the conflict resolution to avoid the one or more conflicts affecting it.

The flight orchestration layer 101 and airspace management layer 103 may be implemented as a scalable and adaptable computing or communication fabric (network) or cloud-computing platform/infrastructure configured for real-time modelling of air traffic within the airspace, detecting one or more conflicts associated with the air traffic, and evaluating the conflicts and providing conflict resolutions for resolving the detected conflicts based on the state of the air traffic, from which the affected portions of air traffic may take action to avoid or prevent the detected conflicts from arising. The air traffic may include a plurality of manned aircraft and/or unmanned aircraft and the airspace may include controlled and/or uncontrolled airspace.

In particular, the flight orchestration layer 101 includes a plurality of flight orchestration components (FOCs) 104a-104n, each flight orchestration component (FOC) 104a covering a specific airspace region 102a of the plurality of airspace regions 102a-102n. Each of the airspace regions 102a-102n includes a plurality of aircraft 106a-106k and 1061-106t in-flight within said each airspace region 102a-102n. The aircraft 106a-106t may be manned and/or unmanned aircraft. Each of the plurality of airspace regions 102a-102n is split into a plurality airspace zones 108a-108e and 108m-1080. The airspace management layer 103 includes a plurality of airspace management components (AMCs) 110a-110q that are grouped into sets of AMCs 110a-1101 and 110m-110q in which each AMC in each set of AMCs 110a-1101 is configured to cover a specific airspace zone 108a-108e associated with a particular airspace region 102a of the plurality of airspace regions 102a-102n. Although in this example, each of the plurality of airspace zones 108a-108o are rectangular or quadrilateral shaped, this is for simplicity and the invention is not so limited, it is to be appreciated by the skilled person that each of the plurality of airspace zones 108a-108o may be differently sized, shaped and/or may overlap depending on the level of geographic coverage required and/or the number aircraft within each airspace zone.

Although each of the airspace regions 102a-102n and corresponding airspace zones 108a-108o are described and illustrated in two-dimensions, this is for simplicity and by way of example only and the invention is not so limited, it is to be appreciated by the skilled person that each airspace, each of the airspace regions 102a-102n, and each of the airspace zones 108a-108o may be representative of a three-dimensional geometry and/or described as a volume or volumetric portion of airspace, each of which has an extent in, without limitation, for example x, y and z-space and/or any other type of 3 dimensional coordinate system (e.g. polar coordinate system) the like. For example an airspace region may be defined as a 3D volume of a portion of airspace that has an x-y extent that covers an area of ground or land and a z-extent describing a volume up to a particular height or altitude or a z-extent range defining a volume of the airspace between a first altitude and a second altitude (e.g. between ground level up to a maximum altitude or specified altitude, or from a first altitude to a second altitude specified by an operator and the like), which may be specified by an operator of the flight management system. Similarly, each of the airspace zones 108a-108o may also be defined in a similar manner in relation to describing a 3D volume of a portion of an airspace region and the like.

For example, the set of AMCs 110a-1101 are each configured to cover a particular airspace zone of the airspace zones 108a-108e of airspace region 102a, which is controlled by FOC 104a. As well, the set of AMCs 110m-110q are each configured to cover a particular airspace zone of the airspace zones 108m-108q of airspace region 102n, which is controlled by FOC 104n. Each of the FOCs 104a to 104n are configured to be in communication with the corresponding sets of AMCs 110a-1101 and 110m-110q.

The FOCs 104a-104n of the flight orchestration layer 101 may each include a flight data component based on, without limitation, for example a flight data component 1044 described with reference to FIG. 1a and/or modifications thereof as further described herein, where each flight data component of an FOC 104a is configured for receiving flight data associated with those plurality of aircraft 106a-106t in-flight within the corresponding airspace regions 102a-102n. As described with reference to FIG. 1a and herein, the flight data or flight data information of an aircraft includes, without limitation, for example data representative of at least the location of the aircraft transmitted or broadcast by said aircraft or a flight data information source on said aircraft; data representative of at least the location of the aircraft transmitted or broadcast by one or more other flight data information sources. The flight data information source on said aircraft may send flight data based on, without limitation, for example data representative of a heading, speed, velocity, location, latitude and longitude, altitude, global positioning system data, and/or any other flight data associated with said aircraft and capable of being used for modelling the airspace state in relation to said aircraft. The flight data associated with each aircraft may be transmitted over a communication network in one or more messages or packets from one or more aircraft and/or flight data information sources. The one or more other flight data information sources may further include, without limitation, for example at least one from the group of: another aircraft; a radar detecting position of said aircraft; All Purpose Structured Eurocontrol Surveillance Information Exchange (ASTERIX) air traffic services information; airspace surveillance data associated with one or more of said plurality of aircraft; automatic dependent surveillance broadcast, ADS-B, data associated with one or more of said aircraft; flight planning services configured for providing flight plans of one or more of the aircraft of the plurality of aircraft; any other standard for exchange of air traffic services information and the like.

The flight data of these aircraft 106a-106t may be transmitted over one or more communication networks from a corresponding plurality of flight data information sources 112a-112z in and around the corresponding airspace regions. The flight data information sources 112a-112z may be configured for detecting, transmitting and/or receiving flight data information associated with each of the aircraft 106a-106t in-flight within each of the airspace regions 102a-102n. For example, flight data associated with the plurality of aircraft 106a-106k in airspace region 102a may be detected, received and/or determined by flight data information sources 112a-112e, each of which transmits flight data associated with the plurality of aircraft 106a-106k in airspace region 102a over one or more communication channels 114a-114e of one or more communication network(s) to the flight data component of FOC 102a. The one or more communication channels 114a-114e of flight data may form a flight data pipe 116a that funnels flight data associated with one or more aircraft 106a-106k within airspace region 102a to the flight data component of the FOC 104a covering airspace region 102a. Similarly, FOC 104n includes a flight data component that is configured to receive flight data associated with a plurality of aircraft 1061-106t in-flight within airspace region 102n. For example, in the airspace region 102a covered by FOC 104a, the flight data associated with an aircraft 106a in airspace region 102a may include data representative of, without limitation, for example at least one or more the speed, velocity, heading, type of aircraft, payload, flight plan, and/or any other flight data information associated with the aircraft 106a that can be used for, without limitation, for example: real-time modelling of the airspace state of the air traffic within airspace of said airspace region 102a; detecting conflicts between aircraft; resolving conflicts between any aircraft and the like within airspace region 102a; and sending flight control information and/or notifications to one or more of the corresponding aircraft via the communication network for enabling said aircraft to take action and the like and/or as the application demands. In addition, the flight data associated with each of the aircraft 106a-106k of airspace region 102a may also include information for identifying the relevant airspace zone of the airspace zones 108a-108e that said each of the aircraft 106a-106k may be transiting and/or traversing. This means that the corresponding portions of flight data associated with each aircraft 106a-106k of an airspace region 102a may be routed to the correct AMCs 110a-1101 covering said airspace zones 108a-108e and the like for updating the corresponding airspace state by said airspace model.

On receiving flight data from flight data pipe 116a, the FOC 104a may process the received flight data corresponding to each aircraft 106a of the plurality of aircraft 106a-106k transiting the airspace region 102a to identify the airspace zone 108a of the airspace region 102a that said each 106a is transiting. The FOC 104a sends the identified flight data associated with each aircraft 106a to the AMC 110a that is covering the identified airspace zone 108a. As the received flight data in relation to each aircraft 106a-106k may be received from different flight data information sources 112a-112e, it may have different formats and/or flight data information associated with each of the aircraft 106a-106k. The received flight data for each of the aircraft 106a-106k in airspace 102a may be resolved and/or consolidated/standardised to form canonical flight data or flight data messages corresponding to said each of the aircraft 106a-106k in-flight in airspace region 102a. This may be performed by the FOC 104a of the flight orchestration layer 101. Alternatively or additionally, this may be performed by the corresponding AMC 110a of the airspace management layer 103.

Each of the AMCs 110a-1101 are continually receiving a stream of flight data or a flight data stream 117a-1171 associated with the aircraft 106a-106k that are transiting the corresponding airspace zones 108a-108e that are covered by said each of the AMCs 110a-1101. For example, AMC 110a receives a flight data stream 117a from the FOC 104a in relation to aircraft 106a-106c transiting the airspace zone 108a that is covered by AMC. In one example embodiment, the flight data stream 117a may include canonical flight data for each aircraft 106a-106c compiled from flight data transmitted from flight information sources 112a-112c in relation to each aircraft 106a-106c in airspace zone 108a.

Each AMC 110a of the set of AMCs 110a-1101 may each include an airspace model component based on, without limitation, for example airspace model component 1044 with airspace models 1044a-1044n modelling airspace states 1045a-145n as described with reference to FIG. 1a and/or modifications thereof as further described herein. The airspace model component of each AMC 110a of the set of AMCs 110a-1101 is configured to generate, maintain and update an airspace model 118a corresponding to the air traffic 106a-106c within the airspace zone 108a based on the flight data stream 117a of received flight data corresponding to each aircraft 106a-106c transiting the airspace zone 108a. For example, the airspace model 118a defines an airspace state space that includes a plurality of entities within the airspace zone 108a and associated flight data and/or metadata. The plurality of entities include entities of a mobile type and entities of a static type. Entities of the mobile type, or mobile entities, are associated with real-world objects that move such as, without limitation, for example aircraft 106a-106t, weather systems and/or movable hazards and the like. Entities of a static type, or static entities, are associated with real-world or conceptual static objects that are defined to be static in a geographic location and are generally immovable such as, without limitation, for example terrain features, hills, mountains, buildings, towers, power lines, controlled airspace such as airports or other restricted airspace defined by notice to airmen messages (NOTAMs) and the like, no fly zones, private land and the like and/or as the application demands. Each of the aircraft 106a-106c transiting the airspace zone 108a are mapped to corresponding mobile aircraft entities within the airspace state space 118a. The state or metadata of each mobile aircraft entity representing an aircraft 106a-106c is updated based on the received flight data associated with said corresponding aircraft 106a-106c.

The airspace model component of each AMC 110a is configured to receive flight data or flight data information from the flight management component of the FOC 104a corresponding to each aircraft 106a-106c transiting the airspace zone 108a covered by AMC 110a. The airspace model component of each AMC 110a is also configured to receive airspace data and/or airspace condition data associated with each of the airspace zones 108a-108e from one or more data services and/or airspace data sources for use in modelling and generating the airspace state of said each airspace zones 108a-108e covering the airspace region 104a of the AMC 110a. For example, each AMC 110a-1101 may be further configured to request and/or receive, from further airspace information data sources, airspace data or airspace condition data associated with the airspace region 102a covered by said each FOC 104a (e.g. non-flight data associated with each airspace zone of the airspace region describing further objects/restrictions of the airspace region etc.). For example, the received airspace data and/or airspace condition data associated with a particular airspace zone 108a of the airspace zones 108a-108e in the airspace region 102a covered by AMC 110a is used by the corresponding airspace modelling component of the AMC 110a for modelling static objects/entities or non-aircraft objects/entities in the airspace zone 108a and updating the airspace zone state accordingly based on this received airspace information. The airspace data or airspace condition data (or non-flight data associated with an airspace/airspace region/airspace zone) may include data representative of, without limitation, for example one or more from the group of: airspace surveillance data; airspace geometry/flight restriction data; airspace obstructions and/or terrestrial structures; flight plans or portions of flight plans of aircraft traversing said airspace zone; airspace disturbances adversely affecting aircraft based on at least one or more from the group of: efflux from a structure, volcano ash, pyrotechnics, weapons firing, light and/or other disturbances adversely affecting aircraft and/or pilots of aircraft and the like; airspace weather data; and notice to airmen message (NOTAM) data; any other airspace condition data defining the structure of the airspace, regulations associated with the airspace, environmental data associated with and/or affecting the airspace and the like.

Each AMC 110a further includes one or more conflict detection pipeline components and/or conflict resolution pipeline components based on, without limitation, for example conflict detection pipeline component(s) 1046 and conflict resolver pipeline component(s) 1048 as described with reference to FIG. 1a and/or modifications thereof as further described herein. The conflict detection pipeline component(s) of each AMC 110a may be further configured to detect any flight conflicts in relation to at least one or more aircraft of the aircraft in-flight within the particular airspace zone based on analysing each of the entities in the airspace state of the airspace model 118a with respect to each of the other entities in the airspace state of the airspace model 118a. Based on any detected flight conflicts in relation to one or more of the aircraft entities corresponding to said one or more aircraft 106a-106c in the airspace zone 108a, the conflict resolver components of said each AMC 110a may be further configured to resolve any detected flight conflicts in relation to said at least one or more aircraft based on the properties of each aircraft 106a-106c and the states of each of the entities represented by each of the aircraft 106a-106c.

In order to perform maintenance of the airspace model and/or corresponding airspace states, conflict and resolution evaluation/analysis and receive the real-time incoming flight data stream 117a of flight data associated with each of the aircraft 106a-106c transiting an airspace zone 108a, the AMC 104a is configured to perform a processing interval in which the airspace state of an airspace model 118a is frozen and conflict/resolution analysis is performed, whilst at the same time any flight data received from flight data stream 117a is queued, buffered and/or gated. For example, periodically gate, queue or buffer the incoming flight data from the flight data stream 117a over a first time interval, whilst simultaneously performing an update of the airspace state of airspace model 118a based on previously buffered or queued flight data from a previous time interval and processing the updated airspace state of the airspace model 118a for conflict detection and conflict resolution evaluation/determination, and sending conflict resolution messages (or flight control information) to the corresponding aircraft 106a-106c of the airspace zone 108a. This process is repeated or iterated for subsequently received flight data, which is again gated, queued or buffered, whilst releasing the queued or buffered flight data for updating the model 118a, detecting conflicts, evaluating resolutions and sending conflict resolution messages towards each aircraft that requires it.

The AMC 110a is configured to select, for each set of conflicts and resolutions in relation to each aircraft 106a-106c, the most optimal resolution that would resolve the conflict(s) or resolve at least the most imminent conflict(s) in relation to the aircraft 106a-106c. The AMC 110a sends flight control information including data representative of the selected conflict resolution in relation to the associated aircraft 106a-106c via the corresponding FOC 104a. Thus, the FOC 104a receives a plurality of conflict resolution messages from each of the plurality of AMC 110a-1101 of the airspace region. The FOC 104a sends data representative of each received conflict resolution to the corresponding aircraft transiting the airspace region 102a covered by FOC 104a. In this manner, the flight controller, pilot and/or human remote pilot, on receiving the conflict resolution message via a client device may take action in relation to the associated aircraft to avoid and/or resolve the detected conflict.

FIG. 1c is a flow diagram illustrating an example flight management process 120 of the example flight management systems 1000 or 100 of FIGS. 1a and/or 1b according to some embodiments of the invention. The flight management process 120 includes the following steps of: In step 122, receive flight data from a plurality of disparate information sources associated with aircraft in the airspace. In step 124, resolving the received flight data for each aircraft within the airspace. In step 126, model airspace based on the resolved flight data to determine one or more conflicts associated with one or more aircraft within the airspace, and determining and evaluating resolutions to each of the one or more conflicts associated with said one or more of the aircraft within the airspace. In step 128, communicating the resolutions to the affected aircraft within the airspace.

FIG. 1c is a flow diagram illustrating an example flight orchestration method 130 that may be performed by the flight data component 1042 of flight management system 1000 of FIG. 1a and/or a FOC 104a of the example flight management system 100 of FIG. 1b according to some embodiments of the invention, combinations thereof, modifications thereto and/or as described herein. For example, the FOC 104a is part of the flight orchestration layer 101 covering an airspace comprising a plurality of airspace regions 102a-102n. The FOC 104a may include a flight data component that may be configured to perform the flight orchestration method 130 based on the following steps of: In step 132, receiving at least flight data associated with a plurality of aircraft 106a-106k in-flight within the airspace region 102a covered by said FOC 104a. In step 134, when the received flight data for an aircraft 106a is received from disparate information sources 112a and 112b, performing resolving the received flight data for said aircraft 106a. In step 136, communicating the flight data and/or resolved flight data associated with each aircraft 106a-106k to each corresponding AMC 110a covering airspace zone 108a that is associated with and/or contains said each aircraft 106a-106k. In step 138, receive one or more conflict resolution messages associated with or addressed to one or more aircraft in each airspace zone 108a-108e from the corresponding AMC 110a-1101. In step 139, communicating data representative of the conflict resolution messages and/or flight control information associated with the conflict resolution messages to one or more of the plurality of aircraft.

FIG. 1d is a flow diagram illustrating an example airspace management method 140 that may be performed by the airspace modelling components 1044, conflict detection pipeline and/or resolver components 1046 and 1048 of flight management system 1000 of FIG. 1a and/or an AMC 110a of the example flight management system 100 of FIG. 1b according to some embodiments of the invention, combinations thereof, modifications thereto and/or as described herein. As an example, the airspace management layer 103 includes a plurality of sets of AMCs 110a-1101 and 110m-110q, each set of AMCs 110a-1101 connected to a FOC 104a of a plurality of FOCs 104a-104n, said FOC covering an airspace region 102a of airspace. Each AMC may include and/or include the functionality of an airspace modelling component(s), conflict detection pipeline and/or resolver components. Each AMC 110a is allocated and/or associated with a particular airspace zone 108a of the airspace region 102a covered by said FOC 104a. The airspace flight management method 140 includes one or more of the following steps of: In step 142, receiving flight data of a plurality of aircraft in-light within the airspace zone 108a of the airspace region 102a. The AMC 110a may also receive airspace condition data and/or airspace data associated with each airspace zone 108a-108e of the airspace region 102a covered by said AMC 110a. In step 144, modelling the corresponding airspace zone state of at least air traffic in-flight within the airspace zone 108a based on received flight data associated with the aircraft 106a-106c in-flight within the particular airspace zone 108a. The modelling may also include modelling the airspace zone state for all other airspace objects/entities and the like that may affect the routes/paths of aircraft 106a-106c in-flight within the particular airspace zone 108a based on any received airspace data and/or airspace condition data from one or more airspace information data sources. In step 146, using the modelled airspace state for detecting any flight conflicts in relation to at least one or more aircraft 106a-106c of the aircraft 106a-106c in-flight within the particular airspace zone 108a. In step 148, for each aircraft within the particular airspace zone 108a, using the modelled airspace state for resolving any detected flight conflicts in relation to said aircraft and forming a set of one or more conflict resolutions. In step 150, for each aircraft with a detected flight conflict, evaluating and selecting a conflict resolution from the corresponding set of conflict resolutions for sending to said each aircraft. In step 152, sending data representative of the selected conflict resolution to the corresponding aircraft via the FOC 104a associated with said AMC 110a.

Although FIGS. 1a to 1e describe various aspects of the flight management systems 1000 and/or 100, this is by way of example only and the invention is not so limited, the skilled person in the art would understand that the flight data component(s), conflict detection component(s), resolver component(s), airspace modelling component(s), flight management system 1000, flight management system 100, FOCs 104a-104n and/or AMCs 110a-110q may be further modified and/or adapted as the application demands. For example the following modifications and/or additions may be made to the corresponding system(s), apparatus, component(s), method(s) and/or process(es) of the flight management systems 1000 and/or 100 and the like and/or as the application demands.

Additionally or optionally, the flight management system 100 or 1000 may include dynamic allocation of AMCs/apparatus 110a-110q for managing load and scaling of the flight management system 100 or 1000. Each FOC 104a of the plurality of FOCs 104a-104n may be further configured to dynamically assign one of a plurality of airspace zones within said airspace region to each of the plurality of AMCs, based on processing load of said AMC and/or number of flights within each airspace zone. For example, the dynamic assignment may include dividing a particular airspace zone 108a of an AMC 110a into multiple airspace zones when the processing load associated with the number of flights of aircraft 106a-106c within the airspace zone 108a exceeds a first predetermined load threshold. As an option, one or more of the airspace zones 108a-108e of an airspace region 102a may overlap to ensure full coverage of the airspace region. When this first predetermined threshold is exceeded, then the flight management component 110a allocates, initiates and assigns an AMC to each of the multiple airspace zones. This enables more processing power and computational resources to be used when an AMC 110a is performing below a certain performance level such that it becomes dangerous for use in conflict detection and resolution. Dividing airspace zones enables more processing power to enable conflict detection and resolution are performed within a set time frame.

In addition, the FOC 104a may reduce the computational resources and/or processing power should one or more AMCs 110a-1101 of the airspace region 102a have spare processing capacity to take on the processing load of an underused AMC 1101 of another airspace zone. In this case, merging of multiple airspace zones of the corresponding AMCs make take place, where the merged airspace zones form a single merged airspace zone. This may occur when the combined processing load associated with the number of flights within multiple airspace zones falls below a second predetermined load threshold, where one of the AMCs of the merged airspace zones is configured to cover the single merged airspace zone whilst the other AMCs of the merged airspace zones are deallocated. In some embodiments, the first predetermined load threshold is greater than or equal to the second predetermined load threshold. As an option, dividing the particular airspace zone of an AMC into multiple airspace zones may include dividing the particular airspace zone into an even number of airspace zones, which provides the advantage of this is that fragmentation of the airspace regions and/or airspace is reduced and also this condition makes it easier for each FOC 104a to workout tessellation, manage and monitor corresponding AMCs 104a-1041 and associated airspace zones 108a-1081 of airspace region 102a. Additionally or optionally, merging multiple airspace zones of corresponding AMCs into a single merged airspace zone further includes merging an even number of airspace zones to form the merged airspace zone. Preferably, the one or more airspace zones allocated for merging are adjacent airspace zones (e.g. airspace zones with at least a common or intersecting boundary). The airspace zones may have continuously shaped x-y extents such as, without limitation, for example circular, ellipsoidal, triangular, rectangular, diamond and/or any type of polygon or continuous shape and the like as the application demands. There may be differently shaped airspace zones within an airspace region, and/or airspace zones within an airspace region may overlap to ensure coverage of the airspace region.

Alternatively or additionally, multiple airspace zones may be merged as long as each airspace zone is adjacent to at least one other airspace zone of the multiple airspace zones. Although an even number of airspace zones may be merged or an airspace zone may be divided in to an even number of airspace zones depending on load and/or number of aircraft within the airspace zone is described, this is by way of example only and the invention is not so limited, it is to be appreciated by the skilled person that an the merging and/or division of airspace zone(s) may be based on an arbitrary number or an odd number of airspace zones and the like. This may also depend on the shapes of the x-y extents of the airspace zones and the like. For example an arbitrary number or an odd number may be merged depending on the load of corresponding AMC(s) and/or number of aircraft in said airspace zones of said corresponding AMC(s) and the like. In another example, an airspace zone may be divided into an arbitrary number or an odd number of airspace zones of smaller sized airspace zones depending on the load of the corresponding AMC in relation to the airspace zone that is divided and/or number of aircraft in said airspace zone that is divided and the like.

Although each FOC may be further configured to: identify flight data corresponding to a particular aircraft within a particular airspace zone; and route messages associated with the identified flight data to the corresponding AMC of the particular airspace zone for modelling the airspace zone state in relation to air traffic within the particular airspace zone, as an option, each FOC 104a may be further configured to receive airspace condition data associated with the airspace region 102a covered by said each FOC 104a; and determine which airspace zone the airspace condition data pertains to and route messages associated with the airspace condition data to the corresponding AMC 110a covering the determined airspace zone for use in modelling the airspace zone state in relation to airspace condition data within the determined airspace zone.

Each AMC 104a represents or models an airspace zone state based on a plurality of entities determined to be within the particular airspace zone based on at least the flight data and airspace condition data associated with the particular airspace zone. The plurality of entities includes mobile entities and static entities. Each mobile entity being assigned to either: a) one aircraft of the plurality of aircraft in-flight within the particular airspace zone based on the corresponding flight data associated with said one aircraft; or b) a mobile airspace based on corresponding airspace condition data identified to be associated with the mobile airspace. Each static entity corresponding to a particular static airspace condition data within the particular airspace zone.

In essence, each AMC 104a is configured to maintain and update the airspace model of the airspace zone state based on received flight data and/or airspace data associated with the aircraft and/or airspace zone covered by said AMC 104a. The airspace zone state is analysed for at least each mobile entity representing an aircraft for detecting any conflicts with any other entity within the airspace zone state; resolve any detected conflicts between entities within the airspace zone state; and send flight control information notifications including data representative of the resolution of any detected conflicts to corresponding aircraft. Due to changing flight data and/or airspace data and the like that is received, the maintenance/update and analysis of the airspace zone state needs to be performed in a manner that ensures at least real-time issuance of flight control information associated with any detected conflicts. For example, maintaining, updating and analysis may be performed at various processing intervals or times on the airspace zone state, these processing intervals may alternate or cycle at such a frequency to ensure real-time conflict detection, resolution and issuance of flight control information may be performed. For example, in an analysis processing interval, the airspace zone state may be “frozen” or held static such that a static of frozen view of the airspace zone state is provided for the analysis of conflicts/conflict resolution and issuance of flight control information and the like. During the analysis processing interval, incoming flight data and/or airspace data and the like that is being received from the flight data source(s) may be queued/buffered. Once the analysis processing interval is completed, the queued/buffered flight data and/or airspace data may be released for maintaining/updating the airspace zone state of the modelled airspace. The analysis processing interval is repeated continually to ensure “real-time” conflict detection, resolution/deconfliction may be performed. Alternatively or additionally, an another example, the modelled airspace state is mutated at specific intervals where updates to the modelled airspace zone state are limited to an analysis processing interval in which a flight data/airspace data message queue/buffer is processed prior to the conflict/resolution analysis, whilst any new incoming and received flight data/airspace messages are buffered for mutating the airspace zone state in the next analysis processing interval.

The above approaches may further include, without limitation, for example each AMC 104a being configured to switch between a data ingestion phase and an airspace zone state analysis phase, wherein: the data ingestion phase is configured to: receive flight data associated with aircraft and/or airspace data/airspace condition data associated with the particular airspace zone; identify each entity corresponding to an aircraft or airspace data/airspace condition data associated with corresponding received flight data and/or received airspace data/airspace condition data; and send a message to each identified entity, each message including data representative of the corresponding flight data and/or airspace data/airspace condition data for updating the state of said each identified entity. The airspace zone state analysis phase, performed within a predetermined analysis interval, is configured to: update the airspace zone state based on any queued messages associated with corresponding entities of the airspace zone state; each of the entities associated with aircraft within the airspace zone state are analysed for detecting any conflicts with any other entity within the airspace zone state; resolve any detected conflicts between entities within the airspace zone state; and send flight control information notifications including data representative of the resolution of any detected conflicts to corresponding aircraft. Additionally or as an option, during the airspace zone state analysis phase, any received flight data of aircraft and/or airspace condition data associated with the particular airspace zone are buffered for processing during the next data ingestion phase.

In another example, snapshots of the airspace zone state are taken at various time instances (e.g. periodic or aperiodic time intervals) where each snapshot is provided for analysis for detecting any conflicts with any other entity within the airspace zone state; resolve any detected conflicts between entities within the airspace zone state; and send flight control information notifications including data representative of the resolution of any detected conflicts to corresponding aircraft. This may involve cloning the airspace zone state into a snapshot. The snapshots of the airspace zone state are taken and analysed at a frequency that ensures conflicts are detected, resolved and flight control information sent in a real-time manner to ensure aircraft and//or operators of said aircraft have time to avoid any detected conflicts or take action in relation to any detected conflicts. Each airspace zone state snapshot is analysed for conflicts/deconfliction whilst concurrently or at the same time airspace zone state is updated/maintained based on further received flight data/airspace data associated with aircraft in flight in the airspace zone and the like. Although the snapshot becomes obsolete as soon as at least new flight data becomes available to the AMC 104a, it is analysed as rapidly as possible to ensure detection of conflicts and resolution thereto is performed in a real-time manner or quickly enough for aircraft and/or operators of said aircraft to take action and avoid any detected conflicts.

Although several examples of using flight data and/or airspace data associated with aircraft and/or other entities in an airspace zone are provided for modelling the airspace zone state of the airspace zone and performing conflict/deconfliction/resolution analysis thereto, this is by way of example only and the invention is not so limited, it is to be appreciated by the skilled person that any other approach in which an airspace zone may be modelled such that a static view of the airspace zone state/model is provided for the analysis, which may be performed using various techniques or different ordering of the steps of maintenance, updating, and/or analysis of the airspace zone state/model such as, without limitation, for example the above-mentioned queuing/buffering approach(es) and/or as herein described; or providing a snapshot of the airspace zone state at a particular point in time, where the snapshot is analysed and any newly received flight data/airspace data is buffered, where the airspace zone state is updated after the analysis of the snapshot; or providing a snapshot of the airspace zone state at a particular point in time for analysis, where the snapshot is analysed whilst concurrently the airspace zone state may be continually updated/maintained based on received flight data/airspace data and the like; and/or using entity versioning techniques and the like; or any other methodology for processing a modelled airspace state of the airspace for detecting conflicts, resolving said conflicts and/or issuing flight control information in relation to any detected/resolved conflicts and maintaining/updating the airspace zone state in relation to further incoming flight data/airspace data from said flight data sources and the like; and/or combinations thereof, modifications thereto and/or as the application demands.

Optionally, each of the AMCs 110a-1101 may be configured to hand-off an aircraft exiting the corresponding airspace zone to enter another airspace zone of one of the other AMCs 110a-1101 of the airspace region. For example, each AMC 110a is configured to detect a mobile entity representing an aircraft 106a transitioning from the airspace zone 108a of the AMC 110a to another airspace zone 108b of another AMC 110b. As an option, a hand-off notification message may be sent from the AMC 110a to the other AMC 110b including data representative of the detected mobile entity to enable the other AMC 110b to update its airspace model and airspace zone state accordingly. Additionally or alternatively, when the mobile entity of the aircraft 106a is detected to transition to another airspace zone of another AMC 108m associated with another FOC 104n, the AMC 110a may be further configured to notify the corresponding FOC 104a to send a hand-off notification message to the other FOC 104n and to the corresponding aircraft 106a associated with the detected mobile entity to ensure flight data associated with the corresponding aircraft 104a is transmitted to the other FOC 104n.

The FOC is configured to process the received flight data associated with a plurality of aircraft in-flight within the airspace region covered by said FOC by: receiving flight data associated with each of one or more aircraft of the plurality of aircraft from multiple flight data streams of one or more flight data sources; identifying portions of the received flight data associated with each of one or more aircraft of the plurality of aircraft; combining the identified portions of received flight data for said each aircraft into a flight data message including data representative of a single canonical representation of flight data associated with an entity corresponding to said each aircraft; and sending each flight data message to the corresponding AMC for modelling the corresponding airspace zone state.

Additionally or optionally, the single canonical representation of flight data associated with an entity corresponding to said each aircraft is based on portions of flight data identified to be associated with the same entity and combined from multiple flight data information sources, the single canonical representation including data representative of the state of the entity in relation to at least one of the position, location, velocity, airspeed, altitude and any other relevant data of the aircraft corresponding to the state of the associated entity. Each entity is allocated a unique entity identifier and each flight data message is routed to the entity based on the unique entity identifier. Additionally or alternatively, each entity may have multiple unique identifiers such as, for example, secondary identifiers that are also unique, and each flight data message may be routed to said each entity based on said secondary identifiers.

In addition, detecting flight conflicts in relation to at least one or more aircraft in flight within a particular airspace zone further comprises detecting a set of conflicts for each aircraft modelled in airspace zone state based on analysing any potential conflicts between said each aircraft and at least one or more of: the positions of other unmanned aircraft modelled in the airspace zone state; the positions of other manned aircraft modelled in the airspace zone state; the positions of any unknown aircraft or entities modelled in the airspace zone state; the geometric extents of volumes of restricted/controlled airspace within the airspace zone; weather forecast data about weather systems within the airspace zone; and any flight plans of other unmanned aircraft or manned aircraft modelled in the airspace zone state. The conflict detection pipeline component for each AMC 110a may include a plurality of different conflict detection components that may be dynamically allocated to the conflict detection pipeline. Each allocated conflict detection component is configured to analyse the airspace zone state in relation to each entity and detect a specific type of potential conflict that may occur between entities. Each conflict detection component may be configured to detect a different type of conflict to other conflict detection components within the conflict detection pipeline component.

Furthermore, the conflict resolver pipeline component of an AMC may be further configured to resolve any detected flight conflicts by: generating a set candidate resolutions for each aircraft associated with a set of detected conflicts; selecting a single resolution from the set of candidate resolutions to avoid each of conflicts in the set of conflicts based on properties of said each aircraft and/or airspace zone; and sending flight control information to said each aircraft, the flight control information comprising data representative of the selected conflict resolution. The flight control information associated with each aircraft in which a conflict is detected may include, without limitation, for example data representative of a notification of the associated selected conflict and actions to be taken, instructions and/or commands for the actions an aircraft should undertake to avoid said selected detected conflict, and/or any other type of information associated with the conflict and the like as the application demands.

Generating a set of candidate resolutions based on a set of conflicts in relation to at least one or more aircraft in flight within a particular airspace zone further comprises analysing, for each aircraft modelled in airspace zone state, one or more resolutions based on aircraft properties and/or airspace zone from at least one or more of: aircraft priority; aircraft priority based on its payload; the latency of the connection with aircraft; any rules of the air in the vicinity of the aircraft detected within the airspace zone; aircraft type including at least one of fixed-wing type, rotary-wing type; aircraft course, speed, heading; aircraft intended flight plan/destination; obstacles in vicinity of the aircraft; and effect of implementing a resolution of the set of candidate resolutions on the aircraft and other nearby aircraft. Conflict resolution of a set of candidate conflict resolutions in relation to an aircraft comprises or represents data representative of actions and/or instructions for use in directing the aircraft to avoid one or more conflicts of the set of conflicts associated with the aircraft.

Although the flight management systems 1000 and 100 of FIGS. 1a and 1b may be configured to modelling as many aircraft as possible may be traversing based on the received flight data from said aircraft and/or flight data sources and the like and that all aircraft may be sent flight control information associated with a potential conflict, as an option, the flight control information may be only provided to those operators, pilots, and/or flight controllers/systems of said aircraft and/or unmanned aircraft that have been registered and/or subscribed to a conflict detection and/or resolution service provided by the flight management systems 1000 and 100 as described with reference to FIGS. 1a and 1 b.

Although various aspects of the flight management systems 1000 and/or 100 have been described with reference to FIGS. 1a to 1 e, this is by way of example only and the invention is not so limited, the skilled person in the art would understand that the flight data component(s), conflict detection component(s), resolver component(s), airspace modelling component(s), flight management system 1000, flight management system 100, FOCs 104a-104n and/or AMCs 110a-110q may be further modified and/or adapted as the application demands. For example the following modifications and/or additions as described with reference to FIGS. 2a to 5b may be made to the corresponding system(s), apparatus, component(s), method(s) and/or process(es) of the flight management systems 1000 and/or 100 and the like and/or as the application demands.

FIG. 2a is a schematic diagram illustrating another example flight management system 200 according to a second example/embodiment of the invention and is based on the flight management systems 1000 and/or 100 as described with reference to FIGS. 1a-1e and/or as herein described. Flight management system 200 includes a flight orchestration layer 201 connected to an airspace management layer 203 covering a plurality of airspace regions 202a-202n of an airspace. The flight orchestration layer includes a plurality of FOCs 204a-204n, each of the FOCs 204a-204n covering a different one of the airspace regions 202a-202n. For example, FOC 204a covers airspace region 202a, whilst FOC 204n covers airspace region 202n. In this example, airspace region 202a is the airspace of the European Union (EU), whereas airspace region 202n is the airspace of North Africa (NA). Each of the FOCs 204a-204n is connected to a set of AMCs or region managers 210a-210e to 210m-210s. For example, FOC 204a is connected to the set of AMCs or region managers 210a-201e and FOC 204n is connected to the set of AMCs or region managers 210m-210s. Each of the AMCs in the set of AMCs 210a-210e covers an airspace zone within the airspace region 202a covered by the corresponding FOC 204a. For example, AMCs 210a-210e cover airspace zones of relatively the same size as depicted by the size of each of the AMCs 210a-210e, however, AMC 210f covers a larger airspace zone (roughly 4 times the size of the airspace zones of AMCs 210a-210e), which is due to the lower air traffic and/or processing load in relation to the airspace zone of AMC 210f.

The FOC 204a of the set of AMCs 210a-201f is configured to control the number AMCs deployed and also the size of each airspace zone covered by the AMCs in the airspace region 202a covered by FOC 204a. The size of each airspace zone covered by an AMC 210a depends on the amount of air traffic within the airspace zone and the processing load of the AMC in relation to, without limitation, for example modelling the airspace state and/or air traffic of the allocated airspace zone, detecting conflicts and resolutions of air traffic within the airspace zone. Should the processing load and/or air traffic in multiple adjacent airspace zones fall below a lower airspace load threshold, then the AMCs of the multiple adjacent airspace zones may be deallocated and the airspace zones merged into a single airspace zone hosted by a corresponding AMC. Similarly, should the processing load and/or air traffic of an airspace zone increase above an upper airspace load threshold, then the airspace zone may be divided into two or more airspace zones and corresponding AMCs assigned to each additional airspace zone.

Each FOC 204a-204n may include a flight data component configured for receiving and/or routing flight data associated with air traffic within each airspace region 202a-202n, respectively. The flight data component of a FOC 204a may be configured to route the flight data associated with each aircraft of the air traffic to corresponding AMCs 210a-210f based on, without limitation, geospatial information that may be added to the flight data indicating which airspace zone the in-flight aircraft is traversing. Flight data may be received over a communication network from numerous flight data information sources 205a-205n, each of which may distribute flight data associated with aircraft to each of the corresponding FOCs 204a-204n. Furthermore airspace data/airspace condition data and/or non-flight data associated with the airspace environment (e.g. weather systems, airfields, NOTAMs, restricted/controlled airspace, geographical boundaries of restricted/controlled airspace and the like) may be ingested from corresponding airspace information/data source(s) 213a-213n and/or flight database 212b/flight services 212 by each of the corresponding set of AMCs 210a-210f connected to the corresponding FOCs 204a-204n and/or flight database 212b of the flight services 212 and the like. For example, AMC 210a may be configured to request and/or receive the further airspace data/airspace condition data associated with the airspace zone covered by said AMC 210a via a communication network connected to associated airspace information source(s) 213a. This received airspace data/airspace condition data and/or non-flight data is used for modelling non-flight or non-aircraft objects/entities in the corresponding airspace zone state of the airspace zone. The airspace data/airspace condition data and/or non-flight data may be ingested directly by each of the AMCs 210a-210f as required. For example, when an AMC 210a is allocated to an airspace zone, it may request and/or ingest airspace data/airspace condition data/non-flight data at start-up, thereafter, the AMC 210a may monitor for changes in the airspace data/airspace condition data and/or any non-flight data associated with the airspace zone from the information source(s) 213a so that the corresponding modelled airspace state of the airspace zone is sufficiently up-to-date and accurate for performing collision detection and/or resolution procedures and the like.

In this manner, the AMCs 210a-210f corresponding to an FOC 204a may be configured to receive flight data of aircraft and/or airspace data from flight data/airspace data information source(s) 205a for updating the airspace state of the airspace zone covered by each AMC 210a-210n. Furthermore, aircraft 206 may transmit flight data in the form of telemetry data via communication networks to FOC 204a covered by airspace region 202a that the aircraft 206 is within. Thus, the FOC 204a and AMCs 210a-210f receive flight data and airspace data associated with air traffic within the airspace region 202a and corresponding airspace zones of the AMCs 210a-210f.

Each AMC 210a-201n models the airspace state of the airspace zone, in which the airspace state includes a plurality of entities. That is, each AMC 210a-210n includes an airspace model that models an airspace state of the airspace zone covered by that AMC 210a-210n. The airspace state includes a plurality of entities of different entity types such as, without limitation, for example mobile entities and/or static or fixed entities. Each entity has entity attributes/fields that defines the entity state. Mobile entities may include, without limitation, for example aircraft and/or weather systems. Fixed or static entities may include, without limitation, for example airfields, terrestrial features, highways, facilities, cities, and/or any type of restricted/controlled airspace with boundaries and geographical extents/volumes and the like that can be represented as an entity. Each AMC 210a is configured to update the airspace model defining the airspace state based on the received flight data and/or airspace data etc. relevant to the airspace zone that said each AMC 210a covers. Given the flight data and/or airspace data from flight/airspace data sources 205a/213a and/or aircraft 206 may come from disparate sources, the FOC 204a and/or AMCs 210a-210f are configured to ingest this flight data/airspace data, process the flight data/airspace data to identify the flight data/airspace data that corresponds to particular aircraft and/or airspace environment features and map the identified flight data/airspace data to corresponding mobile and/or static entities in each airspace state modelled by each of the AMCs 210a-210f. This is achieved by each FOC 204a sorting and transforming the received flight data into, without limitation, for example geospatial canonical entity messages associated with said entities modelled in the airspace state of each AMC. Each AMC 214a may also be configured to sort and/or, if necessary, transform the received airspace data/airspace condition data and/or non-flight data into, without limitation, for example appropriate entity messages associated with said entities modelled in the airspace state of each AMC based on such received airspace data.

An example operation of flight management system 200 is provided based on the following steps of: Step A, a flight is initiated by aircraft 206, which includes notifying and/or filing a mission flight plan and/or request with a flight planning service 212. The planned flight is received by flight service 212a, where in step B, approval may be provided via an approval process 212c, and the mission flight plan submitted to flight information database 212b. Once approved, in step C.1, the aircraft 206 connects to the region orchestrator 208a of a FOC 204a covering airspace region 202a that the aircraft 206 is within. The aircraft 206 may then proceed with its flight and transmit telemetry messages over a communication network to the FOC 204a via region orchestrator 208a. In step C.2 the aircraft 206 also establishes a command notification channel with the outbound notification services module 209a of FOC 204a, this enables the aircraft 206 to receive conflict resolution messages including data representative of commands and/or instructions associated with a recommendation for avoiding one or more conflicts and the like. In step D, the region orchestrator 208a routes telemetry messages and/or canonical messages based on the telemetry messages to the corresponding AMC or region manager 210a covering the airspace zone of the airspace region 202a in which the aircraft 206 is within or in-flight within. In step E, the region manager 210a receives flight information from flight information database 212b of flight services 212, which can be used load the filed mission request for the flight into the corresponding AMCs over which the flight of aircraft 206 may traverse whilst in flight. Thus, an AMC may be configured to monitor the aircraft 206 and its compliance with the flight plan and/or use the portion flight plan of the aircraft 206 through the corresponding airspace zone for collision detection and/or avoidance. It is noted, that on start-up of each AMC, said AMC is populated with airspace data regarding the airspace zone that it covers and to initialise the airspace state of the airspace model with the most up-to-date airspace data representing the state of the airspace zone covered by AMC or region manager 210a.

Furthermore, during operation, flight data/airspace data from the flight information database 212b, flight/airspace data source(s) 205a/213a, and/or telemetry from aircraft 206, may be used to update each of the airspace states modelled by each AMC 210a-210f. The FOC 204a and/or each AMC 210a-210f may be configured to identify for each portion of flight/airspace data the relevant airspace zone, the aircraft identity or identity of the airspace environment feature/infrastructure, and map this to the relevant entity of the airspace state modelling the corresponding airspace zone. Thus, each entity of an airspace state that models an airspace zone covered by an AMC 210a may be updated such that the AMC 210a may perform real-time conflict detection and/or conflict resolution. This is performed by updating/mutating the airspace state of the airspace zone using the flight data/airspace data at specific intervals, and analysing/processing the updated/mutated airspace state at specific alternate intervals in relation to conflict detection/conflict resolution whilst buffering the flight data/airspace data for the update/mutation interval. For example, in a first time interval the current modelled airspace state is frozen (or a held static), whilst any further received flight data and/or airspace data is buffered, for processing/analysing the frozen airspace state for conflict detection/conflict resolution in relation to the entities within the airspace state. Once the conflict detection/resolution processing/analysis is completed, a second time interval starts in which the frozen modelled airspace state is then allowed to be updated/mutated using all the buffered flight data and/or airspace data. The first and second time intervals alternate in a series and/or continuously. The first and second time intervals may alternate and be performed as rapidly as possible to ensure real-time conflict detection and/or resolution is achieved in relation to aircraft 206 traversing the corresponding airspace zone. Additionally and/or alternatively, the modelled airspace state is mutated at specific intervals where updates to the modelled airspace zone state are limited to an analysis processing interval in which a flight data/airspace data message queue/buffer is processed prior to the conflict/resolution analysis, whilst any new incoming and received flight data/airspace messages are buffered for mutating the airspace zone state in the next analysis processing interval prior to the analysis. The modelled airspace state is effectively frozen (or held static) once the data message queue/buffer has been processed prior to the conflict/resolution analysis because during the conflict/resolution analysis, any new incoming/received flight data/airspace data messages are buffered for the next processing interval. The entities in which any conflicts are detected and resolved may be used to address conflict resolution messages to the corresponding aircraft that map to these entities. The conflict resolution messages are sent from the corresponding AMC 210a-210f via the outbound notification service 209a of FOC to the relevant aircraft 206 and/or to relevant aircraft associated with flight data sources 205a-205n.

FIG. 2b is a schematic diagram illustrating the architectural components 220 of a FOC 204a and a connected AMC 210a (or region manager) of flight management system 200 of FIG. 2a according to some embodiments of the invention. In this example, for simplicity an FOC 204a is connected to an AMC 210a covering an airspace zone within the airspace region of the FOC 204a. Although a single FOC 204a and single AMC 210a is described and illustrated, this is by way of example only an the invention is not so limited, it is to be appreciated by the skilled person that the FOC 204a may be connected/coupled to a set of AMCs 210a-210f and that the flight management system 200 may include a plurality of FOCs 204a-204n covering different airspace regions 202a-202n, each FOC 204a connected/coupled to a corresponding set of AMCs 210a-210f. In this case, the main architectural components are illustrated, which include the FOC 204a, AMC 210a, flight data/airspace data source(s)/flight database 205a/212b and aircraft 206 with telemetry flight data and the like. The FOC is connected via a communication network to the AMC 210a, flight data/airspace data source(s)/flight database 205a/212b, and aircraft 206. Although a single aircraft 206 is illustrated, this is for simplicity and by way of example only and the invention is not so limited, it is to be appreciated by the skilled person that the flight management system 200 may be adapted to include a plurality of aircraft, each providing telemetry flight data to the FOC 204a via a communication network and each AMC 210a or a corresponding set of AMCs 210a-210f may receive flight data associated with the plurality of aircraft as described herein. For simplicity, the flight data associated with aircraft 206 will be described, but the skilled person would appreciate that this may be applied to any of the plurality of aircraft within the airspace covered by the flight management system 200, FOCs and/or AMCs of the flight management system 200 and the like.

Aircraft 206 may distribute, broadcast and/or send flight data such as, without limitation, for example flight telemetry data of said aircraft 206 to the flight data component 208a of FOC 204a. Further flight data information source(s) 205a may also distribute flight data associated with aircraft 206 within airspace region 202a to the flight data component 208a of FOC 204a. Airspace information services/source(s) 213a may distribute airspace data, airspace condition data, and/or non-flight data associated with the airspace environment/infrastructure of airspace region 202a (e.g. weather systems, airfields, restricted/controlled airspace, NOTAMS, geographical boundaries of restricted/controlled airspace and the like). Flight database 212b and/or 222a may distribute flight plans and/or missions etc., associated with said aircraft 206 to over a communication network to said AMC 210a.

In particular, airspace data information source(s) 213a may distribute airspace data, airspace condition data, and/or non-flight data such as, without limitation, for example data representative of flight plan data 222a of aircraft 206 from a flight service 223a (or flight database 212b of flight service 212 of FIG. 2b); airspace data 222b from an airspace data service 223b (e.g. AIPs); airspace data such as weather data from weather providers 222c over weather service(s) 223c; airspace NOTAM data 222g from one or more NOTAM services 223d and the like and/or equivalent; and/or any other airspace data, airspace condition data, and/or non-flight data associated with an airspace from other sources and the like. For example, airspace data, airspace condition data, and/or non-flight data may be stored in separate micro-services 223a-2233d and queried typically at AMC 210a start-up and configuration, which is then monitored for changes. The current data for these micro-services does not need to be persisted within the AMC 210a as it can be reloaded from said source(s) 213a/212b on-demand.

Flight data information source(s) 205a may distribute flight data associated with the aircraft 206 from, without limitation, for example via a real-time surveillance bus 223e or communication channel(s) over communication network from flight data sources 222e-222g such as, without limitation, for example manned aviation systems 222d (e.g. flight radar, ASTERIX and/or ADSB and the like); flight data associated with said aircraft 206 from external unmanned aircraft flights (UAVs) 222e and/or manned aircraft flights; flight data associated with said aircraft 206 from other client devices and/or sources 222f (e.g. private pilot, phone apps, Google maps and the like). Further flight data may be distributed from the aircraft 206 itself via telemetry apparatus on the aircraft 206, which may be transmitted to a telemetry ground receiver 222h connected to a communication network and forwarded/sent to the flight data component(s) 208a of FOC 204a via a flight telemetry data bus 224a and monitor 224b of FOC 204a.

Flight data/airspace data information source 205a/flight database 212b and/or telemetry mechanism on an aircraft may include different types of external systems that produce flight and/or airspace data for ingestion by the FOC 204a and/or AMC 210a of flight management system 200. These external systems may have different capabilities for real-time communications dictated by their network connectivity, power requirements, processing capabilities or other factors. The FOC 204a and/or AMC 210a may provide different connection endpoints and protocols for flight and/or airspace data ingestion and will negotiate a suitable connection type with a connecting client. Since connectivity is bidirectional and asynchronous the inbound and outbound data channels may use different protocols and communication technologies. These communication technologies include, but are not limited to: UDP, TCP, HTTP(S), SMS, Mobile push notifications, Email, and/or any other communication technology capable of transmitting flight and/or airspace data messages. Where possible all communications can be authenticated and encrypted to improve security of the flight management system 200.

At the FOC 204a, a flight telemetry monitor 224b received the telemetry flight data of the aircraft 206 as telemetry messages or flight data messages from aircraft 206. These are forwarded to the geospatial router 224c. The geospatial router 224c identifies the AMC 210a that should receive the telemetry messages from aircraft 206 based on, without limitation, for example identifying geospatial information associated with the aircraft 206 within the telemetry messages. This may include identifying the airspace zone the aircraft 206 is within based on, without limitation, for example aircraft identifier and/or geospatial information within the telemetry messages of flight data. Once the airspace zone has been identified from the flight data messages, they may be sent to the corresponding AMC 210a covering that airspace zone. For each received flight data message, the AMC 210a may use the flight data and/or geospatial information therein to identify the mobile entity within the airspace state of the identified airspace zone that corresponds to the aircraft 206. The AMC 210a may track the mapping between, without limitation, for example aircraft and corresponding mobile entities created by each of the airspace states to represent said aircraft. The FOC may be configured to transform the telemetry flight data messages into canonical or standardised telemetry messages including only the relevant flight data telemetry of the aircraft 206 for use by the AMC 210a in updating the entity state attributes/fields and addressed to the entity within the airspace zone of AMC 210a. For example, the transformation of flight data messages to a canonical format is provided by the data ingest system of the FOC 204a and/or flight data component or orchestration component 208a of the FOC 204a. The conversion/canonicalisation of the flight telemetry data/messages may be performed in the flight telemetry receiver 222h, with a canonical position update message being placed on the flight telemetry bus 224a. Converting raw telemetry messages into standardised or canonical messages makes it easier to scale flight management system 200 and AMC 210a to handle other types of flight data from different flight data information sources 205a and the like. The geospatial router 224c then routes the entity canonical telemetry messages to the correct AMC 210a.

Additionally or alternatively, as an option, at the FOC 204a, the flight telemetry monitor 224b receives the telemetry flight data as telemetry messages from aircraft 206, and in the geospatial router 224c identifies the AMC 210a that should receive the telemetry messages from aircraft 206. This may include identifying the airspace zone the aircraft 206 is within based on, without limitation, for example aircraft identifier and/or geospatial information within the telemetry messages. Furthermore, the FOC 204a may be further configured to also identify the mobile entity within the airspace state of the identified airspace zone that corresponds to the aircraft 206. The FOC 204a may be configured to track the mapping between, without limitation, for example the aircraft 206 and corresponding mobile entity(ies) created by each of the airspace states to represent said aircraft 206. Each AMC 210a may notify the FOC 204a of these mappings as and when an entity is created in relation to a received telemetry messages associated with a particular aircraft 206. This may enable the telemetry messages to be transformed/converted into entity canonical telemetry messages including the relevant flight data telemetry of the aircraft for updating the entity state attributes/fields and addressed to the entity within the airspace zone of AMC 210a. Converting raw telemetry messages into standardised or canonical messages directed to each entity corresponding to an aircraft makes it easier to scale flight management system 200 and AMC 210a to handle other types of flight data and/or airspace data from different flight/airspace data information sources and the like. The geospatial router 224c then routes the entity canonical telemetry messages to the AMC 210a.

Additionally and/or alternatively, the flight telemetry receiver 222h and/or geospatial router 224c (or other components of the FOC 204a) may be configured to also receive flight data from flight data information source(s) 205a over one or more communication networks. In this case, flight data information source(s) 205a may send flight data and/or airspace data messages based on, without limitation, for example data representative of flight data from real-time surveillance sources 222e-222g such as, without limitation, for example manned aviation systems (e.g. flight radar, ASTERIX and/or ADSB and the like) 222e, flight data from external unmanned aircraft flights (UAVs) 222f, flight data from other client devices and/or sources (e.g. private pilot, phone apps, Google maps and the like) 222g. The FOC 204a (e.g. flight telemetry receiver 222h or geospatial router 224c and the like) may also be configured to identify the airspace zone these received flight data messages are relevant to and send these flight data messages associated with the aircraft to the corresponding AMC 210a of the identified airspace zone. The AMC 210a is configured to identifying the mobile entities within the airspace state of the identified airspace zone that corresponds to the received flight data within the flight data messages. The AMC 210a is also configured to request and/or receive airspace data messages from airspace information sources 213a associated with the airspace zone covered by said AMC 210a and identify the static or less mobile entities corresponding to the received airspace data messages. The AMC 210a may track the mapping between, without limitation, for example aircraft and corresponding mobile entities created by each of the airspace states to represent said aircraft, airspace environment features and corresponding mobile/static entities created by each of the airspace states to represent said airspace environment features and the like.

As an option and/or alternatively/additionally, the FOC 204a (e.g. flight telemetry receiver 222h or geospatial router 224c and the like) may also be configured to identify the airspace zone these flight data messages received from the flight data sources 205a are relevant to, and identify the mobile entities within the airspace state of the identified airspace zone that corresponds to the received flight data within the flight data messages. If there is enough information in the received flight data of the flight data messages, the FOC may be able to identify the entity that relates to the flight data of each message based on identifiers that may exist within the flight data/airspace data. The FOC 204a may track the mapping between, without limitation, for example aircraft and corresponding mobile entities created by each of the airspace states to represent said aircraft. Each AMC 210a may notify the FOC 204a of these mappings as and when an entity is created in relation to received flight data messages. This enables the received flight data messages to be transformed/converted into entity canonical messages including the relevant flight data of the aircraft 206 for updating the entity state attributes/fields and addressed to the entity representing the aircraft 206 within the airspace zone of AMC 210a. Converting raw flight data messages into standardised or entity canonical messages makes it easier to scale flight management system 200 and AMC 210a to handle other types of flight data from different flight data information sources 205a and the like. The geospatial router 224c may then be configured to route the entity canonical messages to the AMC 210a.

The FOC 204a or AML 210a may include the functionality of entity identity correlation and track fusion. This may be part of message routing in which the inbound messages must reach their appropriate entities (e.g. targets) within the modelled airspace state 228 of an AML 210a. Each entity is assigned one or more identifiers upon creation, these identifiers are used to target canonical entity messages for routing thereto. It is possible some entity canonical messages may not have a target entity identifier, e.g. a position update from radar where an aircraft (e.g. a UAV) has no electronic conspicuity device. In these instances, an identifier will be generated and assigned to a newly created airspace entity within the airspace state 228 and entity canonical messages will be correlated based on the most likely probability. In addition, multiple positional updates may be received from difference sources for the same entity, in these instances track fusion must be applied to result in a single canonical position. This will also be assessed on by selecting the most probable position using congruent data. Congruence of data will be established using some or all, and not limited to, the following types of data: positional; temporal; velocity vector.

The AMC 210a includes an incoming entity message queue 225, a state monitor 226, conflict detection/resolution and airspace state update processor pipeline 227, and airspace state 228 for modelling aircraft, airspace, UAVs, TFRs, weather within the airspace zone covered by AMC 210a. Entity canonical messages representing the received flight data/airspace data messages are processed in the AMC 210a using a message pipeline for incoming entity canonical messages from geospatial router 224c and also internal messages within AMC 210a such as, without limitation, for example requested/received airspace data messages (e.g. Airspace state updates) from airspace information sources 213a/212b and the like. This allows for these messages to be received and processed immediately but paused and buffered in the entity message queue 225 periodically during conflict detection, thus ensuring that entities are not updated during analysis which could cause data inconsistencies. The entity canonical messages and the other internal messages are routed to the corresponding aircraft entities and/or airspace entities (e.g. mobile aircraft entities and/or mobile and/or static/fixed airspace entities) they are targeting and the entities' internal state is modified when the message is processed during the processing interval; this includes such things as identifiers, location, altitude, velocity and any other pertinent airspace data. Messages may also be routed to the AMC 210a itself or directly to static entities in the airspace state 228 such as TFRs or other such airspace structures. These entities will also update their internal state as is appropriate.

For example, on receiving the entity canonical telemetry messages and/or entity canonical messages including flight data and/or receiving airspace data messages, the AMC 210a stores the received entity canonical messages and also the received airspace data messages (e.g. Airspace state updates) within an incoming entity message queue 225 for use in updating the airspace state during a processing interval. Furthermore, state monitor 226 may be configured to receive or pull flight data/airspace data relevant to airspace zone of the AMC 210a from one or more flight data/airspace data information source(s) 205a/flight database 212b. The airspace state 228 of the AMC 210a may be updated based on the received flight data/airspace data of airspace zone of the AMC 210a. The state monitor 226 may also be configured to identify the mobile and/or static entities within the airspace state 228 of the airspace zone that corresponds to the received flight data/airspace data within the flight data/airspace data messages. As an option, if there is enough information in the received flight data/airspace data of the flight/airspace data messages, the geospatial router may be configured to be a message router capable of identifying the entity that relates to the flight data/airspace data of each message based on identifiers that may exist within the flight data/airspace data. In any event, the state monitor 226 may place or send the received flight/airspace data messages to the entity message queue 225.

The AMC 210a includes an airspace manager/modeller 227c and the airspace state 228, where the airspace manager/modeller 227c is configured for modelling/updating the airspace state 228 of the airspace zone covered by AMC 210. As described, the airspace state includes a plurality of entities of different entity types such as, without limitation, for example mobile entities and/or static or fixed entities. Each entity has entity attributes/fields that defines the entity state. Mobile entities may include, without limitation, for example aircraft and/or weather systems. Fixed or static entities may include, without limitation, for example airfields, terrestrial features, highways, facilities, cities, and/or any type of restricted/controlled airspace with boundaries and geographical extents/volumes and the like that can be represented as an entity.

The AMC 210a is configured to update the airspace state 228 during a conflict detection/resolution/update processing interval, in which the entity canonical messages stored in the entity message queue are moved to airspace state update processor pipeline 227 (e.g. airspace modelling component) for processing whilst all subsequent entity canonical messages that are received during the processing interval are stored in the entity message queue. The airspace state update processor pipeline 227 is configured for initially updating the airspace state 228 via route message 227a and airspace state manager 227c using the entity canonical messages and/or airspace information messages, which update the entities (especially the position data associated with each entity) within the airspace state 228. In any event, once updated, the airspace state 228 is “frozen” and the deconfliction pipeline 227b, which may include detect conflict pipeline component(s) and conflict resolution pipeline component(s), processes the airspace state 228 for detecting conflicts between entities and determining conflict resolutions for the conflicts. The deconfliction pipeline 227b transmits conflict resolution messages including data representative of commands, instructions associated with resolving a conflict for an entity to the aircraft 206 corresponding to the entity via the outbound notification service 209a of the FOC 204a.

The conflict detection/resolution/update processing interval occurs on a periodic interval basis (e.g. processing interval) in which an entity message queue 225 is paused, and the airspace state 228 updated/analysed based on the canonical entity messages in the paused queue 225. Another entity message queue 225 is instantiated to continue queuing and storing incoming entity canonical messages during the processing interval. The processing interval should be short enough to provide a rapid and practically real-time response to any emerging conflicts between aircraft. For example the processing interval may be relatively short (e.g. <2 seconds) to provide the rapid and practically real-time response to any emerging conflicts and to prevent too many entity canonical messages building up in the queues 225. The airspace state update processor pipeline 227 analyses and updates the airspace state 228 based on several stages including, without limitation, for example: 1) Update the airspace entities from the inbound entity canonical messages in the paused queues 225; 2) Perform calculations of dynamic boundaries around mobile entities e.g. position estimation and projection, latency etc.; 3) Perform detection of potential conflicts amongst the entities (e.g. deconfliction pipeline 227b); 4) Calculate candidate resolutions to conflicts (e.g. deconfliction pipeline 227b); 5) select a resolution from the candidate resolutions for each entity with a potential conflict; 6) Issue commands to enact the resolution via the outbound notifications service 209a of FOC 204a.

In stage 2) position estimation and projection of a mobile entity's future position over time is calculated per processing interval along with a probability using a projection algorithm. Mobile entities within the airspace zone may also experience transient or permanent communications failure. In these scenarios, when other sources of positional data are not available, the mobile entity's position and velocity will be estimated using the projection algorithm. The projection algorithm will take account of the last known sets of data about the entity for a time window and project a set of future data (e.g. position, velocity) along with a probability value. In addition, where there is no current position update for an entity, a possible position and velocity along with a probability will also be calculated.

Estimated and projected position/velocity data and the like will change over time until such time as the probability decreases below a threshold and tracking of the entity within the airspace state is considered “lost”. This allows the flight management system 200 to anticipate the future flight data for the mobile entity and estimate its current flight data to cope with transient communications failures. The system 200 can then still provide deconfliction services to other cooperative mobile entities that still have open communication channels.

The deconfliction pipeline 227b performs conflict detection and also conflict resolution. Conflict detection is performed by algorithmic analysis of the airspace state 228 and the flight patterns of entities representing aircraft flying in the airspace zone. This analysis uses multiple metrics to determine dynamically calculated geometries around the entities which can then be used for conflict detection. Some of the metrics used for this calculation include, but are not limited to: velocity, flight capabilities (airframe type, max velocity, vehicle ceiling etc.), flight priority, communications latency, cooperative vs uncooperative entities (e.g. aircraft); compliance of aircraft and/or operators, pilots, flight controllers of said aircraft with issued instructions, through both explicit acknowledgement and monitoring; deviation from planned flight; fuel/battery levels of the aircraft; emergency status; update frequency of flight data associated with the aircraft; last update timestamp; certainty of projected position; projected (estimated) vs actual flight position. Calculated metrics for now and projected future metrics are considered. This results in one or more safety boundaries/geometries describing areas around the entity with associated probabilities. These safety boundaries/geometries have a defined shape and size based on the metrics used to calculate them. Each entity will have a bespoke set of safety boundaries/geometries calculated per processing interval. Intersections between entity safety boundaries/geometries are calculated, where intersections of safety boundaries/geometries between entities indicates a conflict between these entities, so a set of conflicts are created associated with the entities determined to have conflicts.

The deconfliction pipeline 227b performs conflict resolution once a set of conflicts is established. These are analyzed along with data about the conflicting entities. A set of candidate resolutions are then created for the conflict. There may be zero or more resolutions for some, or all the entities involved in each conflict. In the case where there are multiple resolutions for an entity within a conflict the most appropriate is selected. This selection may involve consideration of the data for the entity and resolutions for other entities within the conflict. Finally, a single resolution per entity will be established, or none where an entity is un-cooperative.

The deconfliction pipeline 227b also sends flight control information such as, without limitation, for example conflict resolution messages including command and control instructions for actioning by the aircraft based on the set of resolutions for entities in conflict. This usually involves sending a conflict resolution message via the outbound notification service 209a over the outbound communications channel to the pilot or client device of an operator to inform them of the action required of them in relation to the aircraft they are piloting/operating and the like. Conflict resolutions can be informative or imperative and can require acknowledgement from the recipient via the inbound communications channel via the FOC 204a. This is used to help calculate compliance and for auditing purposes. Imperative conflict resolutions may include, but not be limited to: Instructions to land; Instructions to return to base; velocity vector changes; altitude changes; contingency Plans

Further modifications to the flight management system 200 and architecture 220 are now described with reference to FIGS. 2a and 2b. In addition to near real-time command and control instructions, the flight management system 200 may additionally choose to communicate contingency plans to aircraft within the airspace region. These plans will have designated triggers such as “communications loss” and will contain a set of instructions that the aircraft can enact when the plan triggers. These plans allow the system 200 to anticipate and manage aircraft in contingent situations with a greater degree of accuracy. Such plans may be periodically updated during flight as the state of aircraft and airspace changes.

AMC 210a may be configured to be capable of processing a continuous stream of data; however, the AMC 210a needs to have periods of stability to assess airspace state and make holistic decisions about potential conflicts and conflict resolutions. As such, the components (e.g. conflict detection pipeline components and/or conflict resolver pipeline components) that comprise the conflict/resolution processing pipeline 227b are extensible and can be easily supplemented with additional conflict detectors, conflict resolvers/resolutions, calculations etc. as needed. These components can provide deconfliction against other data sources e.g. weather, radio interference (Kp-index) etc.

The FOC 204a provides geo-spatial routing of inbound messages to the appropriate airspace zone of the AMC 210a based on the areas of interest and control for an AMC 210a ensuring the messages relevant to an AMC 210a reach it. As well, the FOC 204a monitors AMC 210 “health” in addition to monitoring provided by the hosting fabric of the FOC layer 201 and AMC layer 203. New AMCs may be instantiated as required to account for AMCs that fail due to hardware failure or other reasons. Inbound messages in relation to air traffic for a failed AMC will be automatically routed to the new AMC as soon as it is available. It is important that AMC instantiation time be as low as possible (e.g. <5 seconds) to minimise any period where command and control for an airspace zone of the plurality of airspace zones of an airspace region covered by FOC 204a is unavailable.

At startup, the AMC 210 connects to their governing FOC 204a and receive an initial configuration. This will contain information such as the geographic bounds of the airspace zone (e.g. region of control and region of interest) including altitude limits and any other data required for initialization of the AMC 210 and the airspace state 228 modelled by the AMC 210 via the airspace state manager/modeller 227c. Upon receiving their configuration, an AMC 210a may load its initial airspace state 228 from the appropriate data sources (e.g. flight database 212b/222a and/or airspace data 222b) and then indicate its readiness to the FOC 204a. The FOC 204a may also reconfigure instantiated AMCs as required providing the capability for dynamic airspace zone (or region) scaling and the ability to have hot-spare AMCs on standby for rapid failover if required. AMCs whose configurations are dynamically updated will immediately provision their airspace state 228 and start processing incoming messages and providing de-confliction services as described herein.

Furthermore, command and control handoff is performed using bidirectional channels between each AMCs 210a-210f and corresponding FOC 204a. The communication channel between a AMC 204a and regional orchestrator 208a of FOC 204a is bidirectional, this allows AMCs to send messages to other AMCs as required to facilitate operations such as, without limitation, for example command and control handoff when a controllable entity such as a co-operative UAV transitions from one area of control as governed by a AMC to another, or when confliction resolution must cross airspace region boundaries.

In addition, the flight management system 200 is capable of dynamic re-planning by each AML 210a monitoring changes in their airspace state 228 and re-planning flight plans of entities representing aircraft within its airspace zone. These flight plans may need to be changed during flight in response to changing events, e.g. TFR activation, weather conditions etc. Where such events do not immediately impact the flight, they will not be handled by the normal conflict detection pipeline 227b. This is because they occur out of the immediate range of any calculated deconfliction areas for the entities, but rather affect the planned route of the mobile entity at some point along its path. In these instances, the client device of an operator or pilot of the aircraft may be sent a new plan to avoid such areas at the appropriate points along its planned route. Additionally, such planned changes themselves may be amended if the airspace state 228 is again subject to a change. New plans are calculated using algorithms that account for the cost of the change, this can be weighted based of various metrics such as: Fuel cost; Permission requirements; Mission profile; Entity capabilities; and the like. As a result, the lowest cost route will be offered as an alternative along with the reasons for the re-route request. This will be sent to the recipient using the outbound communications channel and will require acknowledgement.

In addition, airspace state manager/modeller 227c may be configured to perform further airspace state management/modelling of the airspace state 228 of the airspace zone of AML 210a. The state of fixed/static entities, such as ICAO classified airspace, can be dynamic and change over time, this includes whilst flights are taking place. To accommodate this and provide a holistic view of the airspace state 228 for an airspace zone, the AML 210a may track and update their airspace state 228 representing their airspace zone with changes from external data sources as they are received. These changes include, but are not limited to: AIP changes in the Aeronautical Information Regulation and Control (AIRAC) cycle; TFR created via NOTAM; planned flight changes; and/or any other changes issued by standardised air traffic systems. The conflict resolution pipeline can detect and enact resolutions dependent on this data, for example, a TFR activation by NOTAM could result in aircraft in the affected area being ordered to land or return to base.

Although various aspects of the flight management systems and/or architectures 1000, 100, 200, and/or 220 have been described with reference to FIGS. 1a to 2b, this is by way of example only and the invention is not so limited, the skilled person in the art would understand that the flight data component(s), conflict detection component(s), resolver component(s), airspace modelling component(s), flight management system 1000, flight management system 100, FOCs 104a-104n and/or AMCs 110a-110q, flight management system 200 and architecture 220, FOCS 204a-204n, AMCs 210a-210q and the like may be further modified and/or adapted as the application demands. For example the following modifications and/or additions as described with reference to FIGS. 2c to 5b may be made to the corresponding system(s), apparatus, component(s), method(s) and/or process(es) of the flight management systems 1000, 100, 200 and/or 220 and the like and/or as the application demands.

FIG. 2c is a schematic diagram illustrating an example AMC 230 data ingestion and processing architecture for use by flight management system(s) 1000, 100, 200, 220 as described with reference to FIGS. 1a, 1b, 2a and/or 2b, combinations thereof, modifications thereto and/or as described herein according to the invention. The data ingestion process for the AMC 230 includes receiving flight data from the FOC handling the AMC 230 from orchestrator message receiver 212 and also receiving airspace information data from airspace information sources/services. The airspace information data including, without limitation, for example airspace data, airspace condition data and/or non-flight data associated with the airspace, airspace region and/or airspace zone covered by AMC 230. In this example, the orchestrator message receiver 232 of the AMC 230 is configured to receive flight data messages from flight data information sources 222e-222h (e.g. flight data sources 205a of FIG. 2b and/or flight telemetry receiver 222h of FIG. 2b) from the FOC handling the AMC 230. The AMC 230 is also configured to request and/or receive airspace data information messages from airspace information services/sources 213a/212b of FIG. 2b such as, without limitation, for example weather data 222c from weather monitor/service 223c; airspace update data 222b of the updates to the airspace (e.g. airspace restrictions/extensions and the like, NOTAMs) from airspace services and/or monitors 223b; and/or airspace information data from other services, databases, monitors 223a-223d such as, NOTAM service and/or flight database 212b with flight plans of aircraft and the like.

In this example, the airspace region state includes, without limitation, for example a plurality of mobile entities such as aircraft entities 234a-234j, a plurality of fixed/static entities such as airspace entities 236a-236k, and a plurality of other mobile entities such as airspace weather entities 238a-2381 that represent or model the real-time airspace state of the airspace zone covered by AMC 230. These are updated based on the received flight data messages and the received airspace data information messages coming out of the incoming message queue 225. That is, these messages may be buffered in an incoming message queue 225a and, during a data ingestion phase or interval the switch 233a is closed such that the incoming message queue 225a is emptied and any buffered messages and flight data and/or airspace data messages subsequently received during the data ingestion phase pass through message router 227a, where the airspace region state is updated based on the type of messages, e.g. flight data message for an aircraft entities 234a-234j, airspace update message for fixed airspace entity(ies) 236a-236k, airspace update message for mobile airspace entities 238a-2381 and the like. During the data ingestion phase, the incoming message queue 225 is emptied and any received flight and/or airspace messages are essentially directly passed through to message router 227a for updating the airspace region state covered by AMC 230. In this example, the message router 227a examines the received flight data messages and/or airspace information messages passing through of the incoming message queue 225 and identifies from the identifying data within each message the entity within the airspace region state that should receive the flight data and/or airspace data in said message.

When message router 227a receives a flight data message associated with an aircraft, it uses the flight data to identify the corresponding aircraft entity 234a and whether the flight data represents a position update for the aircraft entity 234a. This may involve the AMC 230 maintaining a lookup table of the identifying flight data associated with an aircraft mapped to the corresponding aircraft entity 234a-234j that was created to represent the aircraft. If the flight data message is a position update, then the message router 227a sends the flight data message to the identified aircraft entity 234a for updating the position state of the identified aircraft entity 234a. When message router 227a receives an airspace data message associated with an fixed/static airspace entity (e.g. airspace, airfield, airspace restriction, airspace geometry, etc.), it uses the airspace data to identify the corresponding airspace entity 236a and whether the airspace data represents a new airspace data requiring an update to the corresponding airspace entity 236a. Again, this may involve the AMC 230 maintaining a lookup table of the identifying airspace data associated with an airspace object and the like mapped to the corresponding airspace entity 236a-236k that was created to represent the airspace object (e.g. airfield, airspace restriction, airspace geometry, etc.) If the airspace data message is a new airspace update, then the message router 227a sends the airspace data message to the identified airspace entity 236a for updating the state of the identified airspace entity 236a. When message router 227a receives an airspace data message associated with a mobile airspace entity (e.g. weather system, volcanic plume, or other natural moving hazard, fireworks, fires, bush fires and/or smoke and the like), it uses the airspace data to identify the corresponding mobile airspace entity 238a and whether the airspace data represents a update of airspace environment conditions (e.g. updated weather conditions, and the like) or new airspace data requiring an update to the corresponding mobile airspace entity 238a. Again, this may involve the AMC 230 maintaining a lookup table of the identifying airspace data associated with an mobile airspace object and the like mapped to the corresponding mobile airspace entity 238a-238k that was created to represent the mobile airspace object (e.g. weather system, etc.) If the airspace data message is a new airspace update, then the message router 227a sends the airspace data message to the identified airspace entity 238a for updating the state of the identified mobile airspace entity 238a. This is performed by the message router 227a for all flight and/or airspace data messages 222a-222h that pass through the incoming message queue 225 during the data ingestion phase (with the switch 233a closed) with the corresponding entities of the airspace region state being updated accordingly.

In a processing interval or phase, the airspace state is “frozen” by opening the switch 233a stopping the flow of flight and/or airspace data messages 222a-222h such that any subsequent incoming flight data message and/or airspace data message received during the processing phase is buffered in the incoming message queue 225. Thus, the airspace region state is effectively frozen as there are no more flight data messages and/or airspace data messages that may be received by message router 227c and processed to update the airspace region state. Instead, in the processing phase, the each of the entities in the airspace state are examined for conflicts using the deconfliction pipeline 227b of FIG. 2, i.e. each of the entities are analysed by conflict detection pipeline(s) and any conflicts between entities that are detected are processed by the conflict resolver pipeline(s), where the operators, users, pilots, and/or flight control modules or other control devices of the aircraft corresponding to those aircraft entities with conflicts with other entities of the airspace state are notified via a flight control information/commands/instructions based on the conflict resolution determined by the conflict resolver pipeline. Once the processing phase terminates and/or at least all aircraft entities have been analysed and those with conflicts have been resolved and/or sent the corresponding flight control information for resolving the corresponding conflict, then the processing phase may end and the switch 233a may be closed for performing the data ingestion phase again. The data ingestion phase and processing phase may be alternated at regular intervals at a rate and/or frequency such that real-time conflict detection and resolution may be achieved. Depending on the processing requirements and the like, the data ingestion phase may have a longer or shorter time interval compared to the processing phase time interval. The data ingestion phase and processing phase form a cycle, where the duty cycle of data ingestion phase and processing phase are optimised to ensure that the AMC 230 is capable of performing real-time conflict detection and conflict resolution in relation to at least all of the aircraft modelled by the airspace region state.

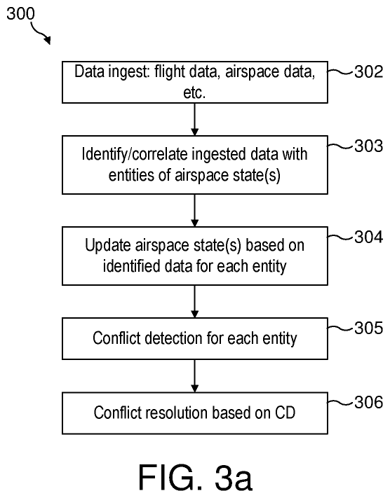

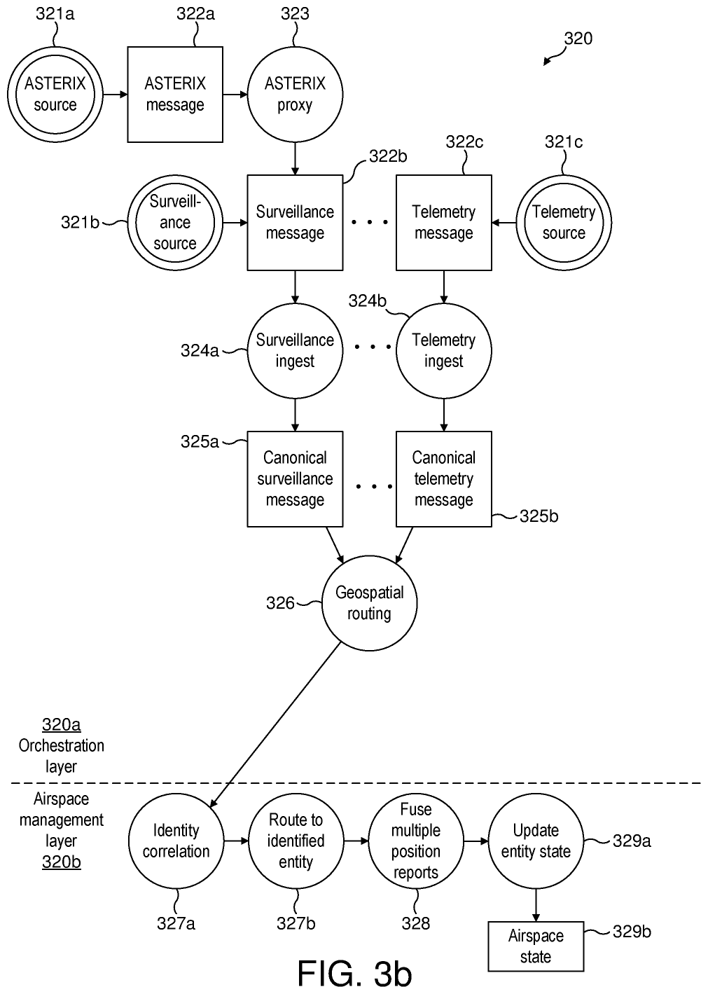

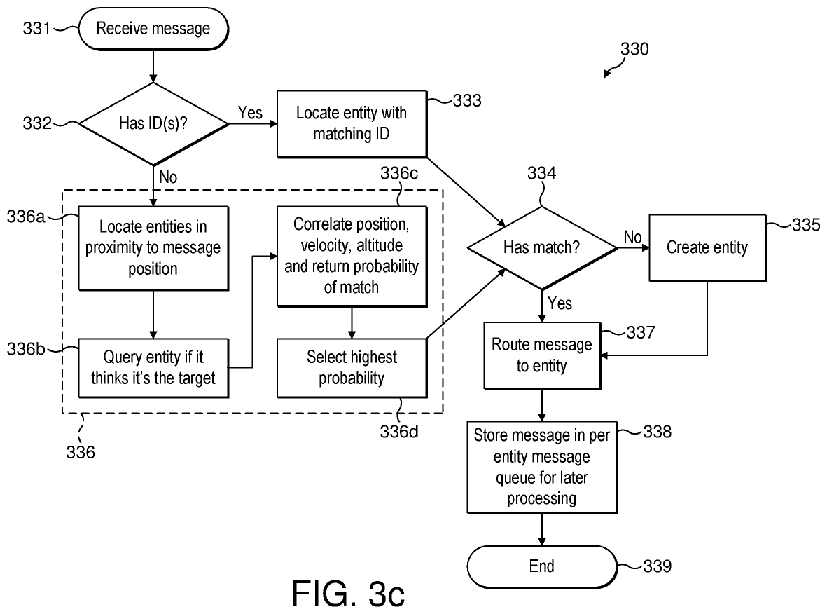

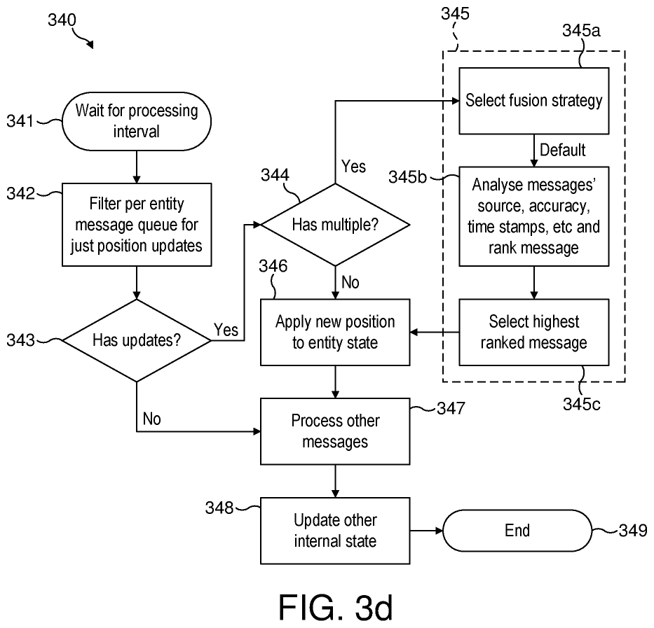

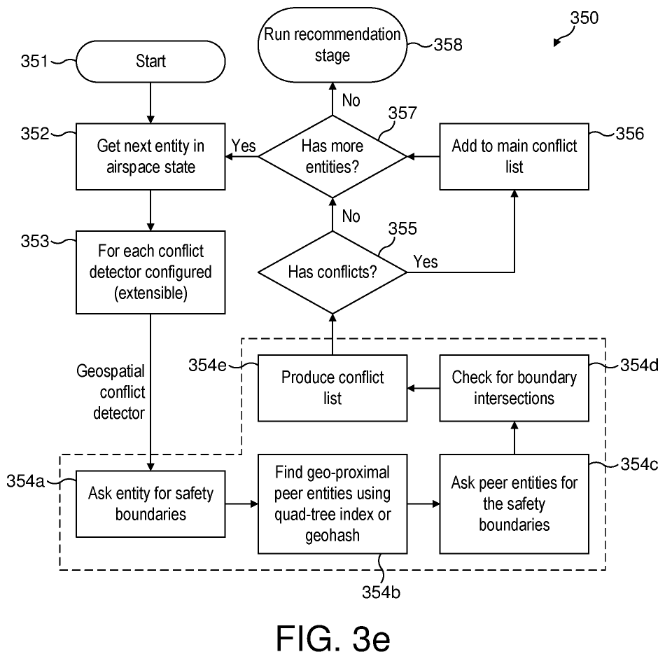

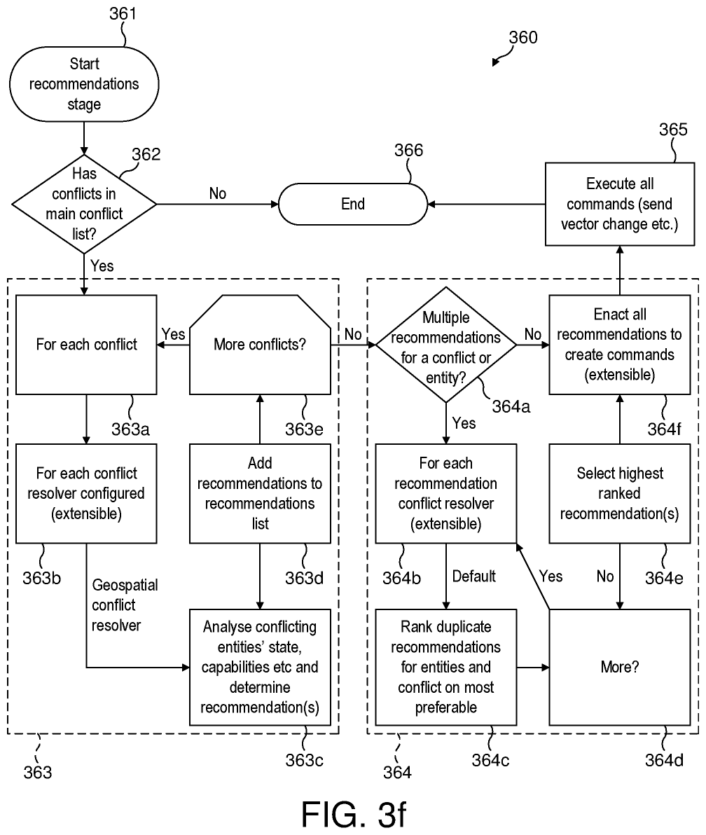

FIG. 3a is a flow diagram illustrating an example method of conflict detection and resolution 300 performed by a AMC of flight management system(s) as described with reference to FIGS. 1a, 1b, 2a, 2b and/or 2c and/or as described herein according to some embodiments of the invention. For simplicity, reference numerals of FIGS. 1a, 1b, 2a, 2b and/or 2c may be reused for similar and/or the same components, apparatus, nodes, systems and the like. In this example, it is assumed that a FOC 104a or 204a is connected to one or more AMCs 110a-1101 or 210a-210e that cover an airspace zone of the airspace region 102a or 202a covered by the FOC. The method of conflict detection and resolution 300 is performed by an AMC 110a or 210a connected to a FOC 204a may include the following steps of: In step 302, ingesting flight data routed by the FOC 104a or 204a to the AMC 110a or 210a and also any airspace data directly to the AMC 110a or 210a. The ingested flight and/or airspace data being received from one or more communication networks. In step 303, identifying and/or correlating the ingested data (e.g. flight and/or airspace data) with entities of airspace state(s). For example, each related and identified portion of flight data may be associated with the state of an aircraft in-flight in an airspace zone, which is represented, in each AMC 110a or 210a, as an entity within an airspace state of an airspace model of the airspace zone of said AMC 110a or 210a. The entity or aircraft entity may include related flight/airspace data (e.g. position, velocity, heading, direction, altitude, attitude and the like) and metadata and the like for use in determining conflicts with other entities within the airspace state of the airspace model. The identified and/or correlated ingested flight/airspace data are sent as messages to the corresponding AMCs that cover the identified airspace zone that the identified and/or correlated ingested flight/airspace data originates from. In step 304, each AMC 110a or 210a receives the corresponding identified/correlated ingested flight/airspace data in relation to each entity and updates the corresponding airspace models/airspace state based on this identified ingested data. This may involve, updating each entity within the airspace model/airspace state based on the related ingested flight/airspace data. In step 305, each AMC 110a or 210a performs conflict detection in relation to each entity of the corresponding airspace model and airspace state representing the airspace zone covered by the AMC. In step 306, for each entity within the airspace state, any detected conflicts between entities are evaluated and those conflicts in relation to aircraft entities are analysed and conflict resolutions determined based on the conflicts detected in relation to said aircraft entities. These conflict resolutions are transmitted by the AMC 110a or 210a as conflict resolution messages including, without limitation, for example data representative of flight control information and/or as conflict resolution notifications/commands/instructions and the like to the corresponding FOC 104a or 204a. Each conflict resolution message includes the identity or address associated with the corresponding aircraft or client device of an operator or pilot of the corresponding aircraft. The FOC 104a or 204a sends each conflict resolution message to the corresponding aircraft/client device and the like, where the operator, flight controller, and/or pilot of the aircraft may take appropriate action based on the conflict resolution message. This is performed for all aircraft traversing or transiting the airspace zone of the AMC 110a or 210a and so those aircraft that receive conflict resolution messages are able to take action to safely avoid conflicts with other aircraft and/or airspace restrictions or entities and the like.

FIG. 3b is a flow diagram illustrating another example of data ingestion 320 for flight management systems of FIGS. 1a, 1b, 2a, 2b, 2c and/or step 302 of method 300 of FIG. 3a according to some embodiments of the invention. For simplicity, reference numerals of FIGS. 1a, 1b, 2a, 2b and/or 2c may be reused for similar and/or the same components, apparatus, nodes, systems and the like. In this example, a flight orchestration layer 320a includes a plurality of FOCs 104a-104n or 204a-204n, and the airspace management layer 320b includes a plurality of sets of AMCs, each set of AMCs covering an airspace region of an FOC 104a or 204a. It is assumed that an FOC 104a or 204a is connected to a set of AMCs that include one or more AMCs 110a-1101 or 210a-210e that cover an airspace zone of the airspace region 102a or 202a covered by the FOC. In FIG. 2b, the double circles are data sources/sinks, single circles are processes, and the squares are data results. The data ingestion 320 includes, without limitation, for example the following: Data source 321a is an All Purpose Structured Eurocontrol Surveillance Information Exchange (ASTERIX) source that acts as a data sink by receiving flight data associated with aircraft in flight within an airspace and a data source forming ASTERIX flight data results 322a in relation to aircraft in flight within an airspace. This may be transmitted over a communication network as ASTERIX flight data representative of ASTERIX information in an ASTERIX message to an ASTERIX proxy process 323, which is configured to convert the ASTERIX flight data message in relation to, without limitation, for example aircraft 106a or 206 in an airspace region 102a or 202a covered by the FOC 104a or 204a into a canonical flight data message format associated with said aircraft 106a or 206. The ASTERIX proxy process 323 may be performed at the location of the ASTERIX source 321a and/or performed at the FOC 104a and/or 204a. This canonical ASTERIX flight data message forms part of the surveillance message data results 322b. Data source/sink 321b is a surveillance source (e.g. radar, telecommunications towers, CCTV cameras and the like) that may already output flight data in a canonical flight data message format, which also forms part of the surveillance message data results 322b. The surveillance source may transmit surveillance flight data in relation to aircraft 106a or 206 in an airspace region 102a or 202a covered by the FOC 104a or 204a. For non-canonical flight data messages, such as the ASTERIX messages and any other non-canonical flight data messages, the FOC 104a or 204a may have proxy process(es) configured to identify and/or extract the useful surveillance flight data from the ASTERIX/other surveillance messages in relation to the aircraft and standardise this flight data information into canonical surveillance messages, which form part of the surveillance data messages 322b, which can be transmitted to the corresponding AMCs 110a-110n or 210a-210e corresponding to the FOC 104a or 204a. Each canonical surveillance message include data representative of flight data from a set of surveillance and/or ASTERIX messages corresponding to a particular aircraft. In the FOC 104a or 204a, a surveillance ingestion process 324a ingests the canonical surveillance flight data and the canonical ASTERIX flight data 322b that are transmitted to the FOC 104a or 204a over a communication network to form a set of received canonical surveillance messages 325a.

Telemetry source 321c (e.g. telemetry device in an aircraft and the like) acts as a data sink by receiving telemetry flight data from an aircraft 106a or 206 in an airspace region 102a or 202a covered by the FOC 104a or 204a to form a set of telemetry messages associated with the aircraft 106a or 206. The telemetry source 321c may already output flight data in a canonical flight data message format such that the telemetry message data 322c are in a canonical flight data message format. In the FOC 104a or 204a, a telemetry ingestion process 324b ingests the canonical telemetry flight data messages that are transmitted to the FOC 104a or 204a from the aircraft 106a or 206 over one or more communication networks to the FOC 104a or 204a for form a set of received canonical telemetry messages 325b. The telemetry source 321c may transmit telemetry type flight data, e.g. telemetry messages 322c, from an aircraft 106a or 206 in an airspace region 102a or 202a covered by the FOC 104a or 204a to a ground station connected to a communication network with the FOC 104a or 204a Should the telemetry messages be in a non-canonical format, the FOC 104a or 204a may be configured to include a telemetry proxy configured for identifying and extracting the useful telemetry flight data of the aircraft from the many different types of received telemetry messages in relation to the aircraft and standardise this flight data information into canonical telemetry messages, which can be ingested by telemetry ingest 324b for subsequent transmission to the corresponding AMCs 110a-110n or 210a-210e corresponding to the FOC 104a or 204a. Each of the canonical surveillance messages 325a and/or canonical telemetry messages 325b may have an identifier such as a geospatial identifier for use by the geospatial routing process 326 for routing these messages 325a and 325b to the corresponding AMCs covering the airspace zones in which the geospatial identifiers correlate with.

The identity correlation process 327a of an AMC 110a or 210a receives corresponding canonical surveillance and/or telemetry messages with flight data of aircraft in flight in the airspace zone covered by said AMC 110a of the set of AMCs. The identity correlation process 327a performs identity correlation of the received canonical messages received from the geospatial router process 326, which identifies the entity in the airspace model of the AMC 110a or 210a that corresponds to the aircraft flight data and/or or airspace data within canonical message. Any updates to identity mappings will be published to the FOC for identity based routing. If there is no identifiable entity, then an entity may be created that represents the aircraft flight data and/or airspace data within the canonical message. This may be due to an aircraft or airspace entity (e.g. weather system) that has just entered the airspace zone and needs to be created for updating the airspace state of the airspace model of the AMC 110a or 210a. Once identified, the route identify process 327b is configured to route the canonical messages associated with identified entities in the airspace model of the AMC 110a or 210a to the identified entities for updating their states. Given that an entity may receive multiple flight data from multiple flight data sources 321a, 321b, 321c each having a position update/report, a fusion process 328 may be performed to combine and/or fuse multiple position updates/reports. That is, should there be multiple canonical messages with similar flight or airspace data associated with a particular entity (e.g. multiple position reports of the same aircraft and the like), the fuse process 328 of the AMC 110a or 210a is configured to fuse this flight data or airspace data information together or select the most reliable flight data or airspace data information that the corresponding entity can use. Thus, each entity receives updates to flight data and/or airspace data information based on the canonical surveillance, canonical telemetry. Once fused, if necessary, an update entity state process 329a is performed in which each of the entities of an airspace state may be updated based on the corresponding received/fused flight and/or airspace data. In the airspace state process 329b, the airspace state may be updated accordingly. The entities of the updated airspace state of the airspace model of AMC 110a or 210a may then be “frozen” and analysed for determining which entities have conflicts in relation to one or more other entities in the airspace state, and determining conflict resolutions for those entities having conflicts with other entities, where those entities with conflicts that correspond to aircraft (e.g. manned and/or unmanned aircraft) within the airspace model may be notified of the conflict resolutions via the corresponding FOC 104a or 204a.

FIG. 3c is a flow diagram illustrating another example method of flight and airspace data identification 330 for use in flight management systems as described with respect to FIGS. 1a, 1b, 2a, 2b and/or 2c and/or with respect to step 303 of FIG. 3a or process(es) 327a/327b of FIG. 3b according to some embodiments of the invention. It is assumed that geospatial routed canonical messages from various different types of flight data and/or airspace data is received by an AMC 110a or 210a. The AMC 110a or 210a may perform the method of flight and airspace data identification 330 for each canonical message received in relation to flight and/or airspace data based on the following steps of: In step 331, receiving a canonical message including at least, without limitation, for example data representative of flight data and/or airspace data associated with an airspace zone.

In step 332, it is determined whether the canonical message has an identifier that matches an entity already within the airspace state of AMC 110a or 210a. The canonical message may include entity identifiers for entities that have already been identified, which are communicated to the FOC, which may map the entity identifiers to the corresponding identifiers, e.g. aircraft identifiers, weather system identifiers, and other identifiers that can be used to map entities in the airspace state with real-world objects such as, without limitation, for example aircraft, weather systems, airfields, restricted/controlled airspace and/or restricted geographic zones/locations and the like. Sometimes a received canonical message may not include an entity identifier because that entity might not exist in the airspace state of AMC 110a or 210a. If the received canonical message has an entity identifier (e.g. Yes), then the method 330 proceeds to step 333, otherwise, if the received canonical message does not include an entity identifier (e.g. No), then the method 330 proceeds to an entity identification step 336, which determines from the flight data and/or airspace data within the canonical message the most likely entity in the airspace state that the canonical message should be directed towards.

In step 333, the entity in the airspace state is located based on the entity identifier, that is, the entity identifier is used to find the matching entity in the airspace state. In step 334, it is determined whether a matching entity was found from steps 333 or 336. If an entity identifier does not match any entity in the airspace state of the AMC 110a or 210a (e.g. No), then the method 330 proceeds to step 335 for creating an entity, otherwise when a matching entity with the entity identifier exists (e.g. Yes), then the method 330 proceeds to step 337. In step 335, when the received canonical message does not match an existing entity in the airspace state, then an new entity and entity identifier is created based on the flight and/or airspace data within the received canonical message for the airspace state of the AMC 110a or 210a. The AMC 110a or 210a may send the entity identifier mapped to any other identifier within the received canonical message to the FOC 104a or 204a to enable the FOC 104a or 204a to insert the entity identifier into newly created canonical messages with identifiers matching the mapping to the entity identifier.

In step 336, when there is no entity identifier within the received canonical message, it is determined from the flight data and/or airspace data within the received canonical message the most likely entity in the airspace state that the canonical message should be directed towards for updating that entity's state. This may be achieved by the following steps of: In step 336a, based on the flight data and/or airspace data in the canonical message, one or more entities within the airspace state of the AMC 110a or 210a that are proximity to any position, speed, velocity, heading and/or bearing or geographic boundaries and the like within the message are located. Although position may be used, other attributes/fields may be used, so step 336a may include locating one or more entities that have fields and/or attributes defining the entities state that are in proximity to corresponding fields, attributes within the received canonical message. In step 336b, each located entity may be queried to determine whether there are any entities that are expecting an update or consider they should be the target for the canonical message. In step 336c, for each located entity, the position, velocity, altitude of the entity may be correlated with the corresponding features (e.g. position, velocity, altitude of the received canonical message. In step 336d, for each located entity, based on the correlated positions, velocities, altitudes, the entity with the most probable match may be selected. That is the highest probability entity that matches the attributes/fields of the received canonical message may be selected from the located set of entities of the airspace state. However, the probability of the highest probability entity may be compared with a threshold probability to determine whether there is a match between the canonical message and an entity in the entity space. If there is a match, then the canonical message is given the entity identifier associated with the highest probability entity, otherwise, there is no match and an entity may need to be created in step 335. In any event, the method 330 proceeds to step 334.

In step 337, the received canonical message is routed to the matched entity or the newly created entity, which becomes the matching entity. In step 338, the received canonical message is stored in an entity message queue for later processing. This is performed to support processing messages out of order if required. For example, messages may be grouped by type, thus messages may be processed in groups/batches to ensure that the internal entity state is updated in the correct order as shown in FIG. 3d. As another example, this may also ensure that, without limitation, for example the position of the entity updated correctly before other messages are processed to ensure that the position of the entity does not change midway through message processing for that interval due to message sequencing. This may be quite important since the position fusion may result in a new (inferred) position being calculated. Once the entity within the airspace state receives the canonical message, the entity may update its fields/attributes that correspond to the fields/attributes of the received canonical message. In step 339, the method 330 may end. However, instantiations of the method 330 for each received canonical message may be created as each canonical message is received, so that canonical messages may be processed simultaneously or substantially simultaneously.

FIG. 3d is a flow diagram illustrating another example method of updating a model of an airspace zone state 340 in an AMC of one or more flight management system(s) as described with respect to FIGS. 1a, 1b, 2a, 2b and/or 2c and/or with respect to step 303 of FIG. 3a according to some embodiments of the invention. The AMC 110a or 210a may perform two phases of processing: 1) an update model processing phase (also referred to herein as data ingestion phase) for updating entities based on received canonical messages in the entity message queue as described with reference to FIGS. 2b and/or 3c; and 2) a conflict detection/resolution processing phase (also referred to herein as processing phase) for detecting conflicts between entities and resolving them. These two processing phases are performed one after the other in a continuous processing cycle. The update model processing phase of method 340 may be performed over a first processing interval, and the conflict detection/resolution processing phase based on methods 350 and 360 (described in FIGS. 3e and 3f) is performed over a second processing interval. The first processing interval may be longer than the second processing interval. Alternatively or additionally, the first and second processing intervals may vary depending on how full the entity message queue gets or how long the conflict detection/resolution phase needs for finishing. In any event, the method of updating a model 340 is performed in the update model processing phase based on the following steps of: In step 341, the update model processing phase starts after the conflict detection/resolution processing phase ends, the method 340 waits until the first processing interval can begin, once the first processing interval can being, the method 340 proceeds to step 342. In step 342, a new entity message queue is formed to receive new canonical messages from the FOC 104a and 204a, whilst the current entity canonical messages in the entity message queue are processed, in which the entity canonical messages are filtered for those entity canonical messages based on position updates.

In step 343, for each entity canonical message, it is determined whether there are position updates for an entity, if there are position updates (e.g. Yes) then the method 340 proceeds to step 344. Otherwise, if there are no position updates (e.g. No) in said each entity canonical message, then the method proceeds to step 347, where these entity canonical messages are processed for updating other internal state information of each corresponding entity. In step 344, only those entity canonical messages with position updates are passed to step 344, where it is determined whether there are multiple entity canonical messages for the same entity, if there are multiple entity canonical messages with position updates, then the method 340 proceeds to step 345 for fusing/resolving the multiple position updates for the entity. Otherwise, given there is only one entity canonical message with a position update for the entity in the current set of entity canonical messages (e.g. No), then the method 340 proceeds to step 346.

In step 345, the multiple position updates for an entity are fused together to create a single position update for the entity. This may be achieved based on the following steps of: in step 345a, a fusion strategy is selected for fusing the multiple position updates together. One strategy may be to merge the position updates together to generate one position update, or another may be to determine the best position update based on the reliability of the information in the entity canonical message for that entity. In this example, the latter is selected, so the method of step 345 proceeds to step 345b in which each of the multiple entity canonical messages are analysed based on the message's source, accuracy, time-stamps, etc., where the multiple entity canonical messages are ranked accordingly. For example, each message may be given a weighted score based on the message's source, accuracy, time-stamps, etc. In step 345c, the highest ranked entity canonical message is selected from the multiple messages with position updates for that entity. The highest ranked entity canonical message with position updates is provided to step 346.

In step 346, on receiving an entity canonical message with a position update (e.g. the single entity canonical message from step 344, or the highest ranked entity canonical message from step 345c), the new position update is extracted from the entity canonical message and applied to the entity. In step 347, all other entity canonical messages from the current set of entity canonical messages that do not have position updates are processed. In step 348, these other entity canonical messages are used to update one or more other attributes/fields and the like of the internal state of each of the corresponding entities in the airspace state of AMC 110a and 210a. The method 340 ends in step 349, where the first processing interval ends and the second processing interval associated with the conflict detection/resolution processing phase may begin.

FIG. 3e is a flow diagram illustrating another example method of conflict detection 350 for use with flight management systems 100, 200 as described with respect to FIGS. 1a, 2a, and/or 2b and/or with respect to step 305 of FIG. 3a according to some embodiments of the invention. As described, the AMC 110a or 210a may perform two phases of processing: 1) the update model processing phase; and 2) the conflict detection/resolution processing phase. These two processing phases are performed one after the other in a continuous processing cycle. The update model processing phase may be performed over a first processing interval, and the conflict detection/resolution processing phase based on methods 350 and 360 (described in FIGS. 3e and 3f) is performed over the second processing interval. The first processing interval may be longer than the second processing interval.

Alternatively or additionally, the first and second processing intervals may vary depending on how full the entity message queue gets or how long the conflict detection/resolution phase needs for finishing. In any event, whilst newly received canonical messages are stored in the entity message queue, the method of conflict detection 350 is performed in the conflict detection/resolution processing phase based on the following steps of: In step 351, the conflict detection method 350 is initiated in which the airspace state of the airspace model of AMC 110a or 210a is essentially “frozen” (or held static) as the incoming message buffers have been swapped, or the incoming message buffer has started buffering messages and stopped outputting messages such that there are no more messages for updating the airspace state. In step 352, each entity in the airspace state is analysed for conflicts in relation to all other entities in the airspace state, thus the next entity in the airspace state is retrieved, this process may or may not be parallelised. In step 353, there may be a plurality of conflict detectors, each conflict detector corresponding to detecting a particular type of conflict. Each conflict detector is configured in relation to the retrieved entity. In this example, a geospatial conflict detector is used for determining whether the retrieved entity is in conflict with another entity using boundaries and/or boundary volumes around the entity. In step 354, the geospatial conflict detector determines a conflict list of all entities that the retrieved entity may be in conflict with.

In step 354, the retrieved entity provides the safety boundaries (or volumes) associated with the retrieved entity. The safety boundaries (or volumes) are defined around the entity based on the entity type e.g. mobile/aircraft, type of aircraft and the like. For example, should another entities safety boundaries (or volumes) overlap with those of the retrieved entity, then it is determined that there is a conflict between that entity and the retrieved entity. In step 354b, the geo-proximal peer entities are found using a quad-tree index or geohash, this finds the entities that the retrieved entity is most likely in proximity to. In step 354c, each of the identified peer entities provide their safety boundaries (or volumes).

In step 354d, for each identified peer entity, the safety boundaries (or volumes) of the peer entity are checked to determine if they intersect or overlap with the safety boundaries (or volumes) of the retrieved entity. In step 354e, those peer entities that have intersecting safety boundaries with the retrieved entity are stored in a conflict detection list associated with the retrieved entity. This is output to step 355. In step 355, it is determined whether the retrieved entity has any conflicts, i.e. is the conflict detection list associated with the retrieved entity empty or not? If there are no conflicts between the retrieved entity and the peer entities (e.g. No) then the method 350 proceeds to step 357, otherwise (e.g. Yes) the method proceeds to step 356. In step 356, the conflict detection list associated with the retrieved entity is stored in a main conflict detection list associated with all entities that have conflicts detected. The method proceeds to step 357.

In step 357, it is determined whether all the entities in the airspace state have been retrieved and checked for conflicts. If all entities have been conflict detection checked, then the method 350 proceeds to step 358, otherwise when there are one or more further entities to check (e.g. “No”), the method 350 proceeds to step 352. In step 358, once the main conflict detection list has been generated in relation to the retrieved entities with conflicts, the recommendation stage is then performed, and the method 350 proceeds to the conflict resolution method 360 of FIG. 3f.

FIG. 3f is a flow diagram illustrating another example method of conflict resolution 360 for use with flight management systems 1000, 100, 200, 220 as described with respect to FIGS. 1a, 1b, 2a, 2b and/or 2c and/or with respect to step 306 of FIG. 3a according to some embodiments of the invention. As described, the AMC 110a or 210a may perform two phases of processing: 1) the update model processing phase; and 2) the conflict detection/resolution processing phase. These two processing phases are performed one after the other in a continuous processing cycle. The update model processing phase may be performed over a first processing interval, and the conflict detection/resolution processing phase based on methods 350 and 360 (described in FIGS. 3e and 3f) is performed over the second processing interval. In any event, whilst newly received canonical messages are stored in the entity message queue, the method of conflict resolution 360 is performed in the conflict detection/resolution processing phase based on the following steps of: In step 351, the conflict resolution method 360 is initiated with the airspace state of the airspace model of AMC 110a or 210a still being in a “frozen” state. In step 362, the main conflicts list associated with entities that have conflicts detected based on conflict detection method 350 is retrieved and it is determined whether there are any conflicts. If there are no conflicts (e.g. “No”), then the method 360 simply ends in step 366 as there is nothing to resolve. However, if there are conflicts in the main conflict list (e.g. “Yes”), then the method 360 proceeds to the conflict resolution evaluation step 363 in which conflict resolutions for each conflict between entities in the main conflicts list is analysed, evaluated and a conflict resolution is determined for the conflicting entities.

Conflict resolution evaluation step 363 may include the following steps of: In step 363a, for each conflict in the main conflict list, perform conflict resolution. In step 363b, there may be a plurality of conflict resolvers, each conflict resolver corresponding to resolving a particular type of conflict. Each conflict resolver is configured to process each conflict of the main conflict list in relation to the corresponding conflicting entities. In this example, a geospatial conflict resolver is used for determining how to resolve the conflicts between the entities in relation to a conflict. In step 363c, analysing each of the conflicting entities states, capabilities and the like and determine a list of recommendations for each entity. In step 363d, the recommendations for each entity are incorporated into a recommendations list for resolving conflicts between each entity. In step 363e, it is determined whether there are any more conflicts it the main conflict list that have not been resolved or processed. If there are more conflicts, then the method 360 proceeds to step 363a to resolve further conflicts form the main conflicts list, otherwise, when all conflicts have been resolved and/or processed from the main conflicts list, the method 360 proceeds to step 364, where recommendations from the recommendations list are selected for each of the entities. Each recommendation corresponding to an entity forms a conflict resolution for that entity.

Recommendation selection step 364 may include the following steps of: In step 364a, from the recommendations list, which lists all recommendations for each entity or conflict, it is determined whether there are multiple recommendations that exist for each entity or conflict. If multiple recommendations exist for an entity or conflict, then the method 360 proceeds to step 364b, otherwise the method proceeds to step 364f. In step 364b, there may be a plurality of recommendation conflict resolvers, each recommendation conflict resolver corresponding to resolving multiple recommendations for an entity or a conflict. Each recommendation conflict resolver is configured to process the multiple recommendations for an entity or conflict from the recommendation list. In step 364c, ranking the multiple/duplicate recommendations for entities and conflicts based on the most preferable to least preferable. In step 364d, it is determined whether all recommendations have been ranked, if not, then method proceeds to step 364c where unranked recommendations of the multiple recommendations are processed by the recommendation conflict resolvers and ranked accordingly in step 364. If all of the multiple recommendations have been ranked from most to least preferable, then the method 360 proceeds to step 364e. In step 364e, the highest ranked recommendation from each set of multiple recommendations for entities or conflicts is selected. In step 363f, enact all recommendations that have been processed by generating conflict resolution messages/notifications including data representative of flight control information, commands, instructions and the like in relation to the real-world aircraft of the corresponding entities. In 365, all conflict resolution messages/notifications (e.g. send vector change, velocity change, hover, land etc.) are executed by sending each conflict resolution messages/notifications associated with an entity to the corresponding real-world aircraft mapped to that entity. In step 366, the method 360 ends in step 366, where the second processing interval ends and the first processing interval associated with the update model phase may begin in which the airspace state of the airspace model of AMC 110a or 210a is “unfrozen” and may be updated based on the entity canonical messages stored in the entity message queue, thus, the method 340 may be performed.

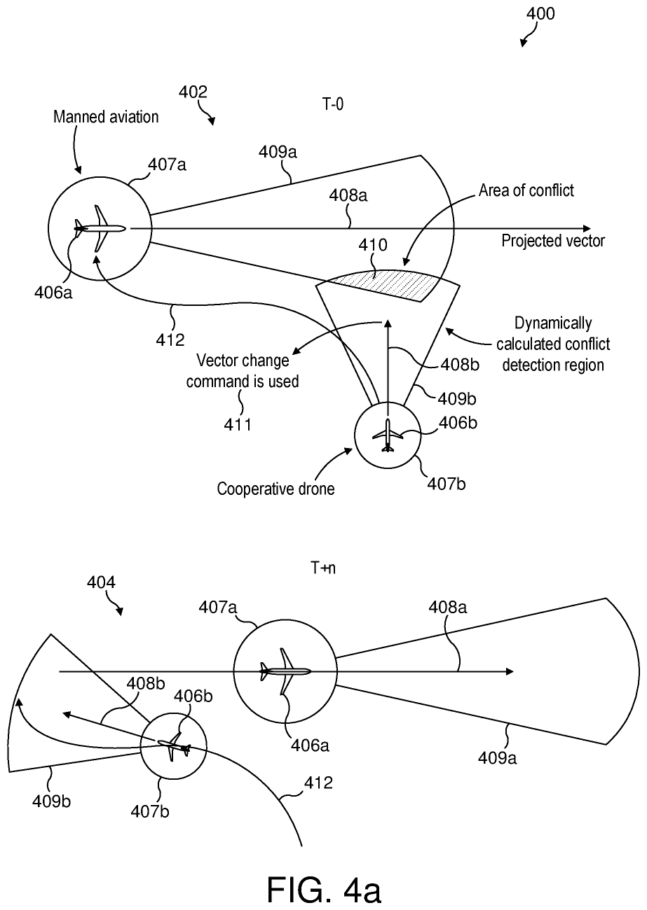

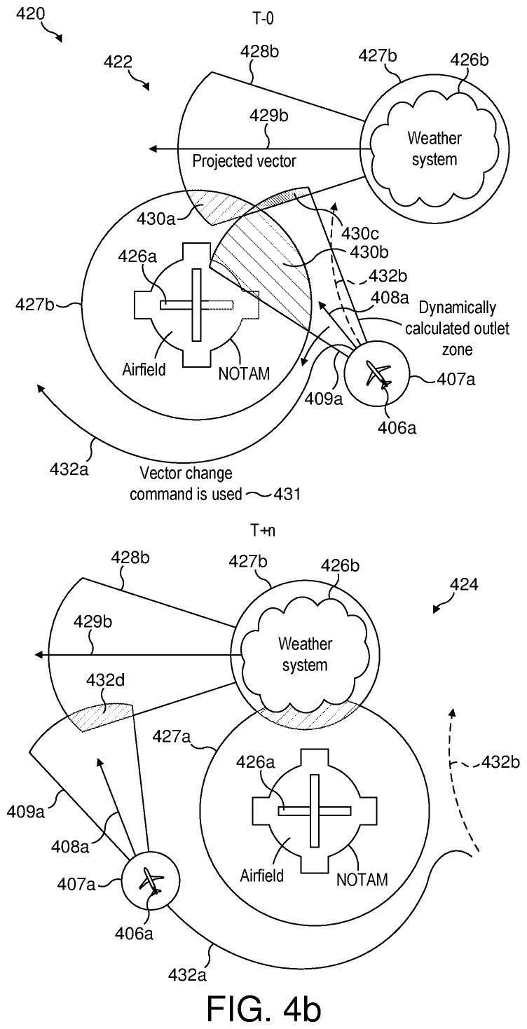

FIG. 4a is an schematic diagram illustrating an example airspace model 400 with an airspace state 402 at time interval T-0 and an airspace state 404 at time interval T+n showing a conflict detection and resolution between two aircraft 406a and 406b within an airspace zone covered by an AMC of a flight management system as described with reference to FIGS. 1a, 1b, 2a, 2b, 2c and/or 3a-3f, combinations thereof, modifications thereto and/or as described herein. In this example, conflict detection and conflict resolution methods 350 and 360 may be performed to determine and resolve the conflict between the aircraft 406a and 406b. In this example, the aircraft 406a is represented as a first entity in the airspace state 402 that has a state including safety boundary attributes such as, without limitation, for example safety boundary 407a, projected flight vector 408a and a dynamically projected safety boundary 409a. The aircraft may be of a large aircraft type, e.g. airliner, and so the corresponding first entity may have further state attributes indicating aircraft type, high priority status, fuel status, maneuverability, ability to land or hover and the like. Similarly, the aircraft 406b is represented as a second entity in the airspace state 402 that has a state including safety boundary attributes such as, without limitation, for example safety boundary 407b, projected flight vector 408b and a dynamically projected safety boundary 409b. The aircraft may be a small drone aircraft type, e.g. a commercial drone for deliveries and/or inspecting power lines and the like, and so the corresponding second entity may have further state attributes indicating aircraft type, low priority status, fuel status, maneuverability, ability to land or hover and the like. These attributes of the first and second entities will be analysed during the conflict detection and resolution methods 450 and 460 for determining conflict resolution.

In this example, when the airspace state 402 at time interval T-0 is frozen, the conflict detection method will detect that there is a conflict by examining the safety boundary attributes of the first and second entities, and determine that the dynamically projected safety boundary 409a and 409b of the first and second entities intersects/overlaps in a conflict region 410 should both the first and second entities continue to traverse along their corresponding projected flight vectors 408a and 408b. This detected conflict will be provided to the conflict resolution method 460, which may seek to resolve the conflict by analysing the attributes of each of the first and second entities, where it may be determined that given the first entity is a large aircraft type, and has a higher priority, that it may continue on its projected path, whilst the second entity being a commercial drone that is more maneuverable and can hover/land easily and/or change its flight path. Given these attributes of each of the entities, the conflict resolution method may issue a conflict resolution notification to the client device of the operator of the drone and/or the flight controller of the drone represented by the second entity in the airspace state 402. The conflict resolution notification may include data representative of a vector change command 411 including data representative of the recommendation to change the flight path of the drone 406b to the flight path 412. In this case, the drone 406b is assumed to be a cooperative drone 406b, where the operator or flight controller of the drone 406b obeys conflict resolution notifications that are issued to it. The operator or flight controller may have a subscription to a conflict resolution service operated by the flight management system. The airspace state 402 of airspace model 400 is unfrozen for the update entity phase in performing entity updates based on entity canonical messages that have been received and queued during the conflict detection and resolution phase. Given that the drone 406b is a cooperative drone, the operator or flight controller pilots the drone 406b along the recommended flight path 412 and so the aircraft 406a continues on its route, thus in airspace state 404 at time interval T+n the potential conflict 410 is avoided and both aircraft 406a and 406b are safely traversing the airspace represented by airspace model 400.

FIG. 4b is an schematic diagram illustrating another example airspace model 420 with an airspace state 422 at time interval T-0 and an airspace state 424 at time interval T+n showing a conflict detection and resolution between an aircraft 406a and an airfield 426a with controlled airspace and/or weather system 426a within an airspace zone covered by an AMC of a flight management system as described with reference to FIGS. 1a, 2a and/or 2b and/or as described herein according to some embodiments of the invention. In this example, conflict detection and conflict resolution methods 350 and 360 may be performed to determine and resolve the conflict between the aircraft 406a and the airfield 426a and weather system 426b.

In this example, the aircraft 406a is represented as a first mobile entity in the airspace state 422 that has a state including safety boundary attributes such as, without limitation, for example safety boundary 407a, projected flight vector 408a and a dynamically projected safety boundary 409a. The aircraft may be of a large aircraft type, e.g. airliner, and so the corresponding first entity may have further state attributes indicating aircraft type, high priority status, fuel status, manuverability, ability to land or hover and the like. Alternatively, the aircraft 406a may be a small drone aircraft type, e.g. a commercial drone for deliveries and/or inspecting power lines and the like, and so the corresponding entity may have further state attributes indicating aircraft type, low priority status, battery status, manuverability, ability to land or hover and the like.

In this example, the airfield 426a is represented as a second static entity in the airspace state 422 that has a state including safety boundary attributes such as, without limitation, for example an first safety boundary 427a (e.g. restricted airspace around the airfield) and a second safety boundary 427b. The weather system 426b is represented as a third mobile entity in the airspace state 422 that has a state including safety boundary attributes such as, without limitation, for example an first safety boundary 427b (e.g. this may depend on the severity of the weather system, e.g. Storm and the like), projected flight vector 428a and a dynamically projected safety boundary 429a predicting the future position of the weather system if it continues on its course and speed.

These attributes of the first, second and third entities 406a, 426a and 426b will be analysed during the conflict detection and resolution methods 450 and 460 for determining conflict resolution. In this example, when the airspace state 422 at time interval T-0 is frozen, the conflict detection method will detect that there is a first conflict by examining the safety boundary attributes of the first, second and third entities, and determine that the dynamically projected safety boundary 409a and 429b of the first and third entities intersect/overlap in a conflict region 430c should both the first and third entities continue to traverse along their corresponding projected flight vectors 408a and 428b. Moreover, the conflict detection method will detect that there is a second conflict by examining the safety boundary attributes of the first and second entities, and determine that the dynamically projected safety boundary 409a of the first mobile entity and the first and second safety boundaries 427a and 427b of the second static entity intersect/overlap in a conflict region 430b should the first entity continue to traverse along its projected flight vector 408a. Although there may be a conflict region 430a between the second and third entities, given it is a weather system and the second entity is a static entity, then the second entity may only be notified of the approaching weather system (if required).

The first and second detected conflicts will be provided to the conflict resolution method 460, which may seek to resolve the conflict by analysing the attributes of each of the first, second and third entities, where it may be determined that given the second entity is an airfield with controlled airspace, this may have higher priority such that the first entity 406a should change its flight path (unless it is meant to be landing at the airfield—which may be determined from the flight plan of the aircraft 406a associated with the first entity). As well, the weather system 426b may be a severe storm, so also has a high priority, i.e. the aircraft 406a should probably turn away from it. Given these attributes of each of the entities, the conflict resolution method may issue a conflict resolution notification to the client device of the operator, pilot of the aircraft 406a represented by the first entity in the airspace state 422. The conflict resolution notification may include data representative of a vector change command 431 including data representative of the recommendation to change the flight path of the aircraft 406a to the flight path 432a. In this case, the aircraft 406a is assumed to be a cooperative aircraft 406a, where the operator, pilot or flight controller of the aircraft 406a obeys conflict resolution notifications that are issued to it. The operator, pilot or flight controller may have a subscription to a conflict resolution service operated by the flight management system. Given that the aircraft 406a is a cooperative aircraft, the operator, pilot or flight controller pilots the aircraft 406a along the recommended flight path 432a. The airspace state 422 of airspace model 420 is unfrozen for performing entity updates based on entity canonical messages that have been received and queued during the conflict detection and resolution phase. Thus in airspace state 424 at time interval T+n the potential conflicts 430b and 430c are avoided and aircraft 406a safely traverses around the airfield 426a of the airspace represented by airspace model 420.

However, when the airspace model 400 and airspace state 424 is “frozen” at time interval T+n for performing conflict detection and resolution. The updated attributes of the first, second and third entities 406a, 426a and 426b will be analysed during the conflict detection and resolution methods 450 and 460 at time T+n for determining conflict resolution. In this example, when the airspace state 424 at time interval T+n is frozen, the conflict detection method will detect that there is a first conflict by examining the safety boundary attributes of the first, second and third entities, and determine that the dynamically projected safety boundary 409a and 429b of the first and third entities intersect/overlap in a conflict region 432d should both the first and third entities continue to traverse along their corresponding projected flight vectors 408a and 429b. The first detected conflict will be provided to the conflict resolution method 460, which may seek to resolve the conflict by analysing the attributes of each of the first and third entities, where it may be determined that given the third entity is a weather system, this may still have higher priority depending on its severity such that the first entity 406a may need to change its flight path. In any event, a conflict resolution notification may be issued to the operator, pilot or flight controller of the aircraft 406a based on what the conflict resolution method 460 determines to be the best or highly ranked recommendation to enable the aircraft 406a to safely and efficiently traverse the airspace.

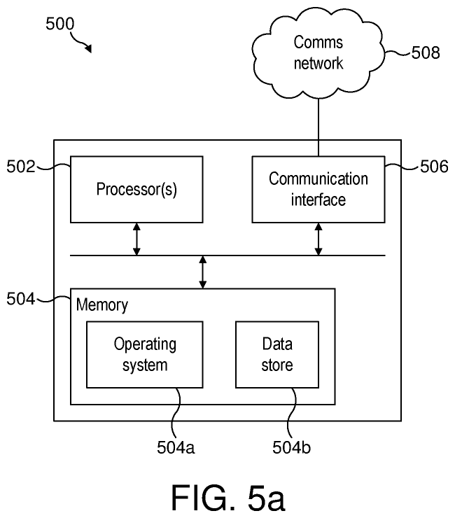

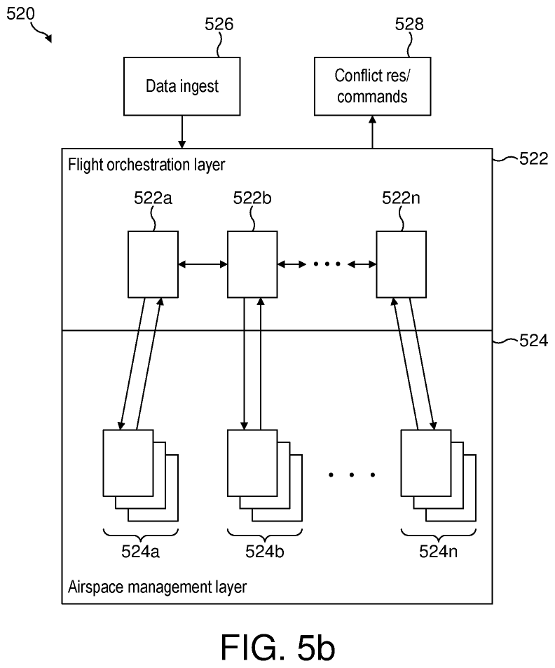

FIG. 5a is a schematic diagram illustrating a computer device or apparatus for use with one or more apparatus, node(s), process(es) and/or components of flight management system(s) as described with reference to FIGS. 1a to 4b according to some embodiments of the invention. Computing system 500 may be used to implement one or more aspects of the systems, apparatus, methods, process(es), device(s) and/or use cases as described with reference to FIGS. 1a-4b, combinations thereof, modifications thereto, as herein describe and/or as the application demands. Computing system 500 includes a computing device or apparatus 502 (e.g. FOC/node, AMC/node, conflict detector/resolver, client devices, server devices, flight management cloud platform etc.). The computing device or apparatus includes, without limitation, for example one or more processor unit(s) 502, memory unit(s) 504 and a communication interface 506. These may be used for performing and/or implementing the process(es) in relation to flight orchestration layer(s) and/or airspace management layer(s) of the flight management system and the like. The one or more processor unit(s) 502 are connected to the memory unit 504, the communication interface 506. The communications interface 506 may connect the computing device or apparatus 500 with one or more other computing devices and/or apparatus (e.g. other FOCs/node(s) and/or AMCs/node(s)) (not shown) associated with the flight management system as described with reference to FIGS. 1a to 4b and/or as described herein. The memory unit 504 may store one or more program instructions, code or components such as, by way of example only but not limited to, an operating system 504a for operating computing device 502, and a data store 504b for storing computer program instructions, executable code, code and/or components associated with implementing the functionality and/or one or more function(s) or functionality associated with one or more flight management mechanisms/systems/components/nodes and/or apparatus, systems and/or process(es) for implementing and performing the flight management system according to the invention, combinations thereof, modifications thereto, and/or as described herein with reference to at least any one of figure(s) 1a to 4b.

FIG. 5b is a schematic diagram illustrating an example flight management system 520 for managing air traffic within an airspace according to some embodiments of the invention. The air traffic may include manned and/or unmanned aircraft and the like. The system 520 includes a flight orchestration layer 522 connected to an airspace management layer 522. The flight orchestration layer 522 including a plurality of FOCs/nodes 522a-522n each covering a different airspace region of the airspace and each configured for receiving flight and/or airspace data from one or more data ingestion system(s) 526 and configured for transmitting, via conflict/resolution communications system 528, data representative of flight control information such as, without limitation, one or more conflict resolutions/notifications to manned and/or unmanned aircraft with detected conflicts for enabling such aircraft to take action to avoid such detected conflicts. The flight control information may be transmitted to flight controllers, client devices of operators and/or pilots of said manned or unmanned aircraft and the like. The airspace management layer 524 includes a plurality of sets of AMCs 524a-524n, where each set of AMCs/nodes 524a is connected to a particular FOC 522a of the plurality of FOCs 522a-522n. Each of the AMCs of a set of AMCs 522a covers an airspace zone of the airspace region covered by the corresponding FOC 522a. Each AMC of a set of AMCs 526a is configured to update, maintain an airspace model of the airspace state of the corresponding airspace zone that that AMC covers based on flight data and/or airspace data received from the corresponding FOC 522a. An AMC of the set of AMCs 526a uses the airspace model to detect any conflicts between, without limitation, for example aircraft within the corresponding airspace zone and/or other airspace infrastructure (e.g. weather systems, airports, restricted airspace and the like) within the airspace zone covered by the AMC. The AMC also evaluates the conflicts for each of the aircraft within the airspace zone and determines conflict resolutions in relation to the conflicts for avoiding said conflicts and the like. These conflict resolutions are sent to the corresponding FOC 522a for distribution/sending to associated aircraft, operators, pilots, flight controllers and the like. The flight management system 520, flight orchestration layer 522, airspace management layer 524, FOCs 522a-522n, sets of AMCs 526a-526n may be configured according to the method(s), process(es), components/nodes, apparatus and/or system(s) associated with the invention, modifications thereof, and/or as described herein, and/or as described with reference to FIGS. 1a-5a for providing a scalable, efficient, secure flight management system for enabling manned and/or unmanned aircraft to safely traverse an airspace, which may be controlled, uncontrolled, restricted and/or unrestricted airspace and the like.

In other aspects, an flight management system according to the invention may include one or more processor(s), a memory and/or a communication interface, the one or more processor(s) is connected to the memory and/or the communication interface, where the one or more processor(s) is configured to implement one or more of the process(es) 130, 140, 150, 300, 320, 330, 340, 350 and/or one or more of the FOCs, AMCs/nodes and/or apparatus thereto, airspace models and airspace states, flight orchestration layers, airspace management layers, and/or flight management systems as described with reference to FIGS. 1a to 5b, combinations thereof, modifications thereof, and/or as herein described, which may be implemented in hardware and/or software and the like as the application demands.

The embodiments described above are fully automatic. In some examples a user or operator of the system may manually instruct some steps of the method to be carried out.

In the described embodiments of the invention parts of the system may be implemented as a form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Although illustrated as a single system, it is to be understood that a computing device may be a distributed system. Thus, for instance, several devices may be in communication by way of a network connection and may collectively perform tasks described as being performed by the computing device. Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A flight management system for controlling air traffic within an airspace, the flight management system comprising a flight data component, airspace modelling component, a conflict detection component and conflict resolver component, the flight data component connected to the airspace modelling component, conflict detection component and conflict resolver component, wherein:
the flight data component is configured to receive at least flight data associated with a plurality of aircraft in-flight within an airspace region of the airspace from a communication network, wherein the airspace region comprises a plurality of airspace zones;
the airspace modelling component is configured to model each airspace zone of the plurality of airspace zones, wherein each airspace zone is represented by a corresponding airspace model comprising an airspace zone state representing the state of at least air traffic in-flight within said each airspace zone based on received flight data corresponding to aircraft in-flight within said each airspace zone;
the conflict detection component is configured to detect any flight conflicts in relation to at least one or more aircraft in-flight within each airspace zone based on the airspace zone state of said each airspace zone;
the conflict resolver component is configured to resolve any detected flight conflicts by the conflict detection component in relation to said at least one or more of the plurality of aircraft; and
the flight data component is further configured to send over the communication network flight control information in relation to any detected and/or resolved conflicts by the conflict resolver component associated with said at least one or more of the plurality of aircraft.

2. The flight management system as claimed in claim 1, wherein the flight data of each aircraft is received from one or more flight data sources over the communication network.

3. The flight management system as claimed in claim 1 or 2, wherein the received flight data of an aircraft comprises at least one or more of:
data representative of at least the location of the aircraft transmitted or broadcast by said aircraft; and
data representative of at least the location of the aircraft transmitted or broadcast by one or more flight data sources; and
data representative of at least the location of the aircraft transmitted or broadcast by one or more disparate flight data sources.

4. The flight management system as claimed in claim 2 or 3, wherein the one or more flight data sources comprises at least one from the group of:
flight telemetry receiver of said each aircraft;
another aircraft of the plurality of aircraft;
a radar source detecting position of said each aircraft;
All Purpose Structured Eurocontrol Surveillance Information Exchange, ASTERIX, air traffic services information;
airspace surveillance data associated with one or more of said plurality of aircraft;
automatic dependent surveillance broadcast, ADS-B, data associated with one or more of said aircraft;
flight planning services configured for providing flight plans of one or more of the aircraft of the plurality of aircraft; and
any other standard for exchange of air traffic services information.

5. The flight management system as claimed in any preceding claim, wherein the flight data component is further configured to:
identify flight data corresponding to a particular aircraft within a particular airspace zone; and
route messages associated with the identified flight data to the corresponding airspace model associated with the particular airspace zone for modelling the airspace zone state in relation to air traffic within the particular airspace zone.

6. The flight management system as claimed in any preceding claim, wherein the airspace modelling component for modelling each airspace model is further configured to receive airspace condition data for said each airspace zone for use in modelling the airspace zone state associated with the airspace zone.

7. The flight management system as claimed in claim 6, wherein airspace condition data comprises data representative of one or more from the group of:
airspace geometry/flight restriction data;
airspace obstructions and/or terrestrial structures;
airspace disturbances adversely affecting aircraft based on at least one or more from the group of: efflux from a structure, volcano ash, pyrotechnics, weapons firing, light and/or other disturbances adversely affecting aircraft and/or pilots of aircraft and the like;
airspace weather data;
notice to airmen message, NOTAM, data; and
any other data representative of the airspace condition and/or environment.

8. The flight management system as claimed in any preceding claim, wherein each airspace model represents an airspace zone state comprising a plurality of entities determined to be within the particular airspace zone based on at least the flight data and airspace condition data associated with the particular airspace zone, wherein the plurality of entities includes mobile entities and static entities, each mobile entity being assigned to either: a) one aircraft of the plurality of aircraft in-flight within the particular airspace zone based on the corresponding flight data associated with said one aircraft; or b) airspace condition data representing a mobile portion of airspace based on the corresponding airspace condition data identified to be associated with the mobile portion of airspace; and each static entity corresponding to a particular airspace condition data associated with a static portion of airspace within the particular airspace zone.

9. The flight management system as claimed in claim 8, wherein the airspace modelling component is configured to:
analyse each of the entities associated with aircraft within the airspace zone state for detecting any conflicts using the conflict detection component with any other entity within the airspace zone state;
resolve any detected conflicts using the conflict resolver component between entities within the airspace zone state; and
send flight control information notifications including data representative of the resolution of any detected conflicts to corresponding aircraft.

10. The flight management system as claimed in claim 8 or 9, wherein the airspace modelling component is configured to queue received flight data/airspace data messages associated with aircraft in flight in the airspace zone, and process the airspace zone state in a plurality of processing intervals, where each processing interval is configured to:
update the modelled airspace zone state, prior to analysing the modelled airspace zone state, based on received flight data/airspace data message queue buffered in the previous processing interval; and
whilst buffering further received flight data/airspace data messages in the queue in the current processing interval:
analyse each of the entities associated with aircraft within the airspace zone state for detecting any conflicts using the conflict detection component with any other entity within the airspace zone state;
resolve any detected conflicts using the conflict resolver component between entities within the airspace zone state; and
send flight control information notifications including data representative of the resolution of any detected conflicts to corresponding aircraft.

11. The flight management system as claimed in any of claims 8 to 10, the airspace modelling component is configured to model each airspace zone by switching between a data ingestion phase and an airspace zone state analysis phase, wherein:
in the data ingestion phase, the airspace modelling component is configured to:
receive flight data associated with aircraft and/or airspace condition data associated with the particular airspace zone;
identify each entity corresponding to an aircraft or airspace associated with corresponding received flight data and/or airspace condition data; and
send a message to each identified entity, each message including data representative of the corresponding flight data and/or airspace condition data for updating the state of said each identified entity;
in the airspace zone state analysis phase, performed within a predetermined analysis interval, the airspace modelling component is configured to:
update the airspace zone state based on any queued messages associated with corresponding entities of the airspace zone state;
each of the entities associated with aircraft within the airspace zone state are analysed for detecting any conflicts using the conflict detection component with any other entity within the airspace zone state;
resolve any detected conflicts using the conflict resolver component between entities within the airspace zone state; and
send flight control information notifications including data representative of the resolution of any detected conflicts to corresponding aircraft.

12. The flight management system as claimed in claim 11, wherein during the airspace zone state analysis phase, any received flight data of aircraft and/or airspace condition data associated with the particular airspace zone are buffered for processing during the next data ingestion phase.

13. The flight management system as claimed in any preceding claim, the flight data component is configured to process the received flight data associated with a plurality of aircraft in-flight within the airspace region covered by said flight data component by:
receiving flight data associated with each of one or more aircraft of the plurality of aircraft from multiple flight data streams of one or more flight data sources;
identifying portions of the received flight data associated with each of one or more aircraft of the plurality of aircraft;
combining the identified portions of received flight data for said each aircraft into a flight data message including data representative of a single canonical representation of flight data associated with an entity corresponding to said each aircraft; and
sending each flight data message to the corresponding airspace model for modelling the corresponding airspace zone state.

14. The flight management system as claimed in claim 13, wherein the single canonical representation of flight data associated with an entity corresponding to said each aircraft is based on portions of flight data identified to be associated with the same entity and combined from multiple flight data sources, the single canonical representation including data representative of the state of the entity in relation to at least one of the position, location, velocity, airspeed, altitude and any other relevant data of the aircraft corresponding to the state of the associated entity.

15. The flight management system as claimed in claim 13 or 14, wherein each entity is allocated a unique entity identifier and each flight data message is routed to the entity based on the unique entity identifier.

16. The flight management system as claimed in any of claims 13 to 15, wherein each of at least one or more portions of received flight data associated with an aircraft includes an external identifier associated with said aircraft allocated by said flight data source, and identifying said portions of received flight data associated with the aircraft includes allocating a unique identifier for said aircraft and mapping each external identifier identified to be associated with said aircraft to said unique identifier of said aircraft, wherein the flight data message includes data representative of the unique identifier of said aircraft for routing to said corresponding airspace model.

17. The flight management system as claimed in any preceding claim, wherein the conflict detection component for detecting flight conflicts in relation to at least one or more aircraft in flight within a particular airspace zone is further configured to detect a set of conflicts for each aircraft modelled in airspace zone state based on an analysis of any potential conflicts between said each aircraft and at least one or more of:
the positions of other unmanned aircraft modelled in the airspace zone state;
the positions of other manned aircraft modelled in the airspace zone state;
the positions of any unknown aircraft or entities modelled in the airspace zone state;
the geometric extents of volumes of restricted/controlled airspace within the airspace zone;
weather forecast data about weather systems within the airspace zone; and
any flight plans of other unmanned aircraft or manned aircraft modelled in the airspace zone state.

18. The flight management system as claimed in any preceding claim, wherein the conflict resolver component for resolving any detected flight conflicts in each particular airspace zone is further configured to:
generate a set candidate resolutions for each aircraft associated with a set of detected conflicts from said conflict detector in relation to said particular airspace zone;
select a single resolution from the set of candidate resolutions to avoid each of conflicts in the set of conflicts based on properties of said each aircraft and/or airspace zone; and
send flight control information to said each aircraft, the flight control information comprising data representative of the selected resolution.

19. The flight management system as claimed in claim 18, wherein the conflict resolver component is configured to generate a set of candidate resolutions based on a set of conflicts in relation to at least one or more aircraft in flight within a particular airspace zone and is further configured to analyse, for each aircraft modelled in airspace zone state, one or more resolutions based on aircraft properties and/or airspace zone from at least one or more of:
aircraft priority;
aircraft priority based on its payload;
the latency of the connection with aircraft;
any rules of the air in the vicinity of the aircraft detected within the airspace zone;
aircraft type including at least one of fixed-wing type, rotary-wing type;
aircraft course, speed, heading;
aircraft intended flight plan/destination;
obstacles in vicinity of the aircraft; and
effect of implementing a resolution of the set of candidate resolutions on the aircraft and other nearby aircraft.

20. The flight management system as claimed in claim 18 or 19, wherein a resolution of a set of candidate resolutions in relation to an aircraft comprises data representative of actions and/or instructions for use in directing the aircraft to avoid one or more conflicts of the set of conflicts associated with the aircraft.

21. The flight management system as claimed in any preceding claim further comprising a flight orchestration layer covering an airspace comprising a plurality of airspace regions, the flight orchestration layer comprising a plurality of flight orchestration components, each flight orchestration component associated with one of the plurality of airspace regions, each flight orchestration component comprising a flight data component configured to:
receive at least flight data associated with a plurality of aircraft in-flight within the airspace region covered by said flight orchestration component; and
communicate flight control information to one or more of the plurality of aircraft; and
a plurality of airspace management components connected to each flight orchestration component, each airspace management component associated with a particular airspace zone of the airspace region of said flight orchestration component, said each airspace management component comprising an airspace modelling component, conflict detection component, and a conflict resolver component that are configured to:
model the corresponding airspace zone state of at least air traffic in-flight within the particular airspace zone based on received flight data associated with aircraft in-flight within the particular airspace zone; and
detect any flight conflicts in relation to at least one or more aircraft of the aircraft in-flight within the particular airspace zone;
resolve any detected flight conflicts in relation to said at least one or more aircraft; and
send flight control information, via the corresponding flight data component of said flight orchestration component, in relation to any detected and/or resolved conflicts associated with said at least one or more aircraft.

22. The flight management system of any preceding claim, wherein the flight management system is further configured to dynamically resize, assign and/or reassign one or more airspace zones of the plurality of airspace zones for modelling the airspace zone state of at least another airspace zone within said airspace region based on processing load of modelling said at least other airspace zone and/or number of flights within said at least other airspace zone.

23. The flight management system of any preceding claim, wherein the dynamic resizing, assignment and/or reassignment further includes at least one from the group of:
dividing a particular airspace zone into multiple airspace zones when the processing load associated with modelling the number of flights within an airspace zone exceeds a first predetermined load threshold, and assigning processing load for modelling each of the multiple airspace zones; and
merging multiple airspace zones into a single merged airspace zone when the combined processing load associated with modelling the number of flights within the multiple airspace zones falls below a second predetermined load threshold;
wherein the first predetermined load threshold is greater than or equal to the second predetermined load threshold.

24. A computer-implemented method of flight management for a flight management system covering an airspace region of an airspace, the airspace region comprising a plurality of airspace zones, the method further comprising:
receiving at least flight data associated with a plurality of aircraft in-flight within the airspace region from a communication network;
modelling each airspace zone of the plurality of airspace zones, wherein each airspace zone is represented by a corresponding airspace model comprising an airspace zone state representing at least air traffic in-flight within said each airspace zone based on received flight data associated with aircraft in-flight within said each airspace; and
detecting any flight conflicts in relation to at least one or more aircraft in-flight within the each airspace zone based on the airspace zone state of said each airspace zone;
resolving any detected flight conflicts in relation to said at least one or more of the plurality of aircraft; and
sending over the communication network flight control information in relation to any detected and/or resolved conflicts associated with said at least one or more aircraft.

25. A flight orchestration apparatus comprising a processor, a memory and a communication interface, the processor, memory and communication interface connected together, wherein the flight orchestration component is adapted to:
receive at least flight data associated with a plurality of aircraft in-flight within the airspace region covered by said flight orchestration apparatus;
distribute the received flight data to a plurality of airspace management components connected to said flight orchestration apparatus, each airspace management component associated with a particular airspace zone of the airspace region of said flight orchestration apparatus and configured to model each particular airspace zone represented by an airspace zone state, detect conflicts using the airspace zone state in relation to one or more aircraft in flight within the particular airspace zone and resolve any detected conflicts in relation to said one or more aircraft within said particular airspace zone; and
receive one or more flight control information messages from one or more airspace management components, each flight control information message associated with at least one aircraft of the plurality of aircraft; and
communicate said received flight control information to the at least one aircraft.

26. A computer-implemented method of operating a flight orchestration apparatus, the method comprising:
receiving at least flight data associated with a plurality of aircraft in-flight within the airspace region covered by said flight orchestration apparatus;
distributing the received flight data to a plurality of airspace management components connected to said flight orchestration apparatus, each airspace management component associated with a particular airspace zone of the airspace region of said flight orchestration apparatus and configured to model each particular airspace zone represented by an airspace zone state, detect conflicts using the airspace zone state in relation to one or more aircraft in flight within the particular airspace zone and resolve any detected conflicts in relation to said one or more aircraft within said particular airspace zone; and
receiving one or more flight control information messages from one or more airspace management components, each flight control information message associated with at least one aircraft of the plurality of aircraft; and
communicating said received flight control information to the at least one aircraft.

27. An airspace management apparatus comprising a processor, a memory and a communication interface, the processor, memory and communication interface connected together, wherein the airspace management component is associated with a particular airspace zone of an airspace region of an flight orchestration apparatus according to claim 25, the airspace management apparatus is further adapted to:
receive at least flight data associated with a plurality of aircraft in-flight within the particular airspace zone covered by said airspace management apparatus;
model the corresponding airspace zone state of at least air traffic in-flight within the particular airspace zone based on received flight data associated with aircraft in-flight within the particular airspace zone; and
detect any flight conflicts in relation to at least one or more aircraft in-flight within the particular airspace zone;
resolve any detected flight conflicts in relation to said at least one or more aircraft;
and send flight control information, via the flight orchestration apparatus, in relation to any detected and/or resolved conflicts associated with said at least one or more aircraft.

28. A computer-implemented method of operating an airspace management apparatus comprising:
receiving at least flight data associated with a plurality of aircraft in-flight within the particular airspace zone covered by said airspace management apparatus;
modelling the corresponding airspace zone state of at least air traffic in-flight within the particular airspace zone based on received flight data associated with aircraft in-flight within the particular airspace zone; and
detecting any flight conflicts in relation to at least one or more aircraft in-flight within the particular airspace zone;
resolving any detected flight conflicts in relation to said at least one or more aircraft; and
sending flight control information, via the flight orchestration apparatus, in relation to any detected and/or resolved conflicts associated with said at least one or more aircraft.

29. An apparatus comprising a processor unit, a memory unit and a communication interface, the processor unit connected to the memory unit and the communication unit, wherein the apparatus is configured to implement the computer-implemented method according to any one of claims 24, 26, and/or 28.

30. A system comprising:
at least one flight orchestration component according to claim 25;
a plurality of airspace management apparatus, each airspace management apparatus according to claim 27;
wherein the at least one flight orchestration component is associated with the plurality of airspace management apparatus.

31. A computer-readable medium comprising code or computer instructions stored thereon, which when executed by a processor unit, causes the processor unit to perform the computer-implemented method according to any one of claims 24, 26, and/or 28.

32. A flight management system as herein described with reference to the accompanying drawings.

33. A method as herein described with reference to the accompanying drawings.

34. An apparatus as herein described with reference to the accompanying drawings.
